(19) United States
(12) Patent Application Publication
(10) Pub. No.: US 2017/0079278 A1
(43) Pub. Date: Mar. 23, 2017

(54) ENHANCER COMPOSITIONS FOR AGRICULTURAL CHEMICALS AND AGRICULTURAL CHEMICAL COMPOSITIONS

(71) Applicant: Jose Alejandro Rodriguez Quintero, Palmira (CO)

(72) Inventor: Jose Alejandro Rodriguez Quintero, Palmira (CO)

(21) Appl. No.: 15/161,283

(22) Filed: May 22, 2016

Related U.S. Application Data
(60) Provisional application No. 62/137,182, filed on Mar. 23, 2015.

(51) Int. Cl. A01N 63/02; A01N 43/54; A01N 57/28; A01N 43/40; A01N 53/00; A01N 37/38; A01N 43/80; A01N 43/82; A01N 33/18; A01N 57/20; A01N 43/68

(52) U.S. Cl. CPC A01N 63/02; A01N 57/20; A01N 43/54; A01N 57/28; A01N 43/40; A01N 43/68; A01N 37/38; A01N 43/80; A01N 43/82; A01N 33/18; A01N 53/00

(57) ABSTRACT

The present invention provides an agricultural chemical enhancer composition comprising a mixture of (a) a fermentation product of one or more of red beans, peas, yellow corn, white corn, white rice, yucca, potatoes, manioc root, starch from vegetables sources, inorganic minerals, non-iodized sea salt, urea or another equivalent nitrogen source, biodynamic water and an inoculum selected from the group consisting of bacillus microorgasnisms or spores and yeast; and (b) an essential oil such as banana oil, cinnamon oil, coconut oil, vanilla oil and mixtures thereof; and urea or another equivalent nitrogen source and an extract of a plant material selected from the group consisting of marranero fern foliage (Pteridium aquilinum), cola de caballo (horsetail fern) leaves (esquisetum arvense), powdered cinnamon (cinnamomum zeylanicum), garlic cloves (allium sativum), tabasco pepper fruits (capsicum frutescens), pasto kikuyo seeds (pennisetum clandestinum) and mixtures thereof. The enhancer of the invention is combined with agrochemicals to augment their activity.

This application claims the priority benefit under 35 U.S.C. section 119 of U.S. Provisional Patent Application No. 62/137,182 entitled “Herbicidal And Pesticidal Combinations Of Fermentation Products And Chemical Agents” filed on Mar. 23, 2015, and which is in its entirety herein incorporated by reference. Additionally, the entire contents of my co-pending applications U.S. Ser. Nos. 14/177,015; 14/177,199 and 14/177,203 are incorporated by reference herein as if those references were denoted in the text of the present specification and claims. Similarly, the entire prosecution history and all prior art cited in the above three co-pending applications is also incorporated by reference in their entirety for purposes of duty of disclosure.

### FIELD OF THE INVENTION

The present invention relates to a novel enhancer for agricultural chemicals, a novel enhancer composition for agricultural chemicals and a method for enhancing the efficacy of an agricultural chemical. The present invention further relates to novel agricultural chemical compositions comprising a natural product enhancer for agricultural chemicals.

The present invention relates to a method for controlling the growth of weeds as well as controlling all pest in the agricultural field and the enhancement of agricultural fertilizers.

This invention further relates to a method of enhancing the activity of an agricultural chemical while used at concentrations lower than the normal amounts used to achieve the same effect, and more particularly, to a method of enhancing the activity of an agricultural chemical, characterized by incorporating in an agricultural chemical one or more natural products of the invention.

The present invention also relates to compositions that include a combination of one or more pesticides and one or more enhancers. The present invention also concerns a method of controlling undesired plant growth employing co-application of an enhancer and an agricultural chemical.

It has now surprisingly been found that co-application of a natural enhancer produced by fermentation and at least one other agricultural chemical results in better and in some cases longer-lasting control of undesired plant growth, insect, bacterial, viral, and fungal infestation. This synergistic effect exhibits itself in a high degree of control at co-application rates which are significantly lower than the rate of each individual compound required to obtain the same degree of control. Furthermore, at any given co-application rate the degree of control is higher than the additive effect obtained for the individual components at the same rate. In some cases both speed of activity and level of control are enhanced and/or weeds can be controlled which are not controlled by either component at economical rates.

This synergistic effect allows for satisfactory control at reduced application rates for each component and even at levels which if applied for a particular component alone would give insufficient control. Additionally, longer residual control may be achieved. This provides for significant economic and environmental advantages in the use of the enhancer and the agricultural chemical used in combination therewith.

### BACKGROUND OF THE INVENTION

Agricultural chemicals including insecticides, fungicides (or bactericides), herbicides, Miticides, fertilizers, and plant growth regulators are used in formulations such as emulsifiable concentrates, wettable powders, granules, dust formulations and suspension concentrates (flowable). At this time, various ideas on the qualities of formulations are carried out to draw out the effect of a technical material of agricultural chemical. However, it is difficult at present to significantly enhance the effect of the active ingredient in an agricultural chemical by devising formulations. Also, because it is more difficult to develop a new agricultural chemical, it is industrially significant to enhance the activity of currently used agricultural chemicals.

Weeds treated with a chemical herbicide are additionally treated with constituents from culture media in which microorganisms have grown. This results in a greater degree of control of the weeds than is obtained by the same level of chemical herbicide alone.

Widespread use of chemical herbicides and other agricultural chemicals have created concern about possible adverse ecological effects caused by the large quantities of chemical agents that are being introduced into the environment. There are additional fears that these chemicals might pose risks to human and animal health. Special concern has been directed to health effects on agricultural workers, who may be exposed to high levels of chemical herbicides. It has been necessary to withdraw from the market or severely restrict the use of some chemical herbicides after adverse environmental or health effects became evident. Disposal of containers for chemical herbicides is heavily regulated, and proper disposal of these containers can be inconvenient and expensive for farmers.

Disposal sites for these containers are limited and illegal container disposal is a growing concern. Thus, there exists a need in the art for compositions and methods for controlling a broad range of weed and agricultural pests species while decreasing the quantity of herbicidal and pesticidal chemicals currently used for this purpose.

One approach to the development of less environmentally harmful methods of weed control is to attempt to identify and isolate herbicidal substances produced by microorganisms. Many microorganisms produce substances that are toxic to weeds. An assumption underlying this approach is that these naturally-occurring agents are less likely to have deleterious environmental effects than the synthetic chemicals presently used as herbicides. Effort has been directed at identifying and isolating such compounds made by microorganisms for possible use as herbicides.

The strategy in these studies has been to identify and isolate specific substances produced by microorganisms that are toxic to plants. To discover naturally occurring herbicides, culture media in which microorganisms have grown have been tested for their effects on weeds. If the medium produced signs of injury in the weeds, then efforts were directed towards identifying and isolating the chemical constituents in the medium that have herbicidal actions.

The isolation and identification of herbicidal compounds made by microorganisms faces numerous obstacles. The process of identifying, purifying, and isolating such compounds is lengthy and expensive. Media in which microorganisms have grown are highly complex mixtures and the active compounds with herbicidal activity may be present in extremely low concentrations. If the active compounds are labile, or if herbicidal actions are due to synergistic interactions of multiple components, then the activity may be lost during purification. Even where an active compound is identified, the production of commercially useful quantities of such compounds by industrial fermentation and purification or by alternative methods involving chemical synthesis may require considerable additional effort.

Perhaps because of the difficulties and expense of isolating microbially-derived herbicidal compounds, only a few natural products made by microorganisms have been developed to the stage where they could be tested as potential commercial herbicides. One example is bialaphos, L-2-amino-4-[(hydroxy)(methyl)phosphinoyl]-butyl-L-alanyl-L-alanine. A synthetic version of a derivative of bialaphos, glufosinate, is also used as a herbicide.

A second approach to using the products of microorganisms for weed control is to use the living microorganisms themselves as bioherbicides. Most of the living organisms that have been developed as bioherbicides are fungi (mycoherbicides). Fungal plant pathogens are generally highly selective, infecting only a single species or a narrow range of plants. Therefore, mycoherbicides have been used mainly as selective herbicides directed at specific species of weeds. Fungi have not been developed as broad spectrum mycoherbicides for the control of multiple weed species.

While the use of living microorganisms as bioherbicides has potential advantages compared to the use of chemical herbicides, it entails numerous problems. Microorganisms must be kept viable during storage and application. Successful infection of the targeted weeds may be adversely affected by environmental conditions. While some fungi have been applied for the selective control of specific weeds, living microorganisms have not previously been useful as broad spectrum herbicides.

The present invention employs a different strategy. It does not entail the laborious isolation of specific toxins produced by microorganisms. It also avoids some of the problems inherent in the use of living microorganisms in the field as bioherbicides. Rather, facultative fermentation products are used to potentiate the actions of chemical herbicides and other agricultural pesticides, making it possible to employ lower concentrations of the chemical herbicides and or other chemical agents. With this approach, it is unnecessary to engage in the lengthy and expensive process of isolating the active herbicidal factors in the facultative fermentation product. Rather, the facultative fermentation product can be used as is, or after processing involving simple procedures such as concentration and partial purification, to provide an economically useful method of effectively controlling weeds while reducing the amounts of conventional herbicides or other chemical agents applied to the environment.

By way of further background, herbicides are biologically active compounds designed to interfere with the metabolic processes of weeds or undesirable weeds that cause problems to compete with crops for water, nutrients, light, space, etc., causing an increase in the cost of harvesting and decline of its value.

The mode of action of a herbicide is an entire sequence of events culminating causing any damage to the plant that may (but need not) be the total senescence thereof. Herbicides to become active in a particular plant species have to interrupt one of the essential physiological processes in the plant. There are a large number of features that contribute to the successful control of weeds. These processes can be divided into: uptake, metabolism and herbicide movement, as shown below:

In most cases, a herbicide must cross the cell wall, and perhaps plasma membrane, organelle membrane of the plant to reach the site of action, where its accumulation causes phytotoxicity. Herbicide uptake into cells and their accumulation there, depends on the physicochemical properties of the molecule of the herbicide (this includes its lipophilicity and acidity), and the membrane permeability of plant cells and electrochemical potential into the plant cell. The herbicide absorption can occur by diffusion or active mechanisms.

For a herbicide to act it shall: 1) Perform uptake, ie make proper contact with the ground, leaves, stems and/or roots, then 2) Perform transport and plant uptake and affect the metabolism, then 3) Moving to the site of action without actually turning off the metabolic functions, and finally 4) achieve its activity in the site of action in a toxic concentration.

For a herbicide activity to occur it has to be intercepted and arrested by the weed's leaves or stems. The greater the amount of intercepted herbicide, the greater phytotoxicity that occurs. There are some factors that influence the interception of the herbicide: (1) coverage capacity of a species (if the crop completely covers the weeds, they can not intercept and retain herbicide), (2) the nature of the leaf surface which is another determinant for herbicide retention and (3) the application of the herbicide, because the vehicle or dispersant also affects herbicide retention by plants.

The penetration of a herbicide begins as the herbicide is deposited on the surface of leaves, in which the herbicide must cross the cuticle and plasma membrane before reaching the symplast (phloem) or the immediate apoplast.

The primary barrier to absorption of herbicide is the cuticle, which covers all surfaces and minimizes air losses of water from the plant, however, the cell wall and cell membrane may also prevent the entry to some extent. The outer layer consists of cuticular wax, epicuticular wax extrusions, which varies with age and leaf species. Waxes are non-polar, oil related in nature and repel the water.

Below the cuticular wax is cutin layer, which is more hydrophilic waxes. Surfactants and other additives herbicide formulations play an important role in the retention and penetration of the herbicide through the waxy cuticle. Preferential entry points for herbicides are the protective cells of the stomata, leaf hairs, and nerves in broadleaf species. Stomata penetrate the leaf surface, but most of the surfactants are not able to reduce the surface tension of aqueous solutions enough to allow entry of the herbicide through the stomata.

Successful treatment of soil-applied herbicide depends on the entry of toxic product concentrations in the roots or aerial part of the weeds. After penetration in the leaves and absorption by the roots, many herbicides are moved to other parts of the plant apoplast and symplast.

The apoplast is an interconnected network of non-living tissue, including cell walls and xylem water driver. This is limited by the cuticle externally and internally by the outer membrane of the cell, the plasmolema. Herbicides entering the root (eg atrazine), move in the xylem to the transpiration stream and follow the movement of water to the tips of the leaves in monocots, or until their margins in dicots. Herbicides accumulate where water is lost by evaporation and this is usually reflected in the timing and location of the phytotoxic symptoms.

In the case of herbicides whose mode of action is associated with processes of plant growth, the herbicide must cause a redistribution of the compound to the growing tips, a process that also involves the symplast. The latter is a system of interconnected living plant cells, including the phloem which contains the cytoplasm metabolically active, limited on the outside by the plasmolema and the inside of the vacuolar membrane, the tonoplast. This contains organelles such as chloroplasts and mitochondria. Action points of all herbicides are located in the symplast.

The sugars produced by photosynthesis in green tissues of plants are conducted in the symplast to regions where growth and storage takes place. In most circumstances the herbicides are moved out of the single treated leaf through the phloem, and herbicides or the formulation components which interfere with the transport in the phloem limit the translocation of the herbicide.

After the absorption process, the herbicide is translocated from the application site to other parts of the plant to the site of action, which becomes the main physiological function involved in the mode of action of the herbicide.

When the herbicide reaches the site of action, it must be metabolized in the plant, therefore once the herbicide is absorbed either by the foliage or roots and transported, it must impact the organelles within the cell, through the plasma membrane, generally by passive transport processes (without intervention of energy) or active transport through a protein, which acts as carrier, located in the membrane that carries the molecule within the plant cell. Once inside the cytoplasm, the herbicide is transported to the site of action.

Once the herbicide reaches the site of action, that's where its accumulation causes phytotoxicity. Herbicide uptake into cells and accumulation depends on the physicochemical properties of the molecule of the herbicide.

Herbicides can be classified according to their time of application, selectivity, type, chemical family and mode of action. The most useful form of herbicide classification is according to their mode of action. The mode of action is the sequence of events occurring from the absorption of the herbicide to plant death. Herbicides with the same mode of action have the same absorption and transport behavior and produce similar symptoms in the treated plants.

The herbicides according to their mode of action are classified as: Seedling growth inhibitors, Inhibitors of photosynthesis, Pigment Synthesis Inhibitors, Inhibitors of lipid synthesis, Inhibitors of amino acid synthesis, Destroyers of cell membranes, Growth Regulators and other little known mechanisms

The classification of herbicides by mode of action predicts, in general, its spectrum of weed control, time of application, crop selectivity and persistence in soil. Knowledge of the mode of action of the herbicide allows designing programs with more efficient chemical control of weeds and prevent negative effects of herbicide use, such as residues in soil, weed species change and development of herbicide resistant weed biotypes.

Insecticides are agents of chemical or biological origin that control insects. Control may result from killing the insect or otherwise prevent their destructive behavior. Insecticides can be natural or human-made and are applied to the target species in a variety of formulations and application systems (sprays, baits, slow release dissemination, etc.)

The ideal characteristics of an insecticide include (1) great specificity, that is, the product only affects the species which is being targeted, leaving untouched the rest of living beings and the environment, (2) low toxicity in humans, that is the product is of low risk to cause both acute poisoning and low-dose exposures, (3) low toxicity for other fauna, that is, its toxicity to water or general fauna, pollinating fauna (such as bees) and other beneficial insects, (4) lower lethal dose, that is, the insecticide is effective with small quantities and (5) low cost, that is, the product has to be inexpensive.

Insecticides can be classified in different ways: Depending on the route of entry into the insect body, according to the penetration and translocation in the plant, depending on the origin and chemical nature of the product, and according to their mode of action.

According to the route of entry into the insect body, they are divided into:

Stomach or swallowed Insecticides: these insecticides act by ingestion and can be introduced into foods by foods or toxic baits. They are suitable to combat chewing insects, such as caterpillars that consume leaves.

Contact insecticides: These insecticides act when the insect cuticle is contacted with the product. Contact insecticides are a very diverse group and act by tracheal obturation of insect stigmas (flowing into asphyxiation), or inhibiting the nervous system.

Fumigant insecticides are those products that penetrate the respiratory system of the insect. Inhalation or asphyxiating insecticides, some well-known in the domestic sphere, are also called gaseous or insecticide sprayers, and act through the respiratory system of the insect.

According to penetration and translocation into the plant: The insecticide may be applied to the plant surface, penetrate the surrounding tissues, or penetrate tissues. These have the property of being absorbed by plants, through sap passing through the epidermis of leaves, flowers, stems or roots. By poisoning the sap, they kill insects when they feed on the plant, but do not cause any damage to the plant itself. They are indicated to combat sucking insects such as aphids. Most of these insecticides are phosphorus compounds. Most are systemic insecticides since they are applied on the ground, or plant tissues and penetrating through them, are distributed over all its parts. Thus, although the applied insecticide does not cover the entire surface of the plant, or falls directly on the parasites, the plant itself becomes poisonous to pests.

Depending on the origin and chemical nature of the product, there are many compound insecticides used for agriculture in the market place.

Mineral or inorganic insecticides are derived from toxic inorganic salts, usually containing copper, arsenic, mercury, lead and sulfur. These are generally very stable substances that act by ingestion.

Insecticides of plant origin: The products are made from substances derived from plants, such as extracts or plant parts ground into powder form.

Synthetic Organic Insecticides: They are physical organic compounds with chemical, toxicological and varied properties.

Hormonal insecticides and Purpose Regulators growth (RCI) are a group of substances that are chemically or functionally related (bioanalogous) with two hormones produced by insects to regulate their growth, metamorphosis molting hormone or ecdysone, and juvenile hormone or neotenina.

Insecticides not all act in the same way. Depending on the type of insecticide in question, they can be effective by contact or ingestion. The mode of action of an insecticide can be defined as a biochemical and physiological response of an associated application to the insect body. The mode of action of an insecticide is related to the intrinsic characteristics of the active ingredient formulation, which allow reaching the insect pest of one form or another to achieve the control objective, according to the form of input to the insect, they are classified as contact, ingestion and inhalation.

The action by which contact insecticides exhibit activity have to do with the ability to penetrate through the integument or exoskeleton of insects when it comes in contact with the insecticide and is then dissolved so they can act in the hemolymph.

Action swallowing insecticides that act by ingestion enter the body through the digestive tract by eating food contaminated with insecticide. These compounds have the ability to cross the intestinal wall and reach the hemolymph.

Inhaled insecticides act via tracheal penetration to the insect's stigmas.

Fertilizers are substances that provide the nutrients that crops need. With fertilizers, plants can produce more food and cash crops of better quality, improve the low fertility of soils that have been overexploited, among others, which promote agricultural and economic welfare of a country.

Fertilizers also increase crop yields. If the supply of nutrients in the soil is ample, crops are likely to grow better and produce higher yields. However, if even one of the necessary nutrients are scarce, plant growth is limited and crop yields are reduced. Consequently, in order to obtain high yields, fertilizers are needed to supply the crops with soil nutrients that are lacking. With fertilizers, crop yields can often be doubled or even tripled.

Sixteen elements are essential for the growth of a vast majority of plants and these are from the surrounding air and soil. On the ground, the transport medium is dictated by the soil properties. The following are considered essential: a. Air: carbon (C) and CO₂ (carbon dioxide); b. Water: hydrogen (H) and oxygen (O) and H₂O (water); c. Soil, fertilizer and animal manure nitrogen (N)—leguminous plants obtain nitrogen from the air with the help of bacteria that live in nodules roots—phosphorus (P), potassium (K), calcium (Ca), magnesium (Mg), sulfur (S), iron (Fe), manganese (Mn), zinc (Zn), copper (Cu), boron (B), molybdenum (Mo) and chlorine (Cl).

Apart from carbon (C), the plant takes all the nutrients from the soil. Nutrients are divided into two categories: (a) macronutrients, divided into primary and secondary nutrients; and (b) micronutrients or trace.

Macronutrients are needed in large amounts, and large amounts must be applied if the soil is deficient in one or more of them. Within the group of macronutrients, required for the growth of plants in large amounts, the primary nutrients are nitrogen, phosphorus and potassium. The secondary nutrients are magnesium, sulfur and calcium. In contrast to macronutrients, micronutrients or trace elements are required only in minute amounts for correct plant growth and have to be added in very small quantities when they can not be provided by the soil. Nitrogen (N) is the engine of growth of the plant. It is absorbed from the soil in the form of nitrate (NO₃—) or ammonium (NH₄⁺). Being the essential constituent of proteins, it is involved in all major processes of plant development and the development of performance. A good supply of nitrogen to the plant is also important for the absorption of other nutrients.

Phosphorus (P), plays an important role in energy transfer. Therefore it is essential for photosynthesis and other chemical-physiological processes. It is essential for the differentiation of cells and development of tissues, forming the growing points of the plant.

Potassium (K) and 60 active enzymes, which play a vital role in the synthesis of carbohydrates and proteins.

The secondary nutrients are magnesium, sulfur and calcium. Plants also absorb these in considerable quantities. Magnesium (Mg) is the central constituent of chlorophyll, the green pigment in leaves which functions as an acceptor of energy provided by the sun.

Sulfur (S) is an essential constituent of proteins and is also involved in the formation of chlorophyll. Calcium (Ca) is essential for growth of the roots and as a constituent of cell membrane tissue.

Micronutrients or trace elements are iron (Fe), manganese (Mn), zinc (Zn), copper (Cu), molybdenum (Mo), chlorine (Cl) and boron (B). They are part of the key substances in plant growth and are comparable with the vitamins in human nutrition. They are absorbed in minute amounts, their range of optimal supply is very small. Its availability in plants depends mainly on the ground reaction. Oversupply of boron can have an adverse effect on the subsequent crop.

Plant nutrients can act through different forms. (1) Through the roots, the root hairs of the roots absorb water from the soil in which the are dissolved. (2) Through the leaves: they take up carbon and oxygen and also small amounts of other nutrients. The soil nutrients (N, P and K) can be unassimilable even when afixed to the clay-humic complex and the soil solution from which it passes.

Photosynthesis: Through the evaporation of large amounts of water during the day, the soil nutrients taken are delivered to the plant leaves. The main action takes place in the green leaves. This process is called photosynthesis. This is a natural way of transforming the inorganic elements taken from the air by plants and soil organic matter, with the help of energy from sunlight: the light energy is converted into chemical energy.

The fundamental importance of photosynthesis is due to the fact that carbon dioxide and water, become carbohydrates (sugar), which are the basic materials for the synthesis of all other organic substances produced by plants. A sufficient supply of nutrients is important for proper operation of this process. This is due to the fact that if one of the soil nutrients is not present, photosynthesis is delayed.

If a nutrient is present, but in insufficient quantity, the plant develops hunger signs (withdrawal symptoms). Nutrient deficient plants are stunted (small), the leaves are pale green or bluish dark green, yellowish or have reddish spots or stripes. At harvest, yields are sometimes severely reduced.

Therefore the growth of a plant depends on a sufficient supply of each nutrient, and performance is limited by nutrients that are restricted (minimum limiting performance factor). In agricultural practice, this is the case for nitrogen, phosphorus, potassium, magnesium and sulfur. Hence, these nutrients have to be applied in the form of mineral fertilizers to obtain satisfactory yields.

Fertilization is one of the fundamental pillars of agricultural production. In most farming systems, crop fertilization is done by applying nutrients directly to the soil. The efficiency of this type of fertilizer depends on the plant capacity to mobilize the nutrients from roots to different organs and tissues. This is affected by soil conditions (pH, water availability, temperature and clay content, etc.) and the format of the fertilizer (in powder, granular, liquid, etc.). When the plant is under stress or in soils with low nutrient availability, the tissues experience nutritional deficiencies that the soil alone can not mitigate.

One of the most widespread techniques and which has become very popular in many countries in crop nutrition is “Foliar Fertilization”, which allows you to quickly correct nutritional deficiencies and helps the plant to recover their metabolic homeostasis. Foliar fertilization does not compete with the traditional application of fertilizer to the ground, but complements it, which helps achieve high levels of crop production

Foliar fertilization is the beginning of nutrient application through the leaf tissue, mainly through the leaves, which are the organs where most physiological activity of the plant is concentrated. In this technique, fertilizer substances are sprayed to the foliage in the form of nutrient solution, using water as dissolution medium. It has been well demonstrated that excellent performance is achieved when foliar nutrients are applied in the right amount and the right time. Foliar fertilization has become an important practice in many agricultural production systems because it allows quick and timely correction of nutritional deficiencies, promotes growth and development of plants, and enhances the performance and quality of the crop. Research has indicated that it is feasible to feed the plant through the leaf tissue, particularly when it comes to correcting deficiencies of minor elements, which are required in very small amounts by plants.

This circumstance makes possible the provision of these elements in very low concentration solutions which are tolerated by the plant and do not produce phytotoxic effects. On the other hand, the root fertilization with micronutrients is often undesirable from the standpoint of management, due to such low doses that can hinder its uniform application. Conversely, foliar application is practical, simple and efficient. Foliar fertilization does not replace soil fertilization, but it is a recommended supplemental nutrition to supply certain nutrients during critical stages of crop or high nutritional demand, such as flowering and grain filling and fruit practice. Under certain culture and soil conditions, foliar fertilization has proved advantageous compared with the ground composting.

Germicides for agricultural use are chemicals that destroy pathogens such as fungi, bacteria and viruses to which they are exposed.

These pathogens are responsible for much of the decline in agricultural production in the tropics and they are typically deal with through chemical methods, which have both an economic and environmental cost. However, plants are also able to react and defend themselves, using a series of natural mechanisms for this. The plant-pathogen interactions can present various types of associations, which depend largely on the genetic content of each agent.

Microorganisms play an important role in agriculture; many are essential to the functioning of ecosystems, contributing from fundamentals such as the biogeochemical cycles of elements (carbon, nitrogen, sulfur, iron, etc.). A few microorganisms can be harmful to plants, behaving as pathogens, causing diseases and loss of crop yields.

The diseases that are common in plants often produce a significant economic impact on yield and quality, which indicates that disease management is an essential component in the production of most crops. There are various diseases in plants, some of which are caused by lack of nutrients, others are caused by microorganisms

Despite the constant contact with pathogenic microorganisms, plants normally remain healthy due in part to the manifestation of several defense mechanisms. Furthermore, pathogens must adapt to host tissue to eventually breed and avoid or counteract these defense mechanisms of the plant. Once these mechanisms are overcome, they can alter physiological functions of plants, affecting its normal operation, generally reducing yields and in extreme cases causing them to die.

For a pathogen to infect a plant, it should be able to build a road into and through the plant, obtain nutrients from the plant and neutralize the defense mechanisms of the plant. Microorganisms can exert mechanical stress on plants. Some fungi exerts pressures that achieve some degree of pre softening plant tissues

In turn, plants have developed various strategies of defense against biotic attack and biotic stress. To defend against the damage caused by a wound and a pathogen attack, they synthesize enzymes that degrade the cell wall of microorganisms or have the ability to inactivate microbial toxins. The composition and structure of the plant cell wall also change form to a more rigid and less digestible barrier. These defense responses are combined in turn with the development of structures against predators such as spines, spikes, trichomes and glandular hairs. Also, a part of another chemical protective strategy used by plants, is the production of secondary metabolites with antimicrobial activity.

Plant pathologists believe that any different sign of normal growth patterns is a clear evidence of disease. The origin of the disease from one plant may be due to a set of agents such as fungi, bacteria and viruses or complexes.

The factors influencing the action of germicides are: (1) time, that is, an antimicrobial substance must be in contact with the material to be disinfected by an appropriate period of time. The death of microorganisms is a gradual phenomenon: most die quickly, others are more resistant. (2) concentration, that is, chemical agents are not effective when its concentration is less than a certain value. Gradually increasing it first produces a germistatic and then germicidal effect. (3) Temperature, that is, the efficiency generally increases with temperature. (4) Humidity, that is, the presence of water facilitates penetration of the antimicrobial into the cell. (5) Nature of the medium, that is, the presence of organic matter in the medium decreases the action of antimicrobials that acts to protect the organism. (6) Nature of the organism, that is, microorganisms that have some form of resistance (bacteria having capsules) are less affected by antimicrobials.

Pathogens can cause disease in plants in different ways:

1. Consuming the content of the host cells with which they came into contact.

2. Killing or disrupting the cells metabolism through toxins, enzymes or growth regulatory substances that may secrete.

3. Weakening the host by continuous absorption of nutrients from the cells for their own use.

4. Blocking nutrient transport, organic and mineral substances, and water through the conducting tissues. The fundamental plant physiological processes such as photosynthesis, translocation of water and nutrients, and breathing.

Microorganisms generally attack only part of the plant and produce specific symptoms: necrosis, stains, mosaic, wilt, swollen roots, etc. The most common pathogens in plants are fungi, although bacteria are also important. The diseases caused by mycoplasma and viruses are often not recorded, mostly because they are very difficult to detect.

Nematodes are also pests that can be damaging and the farmer needs to deal with them.

In response to such microorganisms, germicides can be classified depending on the microorganism that they control. Fungicides are used to control fungal diseases and they include specific and broad-spectrum contact and systemic (translocated inside the plant.

Bactericide for controlling plant diseases are generally moderate and may be phytotoxic to some crops. Therefore, control is very important in the management of bacterial diseases.

Virucides is a class where there are no commercially effective chemicals to control diseases caused by viruses. The control should be based on sanitation, removal of diseased plants and control of insect vectors.

The present invention provides Enhanced Proficiency Activators (EPACs') which can be combined with herbicides, insecticides, germicides, and fertilizers to enhance their activity at lesser concentration. The enhanced effect allows for satisfactory control at reduced application rates for each component and even at levels, which if applied for a particular component alone, would give insufficient control. Additionally, longer residual control may be achieved. This provides for significant economic and environmental advantages in the use of the enhancer and the agricultural chemical used in combination therewith.

### OBJECTS OF THE PRESENT INVENTION

A primary object of the present invention is a method of controlling weeds by applying to the weeds a chemical herbicide combined with a fermentation product, wherein the action of the herbicide is enhanced by the fermentation product and wherein the fermentation product is effective to significantly enhance the activity of the chemical herbicide.

Another object of the present invention is a method of controlling agricultural pests by applying to the pests a chemical pesticide combined with a fermentation product, wherein the action of the chemical pesticide is enhanced by the fermentation product and wherein the fermentation product is effective to significantly enhance the activity of the chemical pesticide.

A further object of the present invention is a method of controlling phytopathogenic fungus by applying a chemical fungicide combined with a fermentation product, wherein the action of the chemical fungicide is significantly enhanced by the fermentation product and wherein the fermentation product is effective to enhance the activity of the chemical fungicide. Another object of the present invention is a method of enhancing the activity of macro, meso and micro fertilizers in agriculture by applying a chemical fertilizer combined with a fermentation product, wherein the action of the chemical fertilizer is significantly enhanced by the fermentation product and wherein the fermentation product is effective to enhance the activity of the chemical fertilizer, reducing the necessary doses and lowering the number of applications to achieve the same results as the chemical fertilizer alone.

A still further object of the invention is to provide agricultural chemical enhancers based on fermentation products that provide for enhanced herbicidal, insecticidal and fungicidal activity.

Additional objects and advantages of the invention will be set forth in part in the description which follows, and in part will be apparent from the description or may be learned by practice of the invention. The objects and advantages of the invention will be realized and attained by means of the methods and combinations particularly pointed out in the appended claims. The following general description is offered by way of explanation and illustration, and not by way of limitation.

### BRIEF DESCRIPTION OF THE FIGURES

FIG. 1 shows the events related to secondary metabolites which are induced during the defense response of plants.

FIG. 2 describes the different events that happen when a herbicide is applied to a plant.

FIG. 3 illustrates how the Enhanced Proficiency Activators of the invention appear to exert their effect.

FIG. 4 features the link of EPAC-H to Herbicide.

FIG. 5 shows how an EPAC-H/herbicide complex is absorbed by the plant through natural processes of transport of substances (active and passive transport).

FIG. 6 is a schematic diagram of how EPAC-H (enhancer or synergist) inhibits the enzyme system detoxification of plants and overcomes the defense system of plants, enhancing herbicide phytotoxicity quickly in contrast to the effect of other performing products which act as herbicide antidotes stimulating degradation.

FIG. 7 illustrates the chemical structure of glyphosate.

FIG. 8 describes how enzyme inhibition occurs when glyphosate is applied to plants.

FIG. 9 shows the chemical structre of the herbicide bispyribac.

FIG. 10 is a photograph of the results obtained from a trial with EPAC-H as an enhancer of Glyphosate (Fossel 480 SL) in a rice crop in the municipality of Tolima, Colombia (A. and C. Pretreatment plots, B. and D. plots after treatment with 480 SL Fossel enhanced with EPAC-H).

FIG. 11 features the results of the field evaluation conducted in the municipality of Palmira, Valle del Cauca, Colombia using 50% Glyphosate+10% EPAC-H.

FIG. 12 illustrates the results of the evaluation of effectiveness of EPAC-H as bispyribac enhancer 400 SC for control of weeds in corn.

FIG. 13 is a schematic diagram of how an insecticide exerts its effect.

FIG. 14 shows the different components of an insect cuticle.

FIGS. 15-17 describe a graphical summary of the field trials of EPAC-H with glyphosate.

FIG. 18 is a graphical summary of the field trials of EPAC-H with paraquat.

FIGS. 19-21 show a graphical summary of the field trials of EPAC-H with atrazine.

FIGS. 22-23 feature a graphical summary of the field trials of EPAC-H with picloram plus 2,4-D.

FIGS. 24-26 illustrate a graphical summary of the field trials of EPAC-H with clomazone.

FIGS. 27-29 feature a graphical summary of the field trials of EPAC-H with 2,4-D.

FIGS. 30-32 show a graphical summary of the field trials of EPAC-H with butachlor.

FIGS. 33-35 describe a graphical summary of the field trials of EPAC-H with oxadiazone.

FIGS. 36-38 illustrate a graphical summary of the field trials of EPAC-H with pendimethalin.

FIG. 39 features a graphical summary of the field trials of EPAC-H with butachlor and pendimethalin.

FIGS. 40-42 show a graphical summary of the field trials of EPAC-H with picloram.

FIGS. 43-45 describe a graphical summary of the field trials of EPAC-H with propanil.

FIGS. 46-48 illustrate a graphical summary of the field trials of EPAC-H with propanil plus clomazone.

FIG. 49 features a graphical summary of the field trials of EPAC-I with metamidophos.

FIG. 50 shows a graphical summary of the field trials of EPAC-I with abamectin.

FIG. 51 is a graphical summary of the field trials of EPAC-I with chlorpyrifos.

FIG. 52 represents a graphical summary of the field trials of EPAC-I with cypermethrin.

FIG. 53 features a graphical summary of the field trials of EPAC-I with profenofos.

FIG. 54 describes a graphical summary of the field trials of EPAC-F with azoxystrobin.

FIG. 55 shows a graphical summary of the field trials of EPAC-F with difenoconazole.

### SUMMARY OF THE INVENTION

The invention provides an agricultural chemical enhancer composition comprising a mixture of: (a) a fermentation product of one or more of red beans, peas, yellow corn, white corn, white rice, yucca, potatoes, manioc root, starch from vegetables sources, inorganic minerals, non-iodized sea salt, urea or another equivalent nitrogen source, biodynamic water and an inoculum selected from the group consisting of bacillus microorgasnisms or spores—and yeast; and (b) essential oils selected from the group consisting of banana oil, cinnamon oil, coconut oil, critic oil, vanilla oil and mixtures thereof; and urea or another equivalent nitrogen source.

The above mixture may further includes an extract of a plant material selected from the group consisting of marranero fern foliage (Pteridium aquilinum), cola de caballo (horsetail fern) leaves (esquisetum arvense), powdered cinnamon (cinnamomum zeylanicum), garlic cloves (allium sativum), tabasco pepper fruits (capsicum frutescens), pasto kikuyu seeds (pennisetum clandestinum) and mixtures thereof.

The invention also provides a method for controlling weeds which comprises applying to said weeds an amount effective to inhibit weed growth or to kill weeds of a chemical agent and a fermentation product produced by facultative fermentation, said chemical agent, in the presence of said facultative fermentation product, being effective to inhibit the growth or to kill at least one weed species, and said facultative fermentation product being effective to enhance the activity of said chemical agent, said chemical agent and said facultative fermentation product being applied in amounts wherein killing of said weeds or the inhibition of the growth of said weeds is greater than would be caused by the same amounts of said chemical agent or said facultative fermentation product applied alone, or provides better or equal control with a significantly reduced dosage of pesticide.

The invention further relates to a herbicidal composition comprising a chemical herbicide and pesticide in combination with a facultative fermentation product which enhances the activity of said chemical herbicide, said facultative fermentation product being present in said composition in amount sufficient to enhance the herbicidal activity of said chemical herbicide against at least one weed species.

The present invention is also directed to method for controlling weeds which comprises applying to the seeds of said weeds an amount effective to prevent or inhibit weed growth through a chemical agent and a facultative fermentation product, said chemical agent, in the presence of said facultative fermentation product, being effective to kill or inhibit the growth of weeds from said seeds of at least one weeds species, and said facultative fermentation product being effective to enhance the activity of said chemical agent, such chemical agent and facultative fermentation product being applied in amounts wherein killing of said seeds or the inhibition of the growth of said weeds from said seeds is greater than would be caused by the same amounts of said chemical agent or said facultative fermentation product applied alone.

The invention further provides an agricultural chemical composition comprising an agricultural chemical in combination with a facultative fermentation product which enhances the activity of said agricultural chemical, said facultative fermentation product being present in said composition in amounts sufficient to enhance the activity of said agricultural chemical.

The invention is also directed to an agricultural chemical composition comprising an agricultural chemical selected from the group consisting of an insecticide, fungicide, acaricide, nematocide, miticide, rodenticide, bactericide, molluscicide and bird repellant and mixtures thereof, in combination with a facultative fermentation product which enhances the activity of said agricultural chemical, said facultative fermentation product being present in said composition in amounts sufficient to enhance the activity of said agricultural chemical.

### DETAILED DESCRIPTION OF THE PRESENT INVENTION

The present invention relates to enhancers of the activities of agricultural chemicals. More specifically, the invention provides Enhanced Proficiency Activators (or EPACs') for agricultural chemicals. When small amounts of EPACs are mixed with agricultural chemicals (organic or synthetic) the amount of active ingredients of the agricultural chemical can be significantly reduced, most preferably by 50% to 75%, while maintaining or, in some cases, increasing the active ingredients' efficacy. In addition to reducing the amount of agricultural chemicals used, EPACs also accelerate the rate of biodegradation of the pesticides used in the soil, water or host surfaces by increasing the propensity and rate of bio-oxidation of the active ingredient. As such, EPACs significantly reduce the rate of leaching, evaporation, and residual traces of agricultural chemicals in the field, crops and general environment.

Applicant has discovered several types of EPACs that are suitable to be mixed with agricultural chemicals. Each of the enhancers is prepared so it is specific for a given family of agricultural chemicals. The enhancers are designed so they are specific for herbicide use, insecticide use, germicide use, fungicide use and fertilizer use.

The EPACs of the invention are manufactured using special techniques as further described below from all natural materials such as legumes, starch containing materials, plant materials, as well as essential oils derived from plants or vegetable or fruit crops. Natural materials are intended to include any crop known to mankind that provides a nutritional benefit or other benefit.

To make the enhancers of the invention, Applicant first makes a facultative fermentation product of one or more natural products selected from the group consisting of green peas, red beans, yellow corn, white corn, white onions, green onions (scalions), eucalyptus leaves and/or flowers, green lemon peels and rinds, nettle leaves, yucca, potatoes, yucca leaves, nutmeg (interior part), green lemon peel and rinds, nettle leaves, rue leaves, wormwood leaves (absinthe), green or red peppers (non-spicy), peeled garlic, garlic cloves, green leaves of citronella, red beans, mint green leaves, red tomato leaves and fruit, soya leaves and fruits, celery (leaves and branches), basil (leaves), raw oats in hull, oregano leaves, mata-raton leaves (gliricidia sepium (jacquin)), red beans, horse tail fern (Equisetaceae), plantain leaves, basil oil, garbanzo beans, lentils, barley, citric oil, white rice, salitre, barley (cereal), sorghum, yellow pine sawdust, pine oil, non-iodized sea salt, inorganic minerals containing phosphorus, calcium, silicon and titanium and strontium, urea or other nitrogen source, biodynamic water (water treated overnight with a metal such as copper, gold, platinum, palladium, aluminum, silver) and one or more of an inoculant selected from the group consisting of yeast Saccharomyces Cerevisiae, Bacillus Subtillis spores, Bacillus Aglomerans spores, Bacillus Megaterium spores, Bacillus Pseudomonas, Azotobacter, and Bacillus Lincheniformis. The composition is particularly useful as demonstrated in the examples of the invention for uses in making the enhancers of the invention which will be particularly useful to combine with herbicides, fungicides, insecticides, miticides, etc.

The minerals used during the fermentation processes of the invention include about 10.00-20.00 ppm Na, 5,000.00-20,000.00 ppm Mg, 100.00-500.00 ppm Al, Si present as silicate of the many elements in the mineral, 20.00-60.00 ppm P, 10.00-30.00 ppm K, 30,000.00-200,000.00 ppm Ca, 50.00-550.00 ppm Ti, 10.00-45.00 ppm Mn, 300.00-1500.00 ppm Fe, 0.20-1.50 ppm Co, 0.5-3.00 ppm Ni, 0.30-5.00 ppm Cu, 0.50-4.00 ppm Zn, 0.5-5.00 ppm As, 200.00-1,000.00 ppm Sr and 5.00-35.00 ppm Ba, as well as many other trace elements commonly found in those minerals.

It should be noted that numerous species of microorganisms can be used in making the fermented compositions of the invention. They include Bacillus sp. microorganisms, Pseudomonas sp. microorganisms, Bifidobacterium sp. microorganisms, and Lactobacillus sp. microorganisms, with one of Streptomyces sp. microorganisms or Corynebacterium sp. microorganisms. Other microroganisms include Streptomyces pactum, Corynebacterium striatum, Bacillus pumilus, Bacillus stearothermophilus, Bacillus brevis, Bacillus cereus, Bacillus subtilis, Bacillus sphearieus, Bacillus licheniformis, Pseudomonas alcaligenes, Pseudomonas marinoglutinosa, Bifidobacterium thermophilus, Lactobacillus casei, Lactobacillus planatarum and Lactobacillus fermentus.

The facultative fermentation products are also mixed with essential oils such as banana essential oil, cinnamon essential oil, coconut essential oil, vanilla essential oil, lavender oil, peppermint oil, eucalyptus oil, rose oil, camomile, camphor oil, caraway oil, cardamon oil, cedarwood oil, citronella oil, coriander oil, cumin oil, dill oil, fennel oil, geranium oil, ginger oil, grapefruit oil, jasmine oil, lemon oil, lemongrass oil, mandarin oil, mustard oil, nutmeg oil, orange oil, parsley oil, pine oil, rosemary oil, rosewood oil, spearmint oil, tangerine oil, thyme oil, tarragon oil and many others that occur in nature.

In a specific embodiment of the invention, the process of the invention is a multi-stage process including the following steps:

(A) The first step of the process is the specialized treatment of the potable water. All water used in subsequent steps of the process of preparing the EPAC's must be treated as follows;

1. Take 1,000 liters or the desired amount of potable water and place it in a suitable sized container and insert a metallic plaque made out of copper or other highly conductive material (Cu, Au, Al, Ag, Pt, etc.). The metal could be metal flakes, powdered metal, shavings, or metallic sheets of any geometric form that provide enough surface area for contact with the water. Allow for air to escape or install a bleeder valve in the container.

2. Allow the water to stand in contact with the metal a minimum of 8 continuous hours with the plaque submerged. The water should be close to neutral pH and may be regular municipal water.

3. The resulting water which we call biodynamic water preserves its suitability for use for approximately 2 months so it can be prepared beforehand and stored for future use.

4. Although, Applicant does not want to be bound to any mechanisms regarding the metal treatment, it is believed that the water pre-treated this way appears to prevent the decomposition of the product during the fermentation stage.

(B) In the second stage of the process, the chosen natural products for fermentation such as those of Table 1, are processed as follows:

The scale up for this step is designed to make 30 liters for future use in the making of the enhancer.

The natural products are first cut or ground to an appropriate size for further processing albeit they could be used just as produced by nature without any reduction in size.

TABLE 1

| | | AMOUNT |
|---|---|---|
| INGREDIENTS | | (Kg) |
| Red Beans | | 0.1 |
| Peas | | 0.1 |
| Yellow Corn | | 0.1 |
| White Rice | | 5.0 |
| Sea Salt (Without Iodine) | | 0.02 |
| Urea (Or other Organic Nitrogen Source) | | 5.0 |
| Biodynamic Water | | 19.61 |
| Bio- | Bacillus Megaterium Or “Yeast | 0.05 |
| Ingredients | Water” | |

| | |
|---|---|
| Total Product | 30.0 Kg |

It should be noted that any other type of natural product can be used in making this formulations. For example one can substitute the red beans, peas, yellow corn and white rice with a combination of white beans, black beans, garbanzo beans, lentils, yucca, potatoes, manioc root, and many others listed in the present specification.

1. The red beans, peas and corn are placed in a pressure cooker or autoclave with 300 cc of biodynamic water and cooked for 30 minutes or longer as required.

2. Place rice in the rice cooker together with the contents of the pressure cooker described in step 1 above.

3. Place the resulting content of the rice cookers in a 30-liter container with sufficient water so that blender operates properly. Blend until totally homogenized.

4. Add salt.

5. Add Urea (or equivalent of organic nitrogen source for a 100% organic product)

6. Add remainder of water while continuing to mix with blender until fully homogenized.

7. Seal container a retain for future use.

(C) In the third stage of the process, the following formulation as shown in Table 2 is mixed as outlined below:

TABLE 2

| INGREDIENTS | Amount | |
|---|---|---|
| Banana Essential Oil | 600 | cc |
| Cinnamon Essencial Oil | 600 | cc |
| Coconut Essential Oil | 600 | cc |
| Vanilla Essential Oil | 1.200 | cc |
| Urea or other nitrogen source | 25 | kg. |
| Biodynamic Water | Balance to | |
| | complete 130 L | |
| Total Product | 130.0 | Kg |

Preparation of Third Stage Formulation:

1. In an empty 130-liter container place:

a. The Essential oils listed above

b. Urea

c. Add the biodynamic water until filling the container to 130 L while blending with a blender until all materials a fully homogenized.

d. Place in 30-liter containers and seal hermetically for future use.

(D) In the fourth stage of the process 100 grams of Baker's yeast are mixed with sufficient water to make one liter.

In this step bacillus subtillis and/or bacillus megaterium maybe used instead of Baker's yeast.

(E) A mineral composition is prepared from minerals derived from mines in the Valle del Cauca region of Colombia and consists of a 50:50 mixture of two minerals having the following elements as the major components as shown in Table 3 (content is reported in ppm):

TABLE 3

| | Mineral 1 | Mineral 2 |
|---|---|---|
| Element | Content in ppm | Content in ppm |
| Ba | 6.5 | 150 |
| Ca | 53000 | 180000 |
| Ce | 0.25 | 2 |
| Co | 0.25 | 2.2 |
| Cu | 0.25 | 0.25 |
| Sr | 510 | 750 |
| Fe | 140 | 8300 |
| La | 0.25 | 1.8 |
| Mg | 4300 | 3200 |
| Mn | 20 | 170 |
| Mo | 0.25 | 0.51 |
| P | 2.5 | 220 |
| K | 2.5 | 47 |
| Se | 2 | 0.55 |
| Si | | |
| Na | 7.5 | 83 |
| Zn | 5.9 | 93 |

The (B) second step material is then fermented for 8 days by adding 1 liter of the yeast water as prepared in the (D) stage and also adding 10 grams of the mineral described in the table.

(F) The resulting facultative fermentation product is then mixed with the composition of the (C) stage process and set aside for future use.

Subsequent to preparation of the composition (F) a phytoadditive is prepared depending on the intended use of the final enhancer composition. Each enhancer is prepared by using other naturally derived products which are mixed with product (F) to give it the desired properties.

The following procedures are used for the preparation of 130 Liters of phytoadditives, which are then mixed with 6,000 liters of part E.

a. For every cubic meter (1,000 liters) of previously prepared biodynamic water there is inserted a biodynamic plaque made out of copper or other highly conductive material (Cu, Ag, Au, etc.), connected by copper (or similar conductive material) wire to a second biodynamic plaque.

b. Place a 30 L container next to each cubic meter container and place the second biodynamic plaque inside.

c. Then, depending on the specialization of the phytoadditive being produced, place in the 30 L container one of the following ingredients (Specializing Agents):

i. phytoadditive-H (Herbicide): 100-200 cc of glyphosate

ii. phytoadditive-I (Insecticide): 100-200 cc of Neem oil

iii. phytoadditive-F (Germicide—fungicide or bactericide): 100-200 cc of citronella oil or limonello oil.

iv. phytoadditive-N(Nutritional—fertilizer): 100-200 cc of pine oil or cacao oil.

v. The amount used, varying between 100 and 200 cc depends on the purity and concentration of the Specializing Agent being used.

d. Allow the above experimental set up to stand overnight minimum (8 hours) with one plaque submerged in the biodynamic water and the other submerged in the 30 L container with the Specializing Agent indicated above in c. i, ii, or iii.

e. After standing overnight, throw away the contents of the 30 L container. Avoid contamination of anything else with this content.

f. Use the specialized biodynamic water prepared above for the following steps in preparing the specialized phytoadditives.

g. Cook the indicated material and quantities shown in table 4 below (depending on the type of phytoadditive being prepared) placing the specific material(s) in biodynamic water at a ratio of 1:1 (same amount of biodynamic water as the volume of the specific material). Cook in pressure cooker or autoclave for one half (0.5 Hrs) hour.

h. Mix with 20 Liters of biodynamic water to wash out materials. Gently mix thoroughly and filter to separate the solids.

i. Discard solids and use the liquid from this process.

j. The result is the specialized phytoadditive.

k. Mix at a ratio of 130 L of specialized phytoadditive to 6,000 L of Part E to produce EPAC-H, EPAC-I and EPAC-F.

l. The resulting mixture is then treated through a pipeline exposed to an electromagnetic field for 8 hours, alternating, one hour on, one hour off, while introducing ionized air bubbles and also being exposed to blue and green lights.

TABLE 4

| FUNCTION | COMPONENT |
|---|---|
| Herbicida -EPAC- | 1,083 gm - Helecho Marranero Foliage. Pteridium |
| H | aquilinum |
| Fungicida | 542 gm - Cola De Caballo Leaves. esquisetum |
| Bactericida | arvense |
| EPAC-F | 542 gm - Powdered Cinnamon. Cinnamomum |
| | zeylanicum |
| Insecticida | 542 gm - Garlic Cloves. Allium sativum |
| EPAC-I | 542 gm - Tabasco Pepper Fruits. Capsicum |
| | frutescens |
| EPAC-N | 1,083 gm - Pasto Kikuyo Seeds. Pennisetum |
| Fertilizante | clandestinum |

The indicated amounts are for each batch of 130 liters of Specialized phytoadditive.

It has been further discovered that the facultative fermentation products can be combined with chemical herbicides to control weeds, wherein the combination of chemical herbicide and facultative fermentation product produces a greater degree of injury than is produced by the herbicide or facultative fermentation product alone. The facultative fermentation products need not be purified and phytotoxic materials in the facultative fermentation product need not be identified in order to use this approach for effective weed control. With this approach to the control of weeds, it is possible to reduce the amount of chemical herbicides that are introduced into the environment.

The present invention overcomes the problems and disadvantages of the prior art by providing a method to control the growth of a broad spectrum of weeds and other pests while reducing the amount of chemical herbicides or other chemicals used to achieve this goal. By combining chemical agents, such as herbicides or other chemical agents, with facultative fermentation products, greater weed or pest control is achieved than is obtained by the same amount of chemical alone. Thus it is possible to control the growth of weeds or pests while reducing the amount of chemical introduced into the environment, thereby reducing the worker exposure, environmental burden and container disposal problems associated with the use of chemical herbicides and other chemical agents. In addition, a general method for broad spectrum control of weed growth is provided that is safer than current methods, inexpensive and effective.

The present invention comprises a method of controlling weeds by applying to the weeds a chemical herbicide combined with facultative fermentation products, wherein the action of the herbicide is enhanced by the facultative fermentation products and wherein the facultative fermentation product is effective to enhance the activity of the chemical herbicide.

The chemical agent and facultative fermentation product are applied in amounts wherein killing of the weeds or the inhibition of weed growth is greater than would be caused by the same amounts of the chemical herbicide or facultative fermentation product applied alone. Another embodiment of the invention comprises a method of controlling the growth of weeds by applying a chemical herbicide together with facultative fermentation product which has been further processed by techniques such as concentration, filtration or fractionation, wherein inhibition of weed growth or killing of the weeds is greater than would be obtained by the same amounts of herbicide or processed facultative fermentation product applied alone.

Another embodiment of the invention comprises a method for controlling weeds to prevent or inhibit weed growth which comprises applying to soil containing the seeds of weeds a herbicide and a facultative fermentation product, wherein the action of the herbicide on the seeds is enhanced by the facultative fermentation product, and wherein the facultative fermentation product is effective to enhance the activity of the herbicide, so that the killing of the seeds or the inhibition of the growth of weeds developing from the seeds is greater than would be caused by the same amounts of the herbicide or facultative fermentation product applied alone.

Another embodiment of the invention comprises a herbicidal composition comprising a chemical herbicide in combination with a facultative fermentation product or processed facultative fermentation product present in an amount sufficient to enhance the activity of the chemical herbicide.

Additional objects and advantages of the invention will be set forth in part in the description which follows, and in part will be apparent from the description or may be learned by practice of the invention. The objects and advantages of the invention will be realized and attained by means of the methods and combinations particularly pointed out in the appended claims. The following general description is offered by way of explanation and illustration, and not by way of limitation.

For purposes of this application, a weed is “any plant that is objectionable or interferes with the activities or welfare of man” at the location where it is growing. A herbicide (here also called a chemical herbicide) is a “chemical used to control, suppress, or kill plants, or to severely interrupt their normal growth processes.”

“Facultative fermentation product” refers to primary and secondary metabolites subjected to fermentation processes which yields a changed metabolite. The term “facultative fermentation product” is used here because the intended meaning is analogous to the use of this term in other contexts related to facultative fermentation.

The term “processed facultative fermentation product” will be used here to refer to materials derived from facultative fermentation product by processing the facultative fermentation product with treatments that alter its composition, where the processed product is a relatively complex mixture of constituents resulting from the interaction of facultative fermentation or derivatives of such constituents. Such treatments may include, but are not limited to, concentration, drying, lyophilization, filtration, ultrafiltration, dialysis, removal of sediment by centrifugation, pasteurization, freezing, boiling, adjustment of pH, and the addition of chemicals such as preservatives, stabilizers, and agents to kill the microorganisms. This definition also includes partial purification by means including, but not limited to concentration, extraction, fractionation, and precipitation.

The term “processed facultative fermentation product” is intended to exclude highly purified compounds isolated from conditioned culture media. After processing, the resulting processed facultative fermentation product remains a type of facultative fermentation product, and the general term “facultative fermentation product” encompasses processed product. To practice the invention, a chemical herbicide and facultative fermentation product (which may be a processed facultative fermentation product), are both applied topically to weeds or to soil containing seeds of weeds. The chemical agent and facultative fermentation product are applied by well-known methods of application such as spraying or as a soil drench.

Application may be preemergent, postemergent or as a nonselective contact herbicide. In the embodiments described below, the application is postemergent. For preemergent application, the herbicide and the facultative fermentation product are applied to the seeds of weeds before the seeds have germinated, or at early stages of germination before the developing plant has emerged from the soil, typically by application to soil in which the seeds are located. The invention can be used to control weeds in an agricultural setting and can also be used for nonagricultural applications. For example, the invention can be used to control weeds in turf and as a contact bioherbicide for the management of roadside vegetation.

The chemical herbicide and the facultative fermentation product are generally applied simultaneously, usually in a single mixture. However, the chemical and the facultative fermentation product can also be applied from separate tanks, and may be applied sequentially.

Compositions for practice of the invention can be formulated in numerous ways, including flowables, dry flowables, water dispersible granules or emulsified concentrates. While the embodiments described below each entail the use of a single herbicide and a single facultative fermentation product, mixtures of media in which different species or pathovars of microorganisms have been cultured can be used to practice of this invention. The invention can also be practiced by applying a mixture of different chemical agents in conjunction with the facultative fermentation product. Furthermore, the invention can be practiced in conjunction with a bioherbicide, i.e., a medium conditioned by one microorganism can be used together with a different microorganism which acts as a bioherbicide.

Various chemical herbicides can be used to practice this invention. The embodiments described below employed sulfosate, glyphosate, glufosinate, paraquat, fluazifop, sethoxydim, imazapyr, chlorimuron, dicamba, bentazon, fomesafen, and imazethapyr as chemical agents.

While known chemical herbicides can be used to practice this invention, it should be appreciated that chemicals which do not fit the conventional definition of herbicide may also be used. For example, plant hormone analogues that are not currently useful alone as herbicides may nevertheless effectively control the growth of weeds when applied in combination with facultative fermentation product or processed facultative fermentation product. Examples of such chemical agents include phytohormones such as indole acetic acid derivatives and also include enzyme cofactors, allelEPACthic compounds, and analogues of amino acids, nucleic acid bases and vitamins.

The facultative fermentation product may be processed in other ways for convenience or to enhance its efficacy. Such treatments may include, but are not limited to, concentration, drying, lyophilization, filtration, ultrafiltration, dialysis, removal of sediment by centrifugation, pasteurization, freezing, boiling, adjustment of pH, and the addition of chemicals such as preservatives, stabilizers and agents to kill the microorganisms. Such treatments also include partial purification by means including, but not limited to concentration, extraction, fractionation, and precipitation.

The components in the facultative fermentation product may enhance the action of the chemical herbicide through various mechanisms.

Mixtures of more than one facultative fermentation product, each medium being conditioned by a different microorganism, may be advantageous. Such mixtures may be especially effective where the different conditioned media facilitate the actions of herbicides through different mechanisms of action involving different fermentation products. Where such mixtures are used, the use of processed conditioned media that has been concentrated may be advantageous.

The formulation of the invention may also contain adjuvants such as surfactants and suspension agents.

In practicing this broad approach to weed control, it should be understood that each particular combination of chemical agent and facultative fermentation product will not necessarily be effective in controlling particular species of weeds. This is consistent with the behavior of broad range chemicals herbicides in general, which are rarely, if ever, effective in controlling all types of weeds. Whether a particular combination of herbicide and facultative fermentation product or processed facultative fermentation product will be useful for a particular application can readily be determined by those skilled in the art without undue experimentation by testing in the greenhouse or in the field. The given Examples illustrate the type of experiment that can be performed to determine the effectiveness of a given combination of facultative fermentation product and herbicide, as well as to optimize parameters such as the application rate for the herbicide.

Certain principles may guide the optimization of parameters. First, the effect of the conditioned media is most evident when the herbicide is applied at a level where the herbicide alone produces weak or marginal effects on the weeds. Where the herbicide at a particular dosage already produces a high degree of weed control, additional benefits from the addition of conditioned media may not be apparent.

Control is more apparent when the weed shows partial response to the level of chemical herbicide employed. Preferred levels for the application of three herbicides (sulfosate, glyphosate, and glufosinate) are illustrated in the Examples. Effects of varying the concentration of herbicide are also illustrated.

Second, it will be apparent to those skilled in the art that while the rate of application of the chemical can advantageously be less than the usual field application some level of the herbicide will be too low to have a useful effect. However, further reductions may be possible for particular applications.

Practice of this invention may make it possible to achieve further reductions in the amount of chemical herbicides employed by giving users the option to replace the traditional prophylactic preemergent herbicide application with more efficient postemergent application. A postemergent chemical herbicide used in conjunction with facultative fermentation product could be applied selectively only as required, providing an alternative to heavy preventative preemergent application of herbicides. This approach has not been generally feasible in the past due to the cost and limited spectrum of most postemergent herbicides.

The constituents of facultative fermentation product are expected to be naturally occurring substances. Thus, it can be anticipated that they will be biodegradable and should not produce long-term deleterious effects. Practice of this invention would have the additional advantage of reducing the costs associated with the disposal of chemical herbicide containers. This reduction would be accomplished by a reduction in the total amount of chemical herbicide used.

The development of Enhanced Proficiency Activators (EPACs') is the result of biotechnological processes that are friendly to the environment and no material or product is used in manufacturing that have any restrictions or genetically modified organisms; ensuring that these products are 100% organic and meet the food codex of FAO.

The raw materials for manufacturing EPAC are 100% renewable vegetable sources, specifically selected for their interaction with synthetic molecules that need enhanced activity. From these sources a mixture of secondary and other metabolites is obtained. These metabolites are obtained in two ways: 1) directly by plant extraction processes, 2) by an industrial process in which, starting from organic sources of energy, a specific microorganism acts so that maximizes the production of primary or secondary metabolite of interest, which is then isolated and purified for use.

This successful biotechnological process results in products that act very effectively as specific enhancers (synergists) of different molecules of chemicals: herbicides, insecticides, germicides and fertilizers, thus minimizing the economic, social, nutritional and environmental cost.

### Properties of EPAC: The Role of Secondary Metabolites of Plants

Proteins are basic organic molecules in plants, as are the structural and regulatory element thereof (enzymes, hormones, etc.). Proteins are made up of peptides, and these amino acids. Plants, unlike animals, can generate its own proteins and amino acids from mineral nitrogen, although in certain circumstances respond very positively to fertilization with special fertilizers containing amino acids.

The plant secondary metabolites are low molecular weight compounds that not only have great ecological importance because the processes involved in plant adaptation to their environment, such as the establishment of symbiosis with other agents and in attracting pollinators, dispersers seeds and fruits, etc.; but because there is an active synthesis of secondary metabolites when plants are exposed to adverse conditions such as: a) consumption by herbivores (insects), b) attack by microorganisms (fungi, bacteria and viruses), c) competition for space soil, light, and nutrients between different plant species.

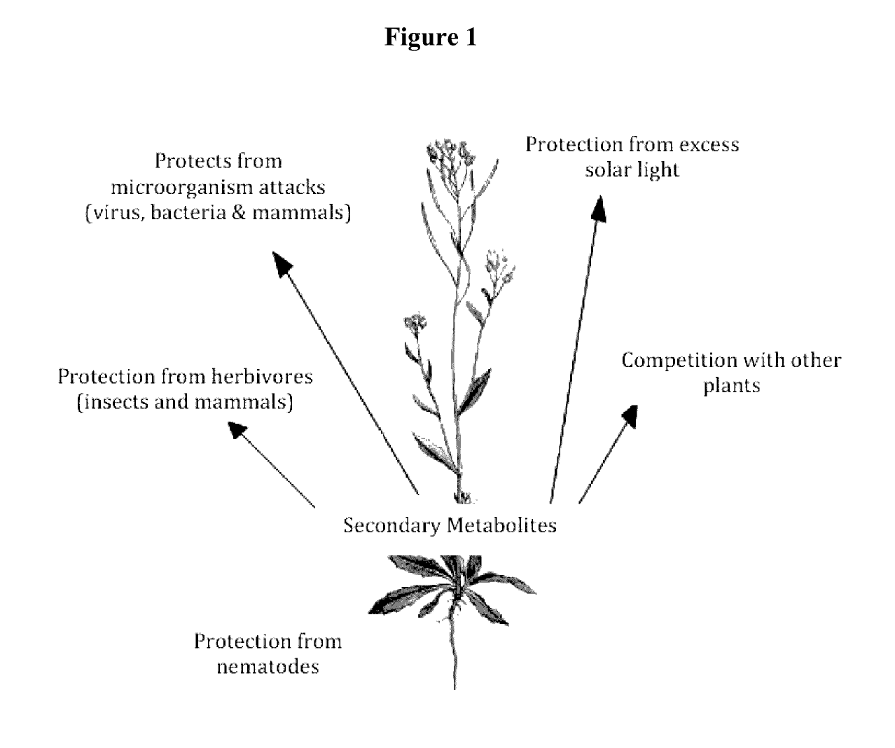

FIG. 1 shows the events in which secondary metabolites are induced during the defense response of plants. Each have different EPACS of great diversity of secondary metabolites with a specific biological activity, which not only confers stability and compatibility with the molecules of agrochemical but which in turn timely facilitates integration with the plant and its stimulation natural defense mechanisms resulting in the natural production of secondary metabolites with specific functions.

### Advantages of EPACs

EPACs secondary metabolites have great diversity and polarity, increasing the stability and chemical compatibility with different molecules of agricultural use as herbicides, insecticides, germicides and fertilizers.

The low molecular weight and physicochemical characteristics of metabolites that make up the product, breaks the intermolecular forces of the agrochemicals molecules, facilitating the absorption of the products in the control body (plants, insects, fungi, etc) and encouraging efficiency.

The diversity of secondary metabolites that make up EPACs allow the existence of a EPAC for each herbicide, insecticide, germicide or fertilizer family, depending on the initial selection process of the farmer, which gives a specific mode of action for each chemical.

The organic composition of EPAC prevents loss of the active ingredient of agrochemicals due to chemical oxidation and low adherence of products for rejection.

EPAC optimize the effect of synthetic chemical products, reducing requirements formulation of the active ingredient of products significantly and up to 50-75%

EPAC can be added to different existing molecules for edaphic and foliar formulations, and contribute to decreasing the residuality of agrochemicals, favoring the natural processes of biological degradation in the environment.

The invention provide EPAC's for uses with herbicides, fungicides, pesticides, germicides and other agrochemicals. A description of each enhancer is further described below.

### EPAC-H: Enhancer for Chemical Herbicides

EPAC-H of organic origin are products that enhance a variety of specific chemical herbicides. It can be added to the different existing molecules for edaphic and foliar use. Each EPAC-H is designed for a specific chemical herbicide family in order to minimize the active ingredient while substantially maintaining or increasing their effectiveness.

They are composed of concentrated proteins of low molecular weight interacting with chemicals formulated as herbicides for weed control in intensive crops; increasing the sensitivity of these plants to active ingredients designed to control. They further overcome the molecular attraction of herbicide chemical molecules, thus ensuring greater homogenization and decreasing potential applications and increasing the control of active ingredient per unit.

EPAC-H is the result of fermentation of plant-derived materials containing a mixture of secondary metabolites that act as herbicide enhancers of different families of chemical molecules helping to improve product efficiency.

EPAC-H is an organic enhancer or herbicide synergist, produced by biotechnological techniques, which achieves substantial reduction in the amount of chemical herbicide used, maintaining or increasing their effectiveness.

### Composition and Characteristics of EPAC-H

EPAC-H is the result of fermentation processes (after which there is added an extract of Marranero Fern Foliage—Pteridium aquilinum) from plant materials containing a mixture of secondary metabolites that allow it to interact with different herbicides. The physicochemical characteristics of various metabolites that make EPAC-H gives it the ability such that EPAC-H may be different for each herbicide. Besides, their organic nature enables rapid absorption of chemicals mixed with it, enabling a significant reduction in the amounts of chemicals applied and loss due to rejection.

### Advantages

Secondary metabolites EPAC-H confer innate compatibility with organic molecules of plants, as if they were engaging quickly absorbed nutrients and increasing the function of herbicidal potency molecules, helping to improve product efficiency.

The high polarity, reactivity and diversity of secondary metabolites of EPAC-H increase the stability and compatibility of plants with different herbicide molecules for agricultural use. The physicochemical characteristics of metabolites that make EPAC-H gives it the ability to work with each herbicide.

The organic composition of EPAC-H optimizes the effect of synthetic chemical products, significantly reducing the requirements of the active ingredient formulation of products, up to 50-75%, in most cases, contributing to the decrease of the residual herbicide and processes favoring natural degradation thereof in the environment.

### EPAC-H as Chemical Herbicide Enhancer

Herbicides are used extensively in agriculture, industry and urban areas because they provide an efficient control of weeds at low cost. In agriculture, they have been very important as weed management tool for many years.

Herbicides are compounds of varied chemical characteristics, but some have similar physicochemical characteristics that influence their potential phytotoxicity such as: Molecular weight, Melting Point, Boiling Point, the water solubility, vapor pressure, diffusion coefficient and the partition coefficient.

It has been found that in some cases less than 1% of the herbicides that reach the surface of the plant interact at the point of action, so that for many herbicides the plant metabolism is the main cause of loss of the active ingredient and pollution resulting environmental.

It has also been shown that most conventional herbicides exhibit physical, chemical and biological degradation. Some physical factors such as ultraviolet light influence the efficacy of herbicides in plants and many different chemical herbicides suffer degradation reactions such as oxidation, and secondly, some microbial enzymes are responsible for their degradation.

Although Applicant does not wish to be bound by any theories or mechanisms of action as to how the enhancers of the invention exert their action, the following represents an explanation as to what Applicant believes is currently understood with out the benefits of further in depth research studies.

### Mode of Action EPAC-H

The mode of action of EPAC-H can be divided into three parts:

### Contact

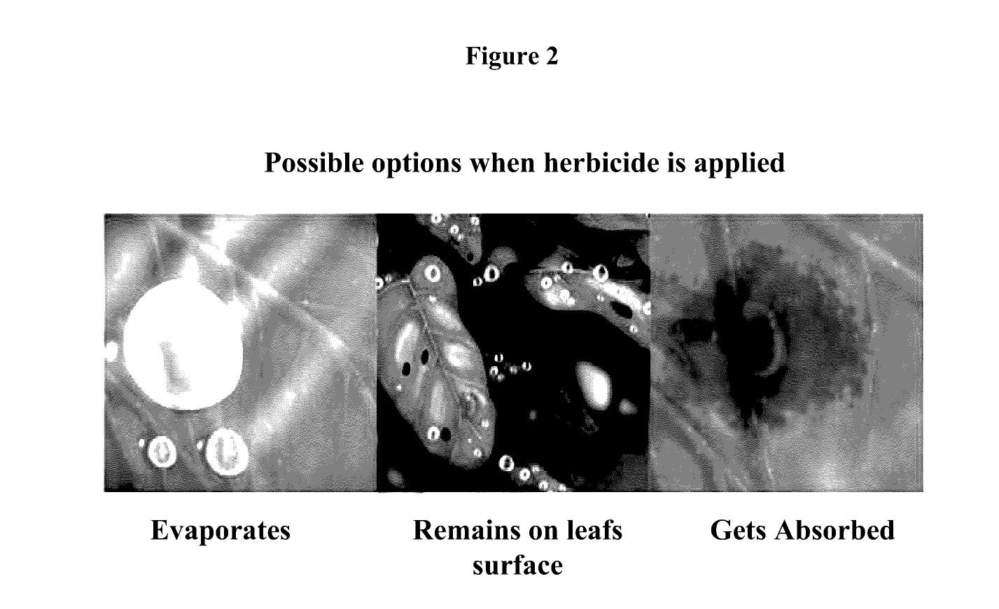

When a herbicide has contacted the leaf surface of a plant, subsequently it evaporates and is lost to the atmosphere, or it remains on the surface of the cuticle in liquid or crystalline form, or penetrates through the cuticle or stomata. This ground-contact herbicide may be limited by several factors such as the formulation of the herbicide, morphology and hairiness of leaf surface and environmental factors, such as shown in FIG. 2.

Regarding the formulation of the herbicide, it has been found that conventional herbicide molecules (comprising oxygen, nitrogen, phosphorus and sulfur), resemble spheres with large intermolecular forces and high surface area, making it difficult to contact the plant due to the morphology and hairiness of leaf surface.

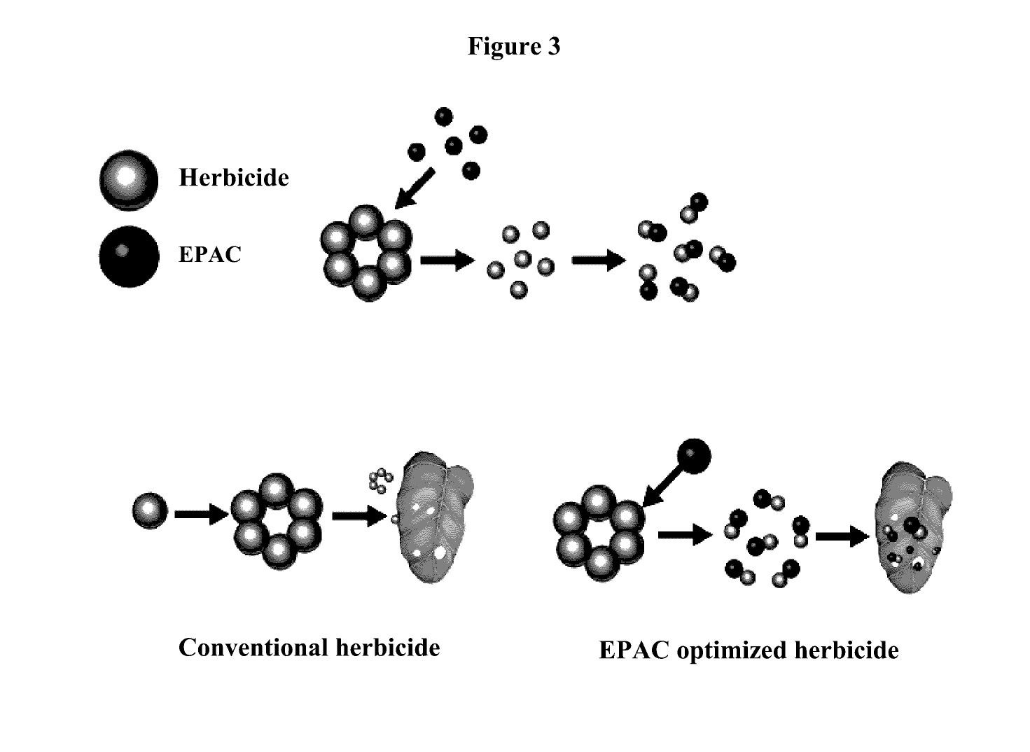

When the conventional herbicide is mixed with the enhancer EPAC-H, the organic composition and high polarity thereof, allows for the breaking of intermolecular forces that exist in the herbicide, making molecules stop attracting to themselves and search for ways of binding to the enhancer, as shown in FIG. 3.

Rupture of these intermolecular forces of herbicides by EPAC-H, increases the stability and compatibility of the molecules, facilitating the entry of the herbicide into the plant by forming covalent bonds i.e., EPAC-H-herbicide, in which electrons are shared due to small differences in electronegativity.

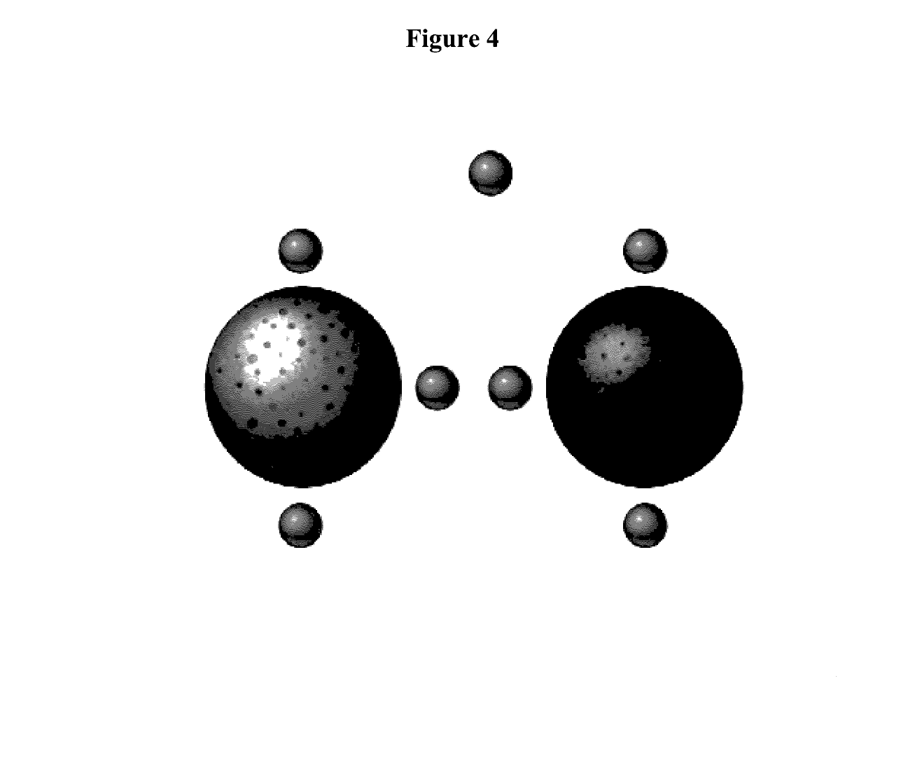

The covalent bond formed between EPAC-H-Herbicide is unique for each herbicide molecule and depend on the physicochemical characteristics of secondary metabolites in the EPAC-H and the initial selection of the farmer for a particular herbicide. See FIG. 4 showing EPAC-H-Herbicide

This covalent bond between EPAC-H-herbicide prevents losses due to low adhesion of the active elements to the leaves of plants, thus overcoming the barrier and morphology of the leaf surface hairiness.

Most herbicidal formulations are applied by spraying the solution or suspension in water, since the surface tension of water is very high and its ability to adhere or contact with the surface of the leaves is reduced by the waxy nature of these. another advantage of EPAC-H, because of its functional properties, is to accelerate the rate of penetration in the ground or leaf, by decreasing the surface tension between the water and the herbicide application. This condition favors the application during rainy seasons.

### Plant Absorption

EPAC-H enhances multiple types of herbicides which have a different mode of action in plants, but the absorption process of the EPAC-H/herbicide complex is similar and the functional properties of EPAC-H play its important role here: secondary metabolites are compatible with the plant, engaging it as if they were rapidly absorbed nutrients, masking the herbicide molecules' functional power and avoiding herbicide detoxification mechanisms in the plant, such as redox reactions, which favors effectiveness of the products.

Oxidation is one of the initial processes in the detoxification of chemical compounds in plants, including herbicides, which can happen for the removal of a proton (H+) or the addition of oxygen in the form of hydroxyl ion (OH−). Oxidation of the herbicide can cause different structural modifications of the molecule, such as rupture of covalent bonds.

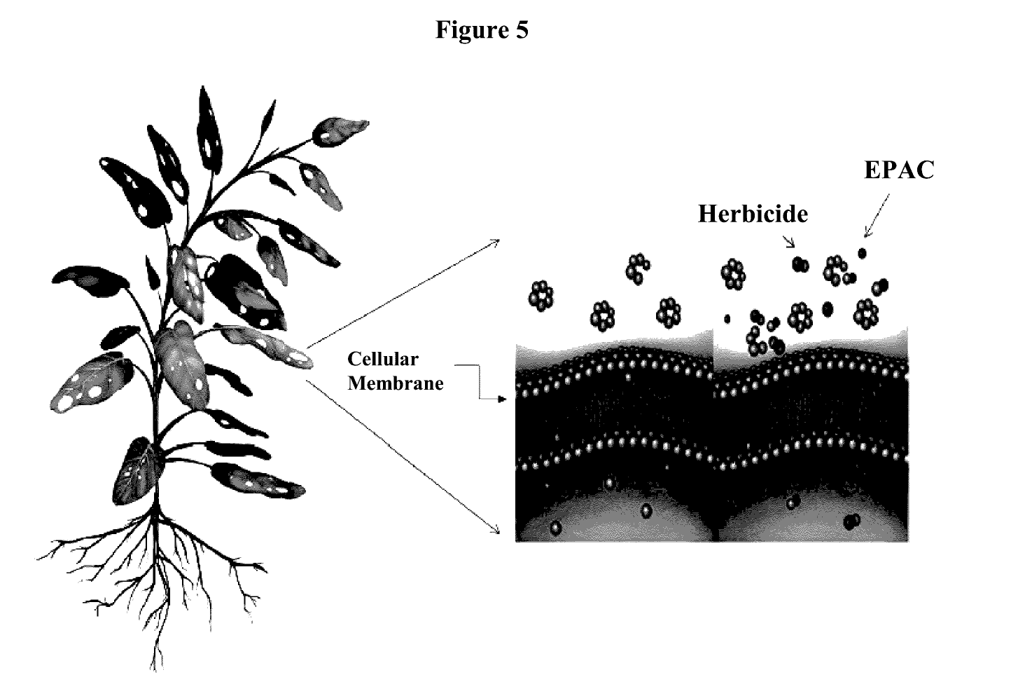

Once the EPAC-H/herbicide complex is recognized as a nutrient or a non-harmful substance, this is absorbed by the plant through natural processes of transport of substances (active and passive transport) as shown in FIG. 5, without altering the characteristics of the herbicide and enhancing its function.

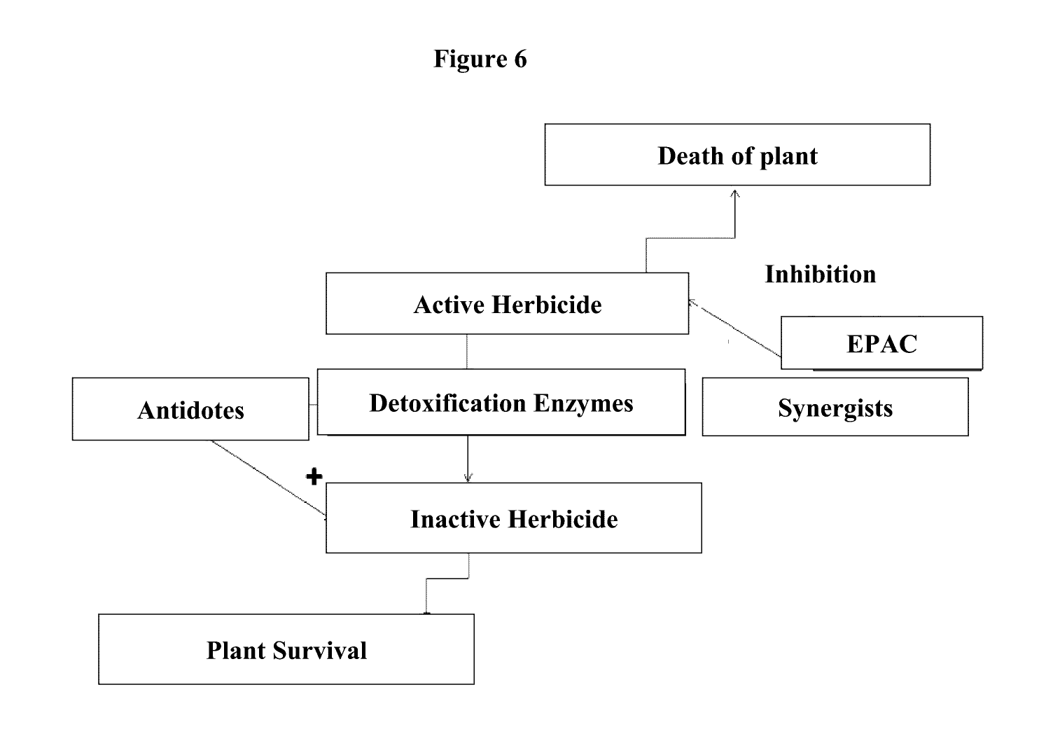

Once the EPAC-H/Herbicidecomplex has been absorbed, a translocation process occurs in which the herbicide disturbs many of the essential physiological processes of plants (depending on the mode of action of the herbicide). After the translocation of the EPAC-H/Herbicide complex, the EPAC-H (enhancer or synergist) inhibits the enzyme system detoxification of plants and overcomes the defense system of the plants, enhancing herbicide phytotoxicity quickly, in contrast to the effect of products which act as herbicide antidotes stimulating degradation as shown in FIG. 6.

After inhibition of the defense system of plants through enzymes detoxification as a result of the enhancer, the herbicide is activated, causing the death of the plant. Thus, although EPAC-H has no inherent herbicidal activity, it increases the effectiveness of specific herbicides only by forming complexes with each of these chemicals.

### Examples of Applications EPAC-H—Glyphosate and Bispyribac

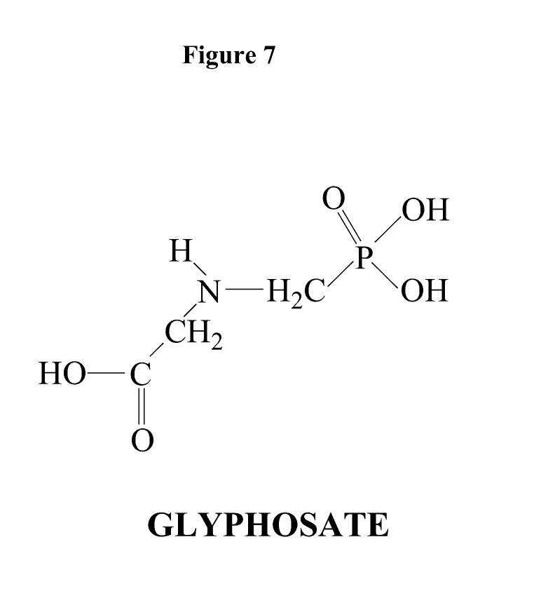

One of the most widely used herbicides in the world that can be enhanced by EPAC-H is glyphosate, a non-selective, broad-spectrum systemic herbicide, which is applied to the foliage at the post-emergence stage and inhibits the synthesis of amino acids in plants. From the chemical standpoint glyphosate is N-phosphonomethyl-glycine and is characterized by its high polarity and consists of three functional groups: amino, carboxylate and phosphonate. FIG. 7 shows the structural formula of glyphosate.

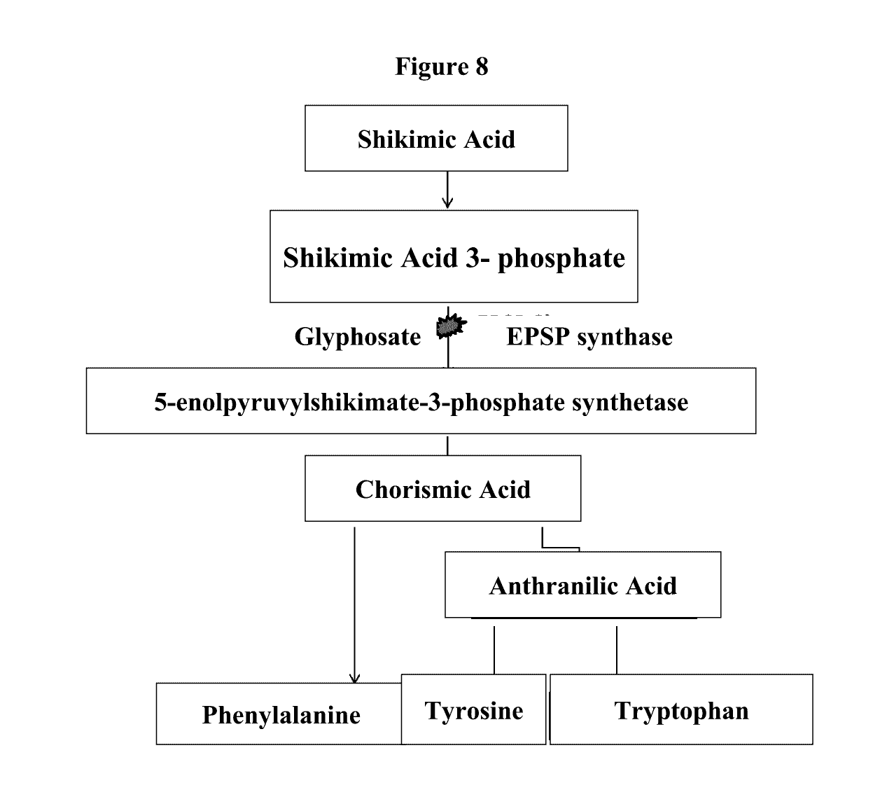

Glyphosate is transported throughout the plant, acting on various enzyme systems and inhibiting the metabolism of several amino acids via the shikimic acid route. This route is the first step in the synthesis of aromatic amino acids in plants in which the enzyme 5-enolpyruvylshikimate-3-phosphate synthase (EPSPS) present in plants, becomes an excellent target for the action of glyphosate, because it competes for the same enzyme sites, blocking the biosynthesis of aromatic amino acids essential for the life of the plant as shown in FIG. 8.

As a result, a slow death of the plant, starting with stunting of growth, followed by chlorosis and finally tissue necrosis occurs.

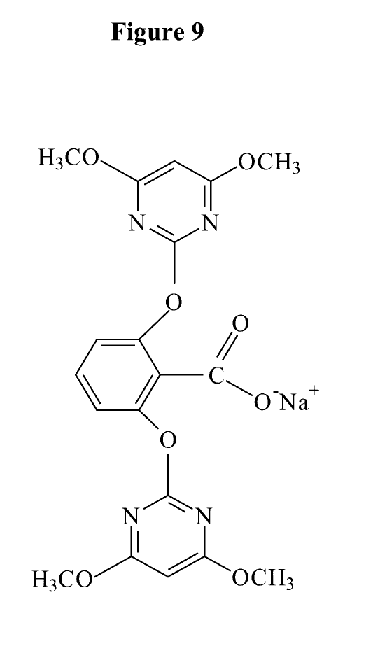

EPAC-H has also been found to enhance other herbicides such as bispyribac, a selective, no residual postemergence herbicide. From the chemical point of view, the bispyribac is characterized as a herbicide composed of carbon, hydrogen, oxygen and nitrogen. It belongs to the chemical group Pyrimidinyloxibenzoic acid, i.e., it is a benzoic acid derivative as shown in FIG. 9.

As glyphosate, it is an inhibitor of the synthesis of amino acids, but in contrast to the latter bispyribac inhibits BCAAs. Bispyribac active ingredient inhibits the enzyme acetolactate synthase (ALS), which is essential for the biosynthesis of valine, leucine and isoleucine. This inhibition interferes with cell division and causes the plant growth to stop. The interruption of growth continues with chlorosis, necrosis and death of weeds.

Additional herbicides that can be combined with EPAC-H include Alachlor, Atrazine, Bentazon, Bialaphos, Butachlor, Butylate, Chlorimuron ethyl, Chlorsul furon, Cinmethylin, Clomazone, Cyanazine, Cycloate, Dicamba 2,4-D (2,4-dichlorophenoxyacetic acid), EPTC, Ethephon, Fenoxaprop, Fluazifop-butyl, Fomesafen, Glufosinate, Glyphosate, Haloxyfop, Hoelon, Imazapyr Imazaquin, Imazethapyr, Linuron, Mefluidide, Metolachlor, Metribuzin, Metsulfuron, Molinate, Norflurazon, Oryzalin, Oxyfluorfen, Paraquat, Pendimethalin, Picloram, Propachlor, Propanil, Pyridate, Sethoxydim, Simazine, S,S,S-tributyl phosphorothioate, Sulfometuron, Sulfosate and Trifluralin.

### EPAC-I: Enhancer for Organic Chemical Insecticides

EPAC-I is a product of organic origin that helps to enhance the activity of a variety of insecticides of chemical origin. It may be added to the different existing molecules for edaphic foliar use. Each EPAC-I is designed for a specific chemical insecticide in order to minimize the active ingredient while substantially maintaining or increasing their effectiveness.

It consists of secondary metabolites that interact with chemicals formulated as insecticides for phytosanitary control in intensive crops. Its composition increases stability and compatibility between different insecticide molecules for agricultural use overcoming the molecular attraction between molecules for different insect control, which ensures greater homogenization, greatest potential applications and control of active ingredient per unit. EPAC-I increases the sensitivity of the active ingredients against the insects and it is designed for certain control mechanisms and increases resistance of the plants, making them more proactive with controlling treatment. The organic composition of EPAC-I with low adhesion prevents losses of active elements of insecticides to plant leaves, reducing stress on the chemical, beneficial microorganisms and plants.

EPAC-I is a fully biodegradable formulation requiring less active ingredient when combined, contributing to agrochemicals having low leachability in soils, which favors the reduction of pollutants in the environment.

### Composition and Characteristics

EPAC-I is the result of fermentation processes from plant materials (to which there is added Garlic Cloves—Allium sativum and Tabasco Pepper Fruits—Capsicum frutescens) containing a mixture of secondary and tertiary metabolites that allow it to interact with different insecticides. The physicochemical characteristics of various metabolites that make EPAC-I give it the capability to enhance each insecticide, depending on the initial selection of the farmer. Furthermore, the organic nature allows rapid absorption of the chemicals mixed with it, enabling a significant reduction in the amounts of chemicals applied and rejection losses.

### Advantage

Secondary metabolites of EPAC-I increase the stability and compatibility between different insecticidal molecules—for agricultural use. The organic composition of EPAC-I overcomes the weak molecular attraction of insecticidal molecules which ensures greater homogenization, greatest potential applications and control of active ingredient per unit.

The organic composition of EPAC-I increases the phythogenic sensitivity of the active ingredients designed for control of the insects by enhancing the effects of chemical insecticides with lower dose of product. EPAC-I increases the resistance mechanisms of the plants, making them more proactive for treatment and control of insects.

The organic composition of EPAC-I having low adhesion prevents losses of insecticidal active elements on to plant leaves, reducing chemical stress on the beneficial microorganisms, and plants.

### EPAC-I as Enhancer of Insecticide Chemicals

More than a million known species of insects feed on plants, and of these, approximately 700 worldwide species cause the most damage to crops, both in the field and in storage. Therefore, chemical insecticide control plays an important role for farmers and society as it helps keep pest populations to tolerable levels to protect crops. Despite this, the indiscriminate use of synthetic insecticides has caused a negative impact on human health, agricultural ecosystems and the environment.

The indiscriminate use of insecticides also creates the appearance of insect populations that are increasingly resistant to these products. Therefore when insecticides are used, proper pest control involves at least: knowledge of pest biology (habits, behavior), most sensitive biological state, etc, as well as economic threshold and appropriate selection of an insecticide. Once the insecticides can exert action on one or various stages of insects such as arthropod development, they can be considered ovicides, larvicides and adulticides if they eliminate eggs, larva or adults, respectively.

Because of the problems mentioned earlier, new alternatives for insect pest management are highly desirable. Plant secondary metabolites have recently been considered an appropriate field to search for new compositions with less environmental impact and potential for agricultural pest control, giving rise to a more organic agriculture.

EPAC-I is an organic product obtained from plants and it represents a significant contribution as an alternative to boost agricultural pest control while decreasing the dose of insecticide application, which contributes to lower environmental impact with the use of these products. Likewise, EPAC-I allows for the control of insects that have developed insecticide resistance without increasing the insecticide dosage.

### Mode of Action EPAC-I

Considering the processes that occur from the time of application of an insecticide until you find the site of action in an organism such processes include:

### Contact

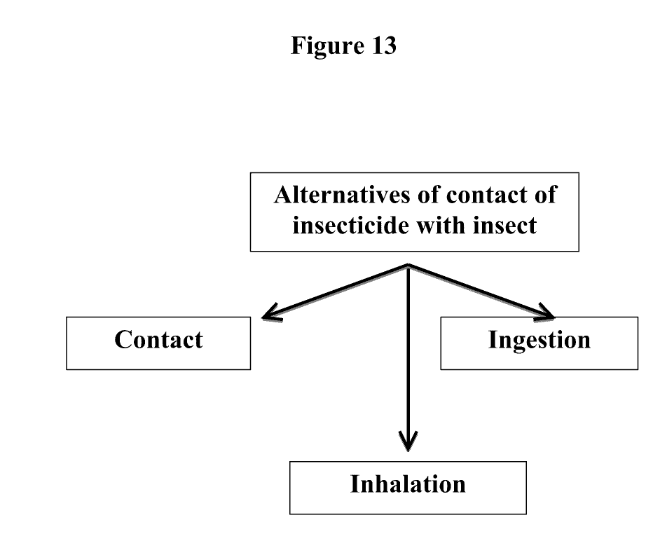

Some insecticides may be applied in more than one form of incorporation, which is closely linked to the mechanism of action of the insecticide inside the insect. Therefore, how an insecticide is incorporated into the insect is crucial to exercise its action effectively. The incorporation or contact insecticide with the insect can occur in different ways: by contact, inhalation, or ingestion either when the insecticide is absorbed by the treated plant and insects ingest the product while feeding on plants. See FIG. 13 for a schematic.

On the other hand, the chemical structures of chemical insecticides are widely varied and complex, which influences the toxicological and environmental properties of these products. Adding EPAC-I allows a certain insecticidal chemical compatibility between different molecules and organic molecules of EPAC-I, which in turn favor overcoming the cuticular barrier as one of the larger obstacles that a conventional insecticide must overcome during contact and entry into the insect (in the case of contact insecticides), or enter the plant (systemic insecticides) and exert their toxic effect.

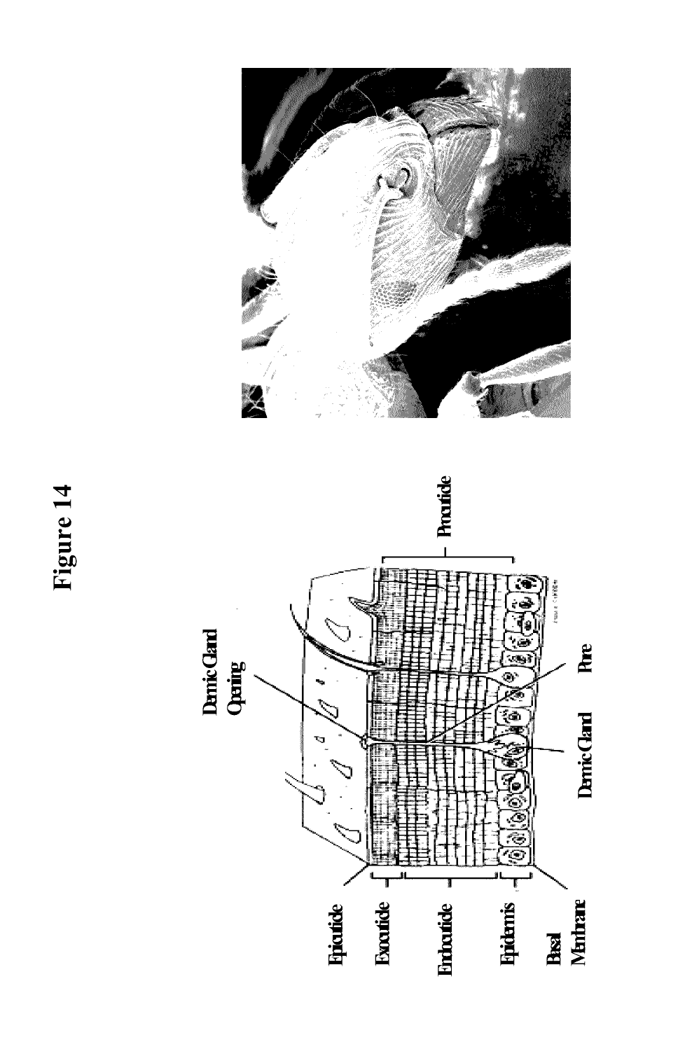

The insect cuticle is composed of chitin, which determines the shape and appearance of insects and is the protective barrier between the internal and physiological systems surrounding the environment of insects. The chitin consists of N-acetyl-D-glucosamine linked together by (1, 4) links. This gives it a flat structure as supporting tissue for their ability to associate with hydrogen bonds. FIG. 14 illustrates the composition of the insect cuticle.

Chitin is the main barrier in insects and it is one of the major contributing factors to conventional insecticide oxidation, leading to product losses. Chitin is an organic material, and when EPAC-I makes contact with this material, in enhances the insecticide function. Therefore, a conventional insecticide mixed with EPAC-I is less likely to suffer losses by chemical oxidation of the product, which contributes to improving their effectiveness.

The functional properties of EPAC-I allow the breaking of the bonds between the complex insecticidal molecules resulting in EPAC-I complexes that are chemically-compatible with the insecticide, facilitating their incorporation into insect or plant body and subsequent absorption.

The mode of action of ingestion of some insecticides is also applicable to both aquatic insects and larvae of agricultural crops, so when a conventional insecticide is used, it is important to spray through the leaves, so the larvae product is applied between the system. Still, when conventional insecticides are applied, there can be uncovered areas, which are used by insects to feed and avoid dying when poisoned with insecticide during ingestion. The addition of EPAC-I to a conventional insecticide, ensures that the contact surface is increased with the insect that feeds on the plant and therefore can eat the amount of product required to cause the toxic effect.

### Absorption

The insect cuticle also plays a critical role in the absorption stage of EPAC-I. In chitin, one can also find structures or external ornaments as furrows, wrinkles, hair, scales, and symbiotic microorganisms, which easily recognize the EPAC-I-Insecticide complex which decreases the surface tension of water on product application, favoring its absorption by the insect. EPAC-I is recognized or interpreted as a germicide by symbiotic microorganisms, which activate their defense system against them (thus reducing or abandoning their protective role for the insect) and allow the EPAC-I/Insecticide to be absorbed without any biological oxidation and, once achieved, the insecticide exerts its action.

The absorption and subsequent metabolism of the insecticide will vary depending on the type of insecticide, which is linked to the mode of action. Absorption by the insect's body is also variable depending on the above two factors. In the case of contact insecticides, the EPAC-I/Insecticide complex penetrates through the integument and is distributed laterally within the integument reaching the site of action via the tracheal system.

On the ground, insecticides undergo a process of degradation and metabolism. The degradation is due mostly to ultraviolet light and also dust particles deposited on the foliage. The plant symbiotic microorganisms also play an important role in the degradation process. In the case of conventional insecticides only part of the product can be absorbed by the plant. In leaves, penetration depends on the quality of the leaf surface and the cuticular wax, so that for an insecticide entering the plant certain conditions must be met between those who have good coverage and where the product exhibits adequate retention or capacity to remain in the foliage and not fall out of it. The EPAC/-I-Insecticide complex favors the increase of the mixture received by the foliage decreasing the chemical stress on plants and beneficial microorganisms.

For systemic insecticides, the EPAC-I-Insecticide complex is absorbed by the plant as a quickly absorbed nutrient. The EPAC-I-Insecticide complex secondary metabolites are to recognized by the plant as a nutrient and promotes natural production of secondary metabolites with insecticidal properties in plants.

### Translocation

EPAC-I increases the sensitivity of the phythogenic insecticide active ingredients designed to control insects. Once the EPAC-I/-Insecticide complex has been absorbed by the insect, the complex is translocated and dissolved in the hemolymph, which leads to the site of action, depending on the type of insecticide, and other organs where they accumulate and exert their toxic effect.

Once absorbed by the plant, the EPAC-F-Insecticide complex moves in various directions, enhancing the insecticidal effect and increasing resistance mechanisms of plants making them more proactive with good treatment control.

The EPAC-I is combined with other pesticides selected from the group consisting of: abamectin, acephate, acetamiprid, acrinathrin, alanycarb, aldicarb, allethrin, alpha-cypermethrin, aluminium phosphide, amitraz, azadirachtin, azamethiphos, azinphos-ethyl, azinphos-methyl, bendiocarb, benfuracarb, bensultap, beta-cyfluthrin, beta-cypermethrin, bifenthrin, bioallethrin, bioallethrin S-cyclopentenyl isomer, bioresmethrin, bistrifluron, borax, buprofezin, butocarboxim, butoxycarboxim, cadusafos, calcium cyanide, calcium polysulfide, carbaryl, chlorantraniliprole, carbofuran, carbosulfan, cartap, chlorethoxyfos, chlorfenapyr, chlorfenvinphos, chlorfluazuron, chlormephos, chloropicrin, chlorpyrifos, chlorpyrifos-methyl, chromafenozide, clothianidin, cyantraniliprole, coumaphos, cryolite, cyanophos, cycloprothrin, cyfluthrin, cyhalothrin, cypermethrin, cyphenothrin, cyromazine, dazomet, deltamethrin, demeton-S-methyl, diafenthiuron, diazinon, dichlorvos, dicrotophos, dicyclanil, diflubenzuron, dimethoate, dimethylvinphos, dinotefuran, di sulfoton, emamectin, emamectin benzoate, empenthrin, endosulfan, esfenvalerate, ethiofencarb, ethion, ethiprole, ethoprophos, ethylene dibromide, etofenprox, etoxazole, famphur, fenitrothi on, fenobucarb, fenoxycarb, fenpropathrin, fenthion, fenvalerate, fipronil, flonicamid, flucycloxuron, flucythrinate, flufenoxuron, flumethrin, formetanate, formetanate hydrochloride, fosthiazate, furathiocarb, gamma-cyhalothrin, halofenozide, heptachlor, heptenophos, hexaflumuron, hydramethylnon, hydroprene, imidacloprid, imiprothrin, indoxacarb, isofenphos, isoprocarb, isopropyl O-(methoxy-aminothiophosphoryl)salicylate, isoxathion, lambda-cyhalothrin, lithium perfluoro-octane sulfonate, lufenuron, magnesium phosphide, malathion, mecarbam, mercurous chloride, metaflumizone, metam, metam-sodium, methamidophos, methidathion, methiocarb, methomyl, methoprene, methothrin, methoxychlor, methoxyfenozide, metofluthrin, methyl isothiocyanate, metolcarb, mevinphos, milbemectin, monocrotophos, naled, naphthalenic compounds, nicotine, nitenpyram, nithiazine, novaluron, noviflumuron, omethoate, oxamyl, oxydemeton-methyl, parathion, parathion-methyl, pentachlorophenol, pentachlorophenyl laurate, permethrin, petroleum oils, phenothrin, phorate, phosalone, phosmet, phosphamidon, phosphine, pirimicarb, pirimiphos-methyl, prallethrin, profenofos, propaphos, propetamphos, propoxur, prothiofos, pymetrozine, pyraclofos, pyrethrins, pyridalyl, pyridaben, pyridaphenthion, pyrimidifen, pyriproxyfen, quinalphos, resmethrin, rotenone, sabadilla, silafluofen, sodium cyanide, sodium pentachloro-phenoxide, spinetoram, spinosad, sulcofuron, sulcofuron-sodium, sulfluramid, sulfotep, sulfuryl fluoride, sulprofos, tau-fluvalinate, tebufenozide, tebupirimfos, teflubenzuron, tefluthrin, temephos, terbufos, tetrachlorvinphos, tetramethrin, theta-cypermethrin, thiacloprid, thiamethoxam, thiodicarb, thiofanox, thiometon, thiosultap-sodium, tolfenpyrad, tralomethrin, transfluthrin, triazamate, triazophos, trichlorfon, triblumuron, trimethacarb, vamidothion, xylylcarb, zeta-cypermethrin, zinc phosphide, beet juice, D-limonene, cedarwood oil, castor oil, cedar oil, cinnamon oil, citric acid, citronella oil, clove oil, corn oil, cottonseed oil, eugenol, garlic oil, geraniol, geranium oil, lauryl sulfate, lemon grass oil, linseed oil, malic acid, mint oil, peppermint oil, 2-phenethyl propionate (2-phenylethyl propionate), potassium sorbate, rosemary oil, sesame oil, sodium chloride, sodium lauryl sulfate, soybean oil, and thyme oil and mixtures thereof.

### EPAC-N: Enhancer for Organic Chemical Fertilizers

EPAC-N is also an organic product obtained by fermentation of plant materials interacting with chemicals formulated as nutrients for plants in intensive crops. EPAC-N reduces physical and mechanical resistance of plants both in the air and soil structure of chemical molecules, decrease the toxicity of the chemicals to the beneficial soil biota and reduces the potential for the same nutritional phythogenic microorganisms. EPAC-N differs from other enhancers in that it prevents or reduces crop nutrient leaching in soils, reducing the environmental impact.

### Composition and Characteristics

EPAC-N is the result of fermentation processes from plant materials containing a mixture of secondary metabolites that allow it to interact with different fertilizers. The physicochemical characteristics of various metabolites that make EPAC-N confer the ability of the existence of a EPAC-N different for each fertilizer family. Furthermore, the organic nature allows rapid absorption of the chemicals mixed with it, enabling a significant reduction in the amounts of chemicals applied and rejection losses.

### Advantage

The secondary metabolites of EPAC-N interact with chemicals formulated as plant nutrients in intensive crops. EPAC-N prevents loss or product, changes low adhesion of nutrients to the leaves of plants thereby increasing their effectiveness. Secondary metabolites of EPAC-N reduce the physical and mechanical resistance of plants, both in the roots and leaves to the adherence of the chemical molecules.

EPAC-N decreases the toxicity of the chemicals to the beneficial soil biota and reduces the nutritional potential for pathogenic microorganisms. EPAC-N reduces leaching of agricultural nutrient in soils.

### EPAC-N as Chemical Fertilizer Enhancer

Under natural conditions the soils should contain all the essential elements required for plant development, however, in most cases they are not sufficient to obtain high yields and good crop quality due to nutrient depletion. An infertile soil produces less, has less vegetation and is more exposed to erosion. This brings about low yields and poor quality of the crop.

To achieve the highest possible yields, the loss of nutrients should be limited, or nutrients must be added, therefore the use of fertilizers has become indispensable. When no fertilizer is used, it results in lower harvest yields because of the gradual impoverishment of the soil nutrients.

The integration of fertilizers into favorable agricultural practices provides for the addition of the nutrients that plants need, in sufficient quantities, in balanced proportions, in the required available form, and in the period that plants require for sustainable agriculture.

### Mode of Action EPAC-N

The movement of plant fertilizers depends on the absorption capacity and the demand for fertilizer, so that this movement involves different interconnected metabolic processes such as: (a) contact or retention of the product, (b) uptake, (c) translocation and utilization within the plant soil and transport to the roots and leaves for uptake and translocation,

### Contact or Retention of the Product

At this stage, the fertilizer is applied on the surface of the leaves or soil. It is recommended that the fertilizer is maintained in contact with the leaves or soil as long as possible to increase the probability of being absorbed. Mixed with conventional fertilizer EPAC-N is favored during the contact with the ground through its organic properties. EPAC-N increases cuticle permeability leading to the nutrients being maintained longer in contact with the leaf surface. The complex EPAC-N/Fertilizer is easily contacted by the plant through its functional properties and is recognized as a nutrient, thus naturally and rapidly absorbed.

### Absorption

Once the EPAC-N-Fertilizer complex has contacted the ground, subsequent—absorption and transport occurs through the plant cells' different layers. Absorption in leaves and other aerial parts of the plants is regulated by the epidermal cells of the external walls of the leaves. Nutrients—penetrate leaves through the stomata found in the beam or underside of the leaves and also through spaces termed submicroscopic ectodesmos in leaves, which expand the cuticles of the leaves' gaps, allowing nutrient penetration to occur.

The absorption of nutrients through the leaves is affected by external factors such as the concentration of the product, nutrients involved, the companion ion application technology, conditions and environmental factors such as temperature, relative humidity, precipitation and wind, as well as by internal factors such as metabolic activity.

The nutrients can be absorbed in the form of molecules or ions. The plant takes its mineral nutrients in ionic form, but eventually molecules are absorbed, either by the leaf or root. The size of the molecule affects absorption; very large molecules have very little chance of entering the cell. Conventional fertilizer mixed with EPAC-N not only increases their chances of being absorbed on contact with the ground because EPAC-N favors the breaking of intermolecular forces in the fertilizer, facilitating binding and organic enhancement and natural penetration into plant.

### Translocation

During this process the EPAC-N/Fertilizer complex is mobilized to the organs of the plant being transported from the epidermal cells to the plant organs where it is required, which cross intercellular spaces (apoplast) or cells of different tissues (symplast). Once the nutrients reach the vascular tissue (xylem and phloem especially), mobility is dramatically accelerated to target tissues. Transport of nutrients to the root, the uptake and translocation of the same, all occurs simultaneously. Therefore, if a change occurs in one of these processes the others are affected. In other words, if a process becomes slow, this will be a limiting factor in the absorption and translocation of nutrients in the plant. The plant's response to the application of organic fertilizer enhancer such as EPAC-N is to invigorate and stimulate vegetation in producing nutrients naturally.

### EPAC-G: Enhancer Organic Chemicals Germicides

EPAC-G is a product of organic origin that helps to enhance a variety of germicides of chemical origin. It may be added to different existing molecules as edaphic or foliar application. Each EPAC-G is designed for a specific chemical germicide family in order to minimize the active ingredient while substantially maintaining or increasing their effectiveness.

EPAC-G consists of secondary metabolites that interact with chemicals formulated as germicides for phytosanitary control in intensive crops. Its composition increases stability and compatibility between different agricultural molecules and attraction between different molecules and enhances their germicidal use in control of microorganisms, which ensures greater homogenization, greatest potential applications and control of active ingredient per unit.

EPAC-G increases the sensitivity of pathogenic microorganisms to active ingredients designed for phytosanitary control and in turn the mechanisms of resistance of plants making them more proactive in treatment control. EPAC-G decreases formulation requirements, helping agrochemicals to exhibit low leachability in soils, which favors the reduction of pollutants in the environment.

### Composition and Characteristics

EPAC-G is the result of fermentation processes from plant materials (to which are added after fermentation Horsetail Leaves—Esquisetum arvense and Powdered Cinnamon. Cinnamomum zeylanicum) containing a mixture of secondary metabolites that allow it to interact with various germicides. The physicochemical characteristics of various metabolites that make EPAC-G confer the enhancement ability of EPAC-G for each germicide family Furthermore, the organic nature allows rapid absorption of the chemicals mixed with it, enabling a significant reduction in the amounts of chemicals applied and rejection losses.

### Advantage

The secondary metabolites of EPAC-G increases stability and compatibility between different agricultural molecules and their germicidal agricultural use. EPAC-G enhances germicidal molecules, which ensures greater homogenization, greatest potential applications and control of active ingredient per unit. The organic composition of EPAC-G increases the sensitivity of the phythopathogenic microorganisms to the active ingredients designed for control them, by enhancing the effects of chemicals with a lower dose of germicidal product.

EPAC-G increases the resistance mechanisms of the plants, making them more proactive in treatment control. EPAC-G secondary metabolites prevent low adhesion losses of active elements of germicides in plant leaves. They also reduce chemical stress on the beneficial microorganisms and plants.

### Mode of Action EPAC-G

Although there are differences among microorganisms that attack plants: fungi, bacteria and viruses, all germicides have a mode of action with similar characteristics. All germicides generally must make contact with the pathogen, be absorbed and then translocated.

### Contact

All biocides affect microorganisms by any of the following mechanisms of action: denaturation of proteins, cell membrane rupture, removing sulfhydryl groups, antagonism and chemical oxidation. To exercise this mechanism of action a germicide must first make contact with the microorganism and enter it. The functional properties of EPAC-G decreases the surface tension of water upon germicidal application of EPAC-G/Germicidal complex, therefore increasing the permeability of the cell membrane of pathogens, facilitating entry and exit of water protoplasm and making the cells burst. Thus, all biochemical reactions dependent on these enzymes are inhibited in the wall of the bacteria or mycelial fungi spore, and distort cell membrane permeability. Cell membrane rupture and distortion of essential proteins occurs in the cytoplasm (plasmolysis) and causes cell death, in addition to the dissolution of pathogenic virus capsid.

All conventional germicides are highly toxic, however, microorganisms have the ability to develop resistance mechanisms to evade the effect of these products. A general feature of most is that while conventional germicides exert their effect, the pesticide molecules undergo a process of degradation. The molecules of the conventional germicide enhanced with EPAC-G reduce their chemical oxydation capacity, remaining longer on the plant. At the same time, the biological oxydation of this substance is increased, so the chemical residuals left on the soil and waters degrade faster.

### Absorption

Once contact has been made, the EPAC-G/Germicidal complex must accumulate to reach a lethal or inhibitory concentration for the microorganism. During the absorption process through the microorganism it must penetrate through the germ tube or the cellular membrane. The EPAC-G/-Germicidal complex absorbed by plants, provide active defense mechanisms producing secondary metabolites that counteract the attack of pathogens reducing its devastating effect.

### Translocation

The germicidal composition should interfere with cell metabolism in one or more sites of action. Due to the properties of EPAC-G, plants exhibit more rapid remission of symptoms, better vegetative development, strengthening the tissues to prevent pathogen attack, improves the defense mechanisms, and provide effective control against phythopathogenic microorganisms.

EPAC-G's are combined with germicides such as Mancozeb, Tricyclazole, Carbendazim, Hexaconazole, Metalaxyl, Benomyl, Difenoconazole, Propiconazole, Kitazin, Tebuconazole, Copper oxychloride, Copper hydroxide, Tridemorph, Propineb, Hexachlorophene, Dichlorophen, Bronopol, Copper Hydroxide, Cresol, Dipyrithione, Dodicin, Fenaminosulf, Formaldehyde, 8-Hydroxyquinoline Sulfate, Kasugamycin, Nitrapyrin, Octhilinone, Oxytetracycline, Probenazole, Streptomycin, Tecloftalam and Thiomerosal and mixtures thereof.

It should be emphasized that the enhancers of the invention can also be combined with other chemical products to enhance their activity. Other chemical products include household chemicals such as detergents, mold removers, bleach chemicals, surface cleaners that include antibactericidal agents, antifungal agents. Additional products include, industrial chemicals, and medicinal the micals. Among medicinal chemicals that can be enhanced include chemotherapeutic agents for the treatment of cancer. Particular anticancer agents include cyclophosphamide, ifosfamide, temozolomide, capecitabine, 5-fluoro uracil, methotrexate, gemcitabine, pemetrexed, mitomycin, bleomycin, epirubicin, doxorubicin (pegylated liposomal), etoposide, paclitaxel, irinotecan, docetaxel, vincristine, carboplatin, cisplatin, oxaliplatin, bevacizumab, cetuximab, gefitinib, imatinib, trastuzumab, denosumab, rituximab, sunitinib, zoledronate, abiraterone, anastrozole, bicalutamide, exemestane, goserelin, medroxy-progesterone, octreotide, tamoxifen, bendamustine, carmustine, chlorambucil, lomustine, melphalan, procarbazine, streptozocin, fludarabine, raltitrexed, actinomycin d/dactinomycin, doxorubicin, mitoxantrone, eribulin, topotecan, vinblastine, vinorelbine, afatinib, aflibercept, bcg, crizotinib, dabrafenib, interferon, ipilimumab, lapatinib, nivolumab, panitumumab, pembrolizumab, pertuzumab, sorafenib, trastuzumab, temsirolimus, vemurafenib, ibandronic acid, pamidronate, bexarotene, buserelin, cyproterone, degarelix, folinic acid, fulvestrant, lanreotide, lenalidomide, letrozole, leuprorelin, megestrol, mesna and thalidomide, combinations thereof as well as all FDA approved chemotherapeutic agents for all diseases.

### EXAMPLES

As will be appreciated by those skilled in the art, the following examples are representative of the present invention. All formulations herein described may be further optimized, as all such further development should be considered within the scope of the present invention.

The herbicidal, insecticidal, fungicidal, miticidal and pesticidal action of the compositions described herein can be seen from the examples which follow. While the individual active compounds may show weaknesses in their action as an individual agent, the combination shows a synergistic action, namely that which exceeds a simple sum of the components.

### Example I

The enhancer of the invention is made from a multiplicity of natural materials including essential oils. The enhancer has a multiplicity of components that are manufactured separately first and then mixed with other phytochemicals by processes described herewith.

All water used in the methods of the invention is potable water which has been pre-treated overnight (at least 8 hours) with a metal such as copper, aluminum, iron, gold, platinum, palladiun, silver as well as other metals from the periodic table which are not reactive or toxic with water. The metal can be in the form of a powdered metal, metal flakes, metallic sheets, or metal screens or plaques having a multiplicity of voids. This water is referred to as biodynamic water. The water after treated with a metal may also be treated with ambient air that has been ionized using an ionizer.

### Part A

The following components (Table 5) are used to make Part A using the stepwise procedure outline below:

TABLE 5

| | | AMOUNT |
|---|---|---|
| INGREDIENTS | | (Kg) |
| Red Beans | | 0.1 |
| Peas | | 0.1 |
| Yellow Corn | | 0.1 |
| White Rice | | 5.0 |
| Sea Salt (Without Iodine) | | 0.02 |
| Urea (Or Organic Nitrogen Source) | | 5.0 |
| Biodynamic Water | | 19.61 |
| Bio- | Bacillus Megaterium Or “Yeast | 0.05 |
| Ingredients | Water” | |

| | |
|---|---|
| Total Product | 30.0 Kg |

1. Place the red beans, peas and corn in a pressure cooker or autoclave with 300 cc of biodynamic water and then cook for 30 minutes.

2. Place rice in rice cooker(s) together with the contents of the pressure cooker described in #1 above. (Do not wash rice). If more than one rice cooker is used, distribute the resulting content of pressure cooker in proportion to the 5 kg of white rice. Follow the cooking instructions of the rice cooker and cook the rice mixture. All water added to rice cooker according to instructions should be biodynamic water.

3. Place the content of the rice cookers in a 30-liter container with sufficient water so that blender operates properly. Blend until totally homogenized (½ to 1 minute)

4. Add Urea (or equivalent of organic nitrogen source for a 100% organic product)

5. Add salt

6. Add remainder of water while continuing to mix with blender until fully homogenized.

7. Seal container.

8. Part A is now complete to use as ingredient in the preparation of EPAC precursors.

### Example II

### Part B

The following components are used to make Part B using the stepwise procedure outline below:

TABLE 6

| INGREDIENTS | Amount | |
|---|---|---|
| Banana Essential Oil | 600 | cc |
| Cinnamon Essencial Oil | 600 | cc |
| Coconut Essential Oil | 600 | cc |
| Vanilla Essential Oil | 1.200 | cc |
| Urea or other nitrogen source | 25 | kg. |
| Biodynamic Water | Balance to | |
| | complete 130 L | |
| Total Product | 130.0 | Kg |

1. In an empty 130-liter container place:

a. The Essential oils

b. Urea

c. Add the biodynamic water until filling the container to 130 L while blending with a blender until all materials are fully homogenized (about 3 minutes).

d. Place in 30-liter containers and seal hermetically.

e. Part B is now complete for future use as an ingredient for preparation of EPAC precursors.

### Example III

### Part C

### Preparation of Yeast Water

One Liter of Yeast Water is made using 100 grams of yeast (Saccaromyces cerviciae) traditionally used for bread making and then the balance is biodynamic water to make one liter. The yeast water is made by mixing 100 gr. of yeast with an amount of water sufficient to complete one liter. The containers are then sealed.

In other embodiments the yeast may be replaced by bacillus subtillis and/or bacillus megaterium, in the same quantity.

### Example IV

### Part D

A 50:50 mixture of the minerals listed in table 7 is prepared by mixing the two minerals and grinding as needed to the make the material powdery.

The mineral composition in the formula is derived from mines in the Valle del Cauca region of Colombia and consists of a 50:50 mixture of two minerals having the following elements as the major components (content is reported in ppm):

TABLE 7

| | Mineral 1 | Mineral 2 |
|---|---|---|
| Element | Content in ppm | Content in ppm |
| Ba | 6.5 | 150 |
| Ca | 53000 | 180000 |
| Ce | 0.25 | 2 |
| Co | 0.25 | 2.2 |
| Cu | 0.25 | 0.25 |
| Sr | 510 | 750 |
| Fe | 140 | 8300 |
| La | 0.25 | 1.8 |
| Mg | 4300 | 3200 |
| Mn | 20 | 170 |
| Mo | 0.25 | 0.51 |
| P | 2.5 | 220 |
| K | 2.5 | 47 |
| Se | 2 | 0.55 |
| Si | | |
| Na | 7.5 | 83 |
| Zn | 5.9 | 93 |

### Example V

### Part E

Part E is made by using parts A-D as prepared above and hydrogen peroxide and additional biodynamic water as per the following steps:

1. Part A is fermented for 8 days after adding one liter of Part C and 10 grams of part D.

2. After the eight days of storage the product is subjected to several filtrations using a filter provided with metallic mesh of 40 microns and then the liquid is recirculated with help of a pump in order to make sure the all the fine particles that could be present in the remaining biomass of the filtration could be removed.

3. The filtered product is then mixed with part B and further recirculated with the help of a diaphragm pump through a pipeline exposed to an electromagnetic field (2-10,000 gauss). Additionally the product is exposed to light stimulus which may include UV light or simply blue and green light.

4. The product after step 3 is treated with about 4.8 liters of 50% hydrogen peroxide and then packaged in suitable containers.

Part E is used to make the enhancers of the invention as shown in the further Examples below.

### Example VI

### Preparation of Specialized Phytoadditives

The manufacturing process of EPACs requires the addition to Part E of a specializing ingredient to which we refer as a phytoadditive. Each phytoadditive is manufactured for the specific type of agricultural chemical that it will optimize, whether it is a herbicide (phytoadditive-H), an insecticide (phytoadditive-I), or a fungicide or bactericide (phytoadditive-F).

1. Preparation of Phytoadditives—

The following procedures are used for the preparation of 130 Liters of phytoadditives, which are then mixed with 6,000 liters of part E.

a. For every cubic meter (1,000 liters) of previously prepared biodynamic water insert a biodynamic plaque made out of copper or other highly conductive material (Cu, Ag, Au, etc.), connected by copper (or similar conductive material) wire to a second biodynamic plaque.

b. Place a 30 L container next to each cubic meter container and place the second biodynamic plaque inside.

c. Then, depending on the specialization of the phytoadditive being produced, place in the 30 L container one of the following ingredients (Specializing Agents):

i. phytoadditive-H (Herbicide): 100-200 cc of glyphosate

ii. phytoadditive-I (Insecticide): 100-200 cc of Neem oil

iii. phytoadditive-F (Germicide—fungicide or bactericide): 100-200 cc of citronella oil or limonello oil.

iv. The amount used, varying between 100 and 200 cc depending on the purity and concentration of the Specializing Agent being used.

d. Allow the above experimental set up to stand overnight minimum (8 hours) with one plaque submerged in the biodynamic water and the other submerged in the 30 L container with the Specializing Agent indicated above in c. i, ii, or iii.

e. After standing overnight, throw away the contents of the 301 container. Avoid contamination of anything else with this content.

f. Use the specialized biodynamic water prepared above for the following steps in preparing the specialized phytoadditives.

g. Cook the indicated material and quantities shown in table 8 below (depending on the type of phytoadditive being prepared) placing the specific material(s) in biodynamic water at a ratio of 1:1 (same amount of biodynamic water as the volume of the specific material). Cook in pressure cooker or autoclave for one half (0.5 Hrs) hour.

h. Mix with 20 Liters of biodynamic water to wash out materials. Gently mix thoroughly and filter to separate the solids.

i. Discard solids and use the liquid from this process.

j. The result is the specialized phytoadditive.

k. Mix at a ratio of 130 L of specialized phytoadditive to 6,000 L of Part E to produce EPAC-H, EPAC-I and EPAC-F.

l. The resulting mixture is then treated through a pipeline exposed to an electromagnetic (2-10,000 gauss) field for 8 hours, alternating, one hour on, one hour off. While the mixture is passed through the pipeline, it is also exposed to either UV light or blue and green light.

TABLE 8

| FUNCTION | COMPONENT |
|---|---|
| Herbicida -EPAC- | 1,083 gm - Helecho Marranero Foliage. Pteridium |
| H | aquilinum |
| Fungicida | 542 gm - Cola De Caballo Leaves. esquisetum |
| Bactericida | arvense |
| EPAC-F | 542 gm - Powdered Cinnamon. Cinnamomum |
| | zeylanicum |
| Insecticida | 542 gm - Garlic Cloves. Allium sativum |
| EPAC-I | 542 gm - Tabasco Pepper Fruits. Capsicum |
| | frutescens |
| Fertilizante | 1,083 gm - Pasto Kikuyo Seeds. Pennisetum |
| | clandestinum |

The indicated amounts are for each batch of 130 liters of Specialized phytoadditive.

### Example VII

### Evaluations in the Field and Laboratory

The amount of Epac added in each trial refers to the percentage added based on the total amount of active in the commercial product. Also, the term Ha stands for hectarea which is equivalent to 2.47 acres.

### Glyphosate Enhancement by EPAC-H

EPAC efficiency enhancer-H with glyphosate has been demonstrated in the field. A study was performed with glyphosate to control different species of weeds in rice fields in two locations in Tolima, Colombia (Town 1: Finca Lot Pool, Venadillo and City 2: Villa Isabel, Ambalema) based on an average basis of Fossel application 480 (Glyphosate as the active ingredient) 4 ml/1 with the addition of EPAC-H in a 1 to 10 with respect to active ingredient of the product applied.

The results after five days of treatment was effective control of the different weed species that were evaluated and observed in the locality 1 using 2.8 L/Ha+EPAC-H 192 ml (70% Glyphosate) was the combination presented greater control as an enhancer of Glyphosate; whereas site 2 combinations 2.8 L/ha glyphosate+EPAC-H 192 ml (70% glyphosate) and 2 L/ha glyphosate+EPAC-H 96 ml (50% Glyphosate) were found fit for work, suggesting that is feasible to decrease the dose of glyphosate in field conditions without altering the effectiveness and contrast enhancing effect through the addition of EPAC.

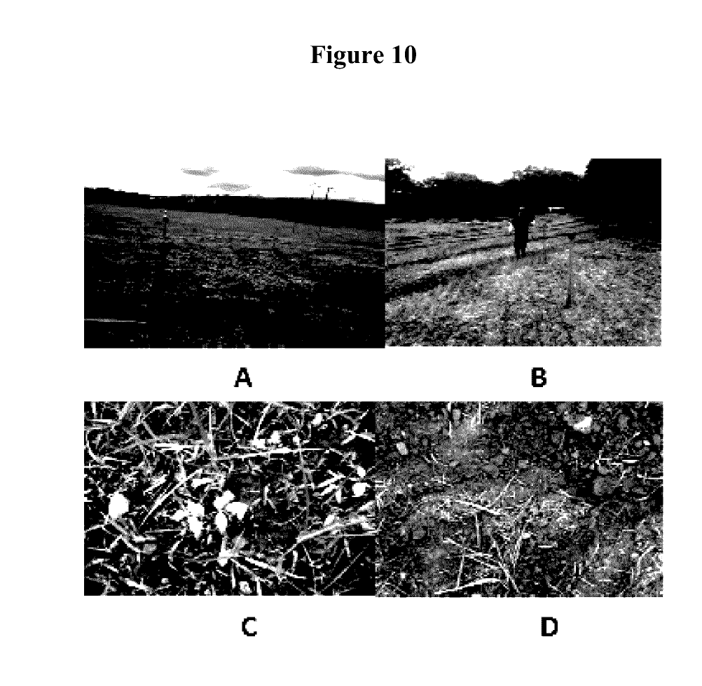

FIG. 10 illustrates with photos the results obtained with EPAC-H as an enhancer of Glyphosate (Fossel 480 SL) in a rice crop in Tolima (A. and C. Pretreatment plots, B. and D. plots after treatment with 480 SL powered Fossel with EPAC-H).

The effectiveness of EPAC-H also was demonstrated in other parts of the country as evidenced by a field assessment conducted in the municipality of Palmira, Valle del Cauca. For this study, 480 Fossel 3 liters (Glyphosate as the active ingredient) per hectare is used, for foliar application with motomochila and combinations thereof was performed using the enhancer EPAC-H. The result was the effective weed control until after 30 days of application using only 50% of Glyphosate+10% EPAC-H, suggesting the feasibility of reducing the use of chemical herbicides again.

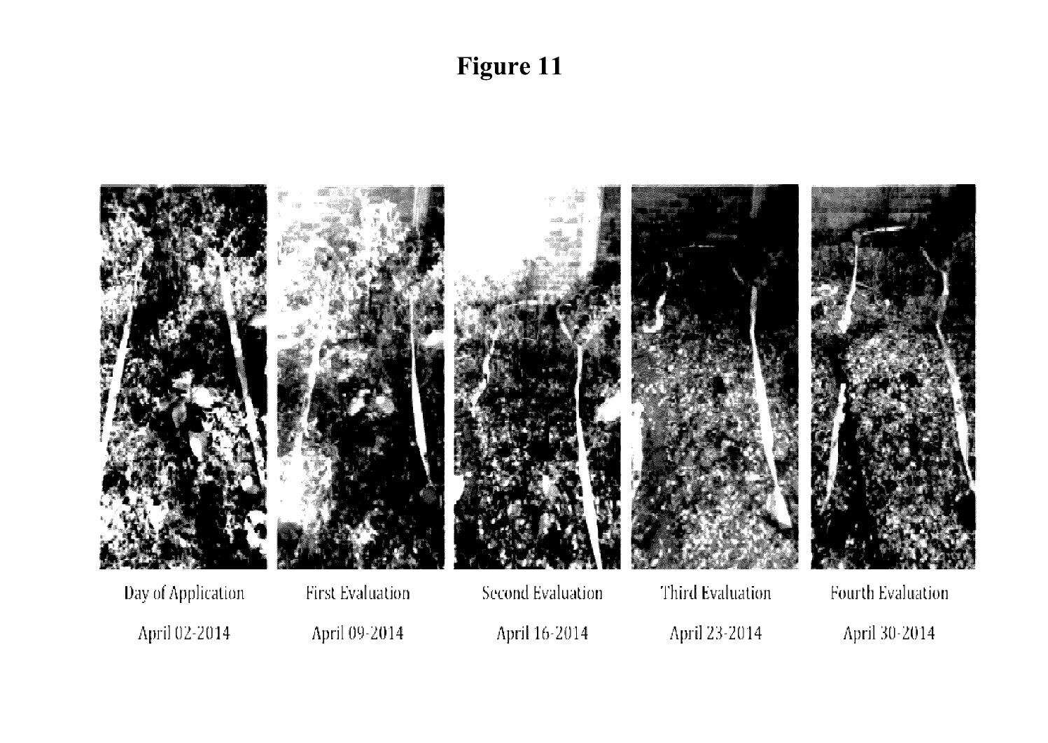

The FIG. 11 photographs also show the results of the field evaluation conducted in the municipality of Palmira, Valle del Cauca using 50% Glyphosate+10% EPAC-H.

### Example VIII

### Bispyribac Enhancement by EPAC-H

EPAC-H efficiency enhancer for bispyribac for weed control in growing corn was evaluated in trials trays. Starting from an average Glistec application base (bispyribac as an active ingredient) to 400 g/L at a dose of 125 ml/ha, with the addition of accompanying product (EPAC-H) in a ratio of 1 to 10% with respect to active ingredient product applied.

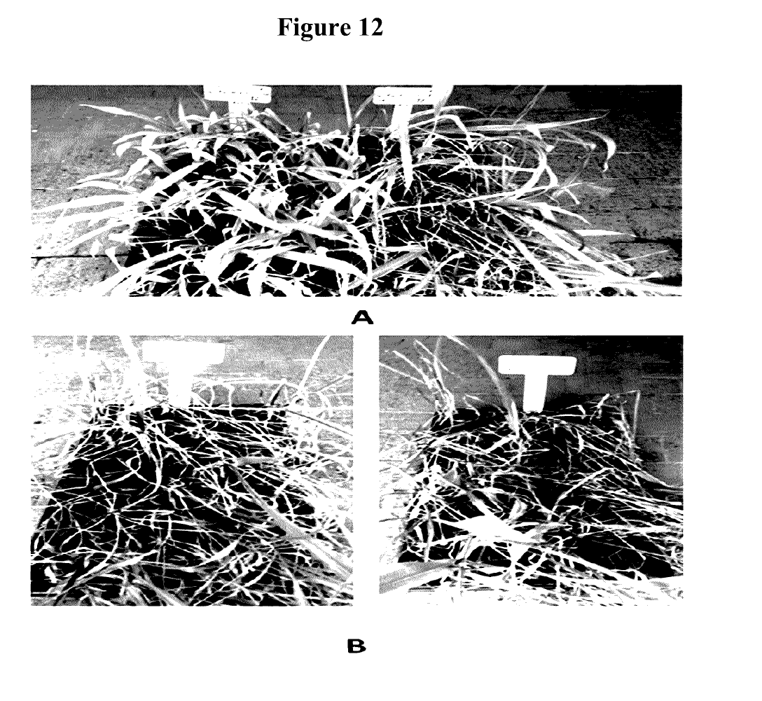

The FIG. 12 photos show the results of the evaluation of effectiveness of EPAC-H as a bispyribac enhancer 400 SC for control of weeds in growing corn. A denotes trays pretreatment (T4: Glistec 50 without EPAC-H/Glistec 50 EPAC-H 5%), B. Trays after treatment (T1: Glistec 100 without EPAC-Hb/Glistec 50 EPAC-H 5%.).

The result was that 50%+5% EPAC bispyribac-H has a 100% higher than performance bispyribac, demonstrating the effectiveness of EPAC-H as bispyribac enhancer while demonstrating the viability of reducing the dose of the herbicide.

### Example IX

### Examples of Applications Epac-I—Methamidophos

Methamidophos is an insecticide with organophosphate group, its chemical name is O, S-dimethyl-phosphoramidothioate. It is a systemic insecticide that acts by contact and ingestion and is used to control sucking and chewing insects that attack crops like corn, potatoes, broccoli, grapes and cotton. It affects the central nervous system by inhibiting the enzyme acetylcholinesterase, resulting in the accumulation of acetylcholine, resulting in muscle overstimulation followed by death of the insect.

### Laboratory Evaluation

### Enhancement of Methamidophos by EPAC-I

The effectiveness of EPAC-I as a methamidophos enhancer was demonstrated in the laboratory. Trialeurodes vaporariorum, one of the most important pests worldwide was used in the study under experimental conditions to test the effectiveness of EPAC-I with nymphs and adults of whitefly.

The effectiveness of EPAC-I on second instar nymphs of T. vaporariorum was done by evaluation of mortality rates by direct and indirect contact.

For the realization of the performance of EPAC-I when used in tomato plants, five leaflets were taken on which a trap clamp into which two pairs of whitefly adults were introduced. Three days after the clamps were removed and the eggs were counted per leaflet, monitoring was conducted on the eggs until they passed the nymph stage II, at which time they were sprayed with the respective treatments.

Product application was performed using a microapplicator (airbrush) at a distance of 15 cm and an angle of 45 degrees on the application unit, achieving a uniform coverage with fine droplets. The quality was verified through application of a strip (2×2 cm) of water-sensitive paper.

5 experimental units per treatment were mounted, and the test plants were kept in a room with controlled temperature (20±1° C.), relative humidity (70±10%) and photoperiod of 12 h. The implemented experimental design was completely randomized with the measured variable survival rate at 10 days after application.

After 10 days of evaluation the highest mortality (96.7%) was obtained using 50% Methamidophos with 10% EPAC-I.

### Example X

### Evaluating the Effectiveness of Methamidophos/EPAC-I with Adult T. vaporariorum

The effectiveness of EPAC-I was assessed with adult T. vaporariorum under experimental conditions taking into account the percentage of mortality by direct and indirect contact with the insects.

The completion of the performance test EPAC-I with adults of T. vaporariorum was carried out directly on whitefly adults collected from breeding individuals in the “Bio-Systems Center”. These were placed in a box with mesh which allows passage of the droplets in the spray. Product application was performed with an airbrush at a distance of 30 cm and a 45° angle on the application unit, achieving a uniform coverage with fine droplets. The quality was verified through application of a strip (2×2 cm) of water-sensitive paper.

To assemble the test, from tomato plants we selected randomly 5 leaflets per treatment and then were sprayed and once dried, in each bags mesh were placed into which 10 adults whiteflies were placed, and each of these units was duly marked according to the assessed treatment. Tomato plants with the evaluation units were maintained in a room with controlled temperature (20±1° C.), relative humidity (70±10%) and photoperiod of 12 h. The evaluation design was completely randomized and readings from day one after application to day 10 were performed.

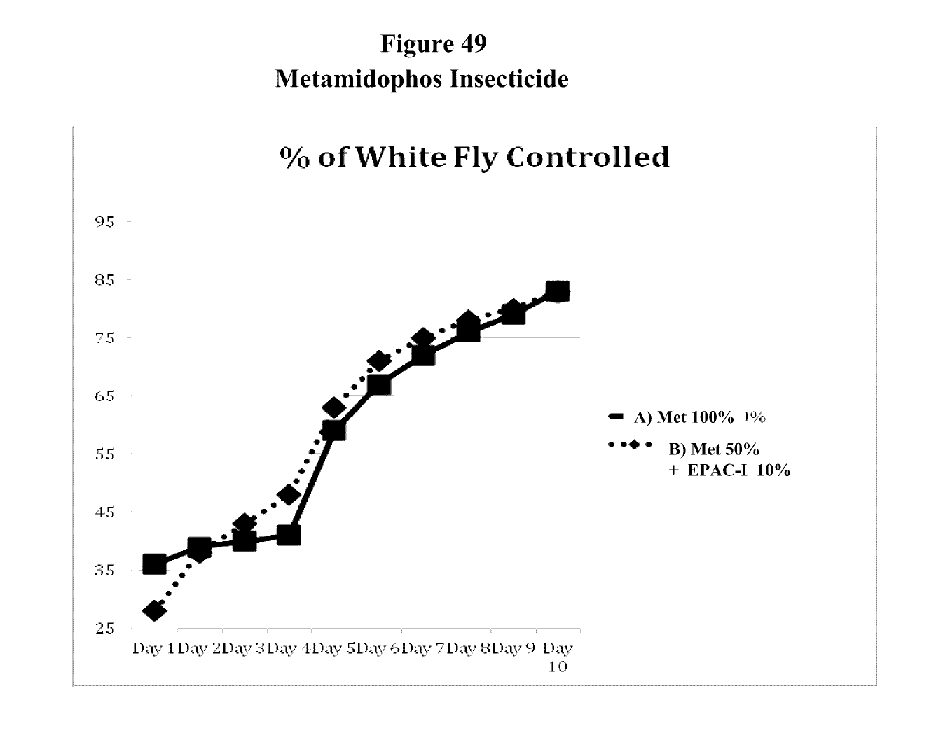

After the number of testing days, the treatment Metamidofos 50%-10% EPAC-I had the highest percentage of mortality. See FIG. 49.

### Example XI

### Laboratory Evaluation

### Azoxystrobin Enhancement by EPAC-F

The effectiveness of EPAC-F as an enhancer of Azoxystrobin has been demonstrated in the laboratory of the CIB (Biological Research Corporation) located in Medellin. In a study in experimental conditions the effectiveness of EPAC-F was evaluated by a sensitivity test to Mycosphaerella fijiensis (from a banana farm in Santa Marta), causal agent of Black Sigatoka, following the recommendations of the Fungicide Resistance Action Committee's (FRAC) to strobilurin fungicides from.

The test is based on measuring the length elongation ascospore germ tube that germinated in culture medium 2% agar, modified with a number of products made by mixing the adjuvant, EPAC-F and fungicide Liege 25 SC, whose active ingredient is Azoxystrobin 250 g/L. Then the following 11 treatments were evaluated are as follows:

T1. Azoxystrobin 25% SC 100 at a dose of 400 cc/Ha.
T2. Azoxystrobin 25 SC 50% at doses of 400 cc/Ha.+EPAC 10%
T3. Azoxystrobin 25 SC 50% at doses of 400 cc/Ha.+EPAC 20%
T4. Azoxystrobin 25 SC 70% at doses of 400 cc/Ha.+EPAC 10%
T5. Azoxystrobin 25 SC 60% at doses of 400 cc/Ha.+EPAC 10%
T1A. Azoxystrobin SC 25 50% at doses of 200 cc/Ha.+EPAC5%
T2A. Azoxystrobin SC 25 50% at doses of 200 cc/Ha.+10% EPAC
T3A. Azoxystrobin SC 25 50% at doses of 200 cc/Ha.+15% EPAC
T4A. Azoxystrobin SC 25 25% at doses of 200 cc/Ha.+10% EPAC
T5A. Azoxystrobin SC 25 25% at doses of 200 cc/Ha.+15% EPAC

### Azoxystrobin: Amystar 500 g/l

The control process involved the use of fungicide Amystar 50 WG with the active ingredient Azoxystrobin 500 g/L. This product is considered direct competition from Feudal 25 SC. The spray form of the combinations was done by airbrush.

### Results

The success of this step was to get the lowest percentage of germination of ascospores, therefore, T5A (EPAC Azoxystrobin 25%+15%) was considered the best treatment. Finally germinated ascospores elongation was evaluated. The success of this step was to get the lowest number of ascospores germinated more than 150 μm elongation, in this case the best treatments were the T4, T1A and T5A.

### Study Findings

Among the products evaluated the strongest result has the T5A with 37% of ascospores more than 150 μm, like a lower germination percentage elongation reported. This percentage of 37% exceeded by more than double that achieved by the Amystar control. This test (T5A) constitutes the best result to date, because it is a test that was run with 25% active ingredient.

The following additional examples are offered by way of illustration of the preferred embodiments and not by way of limitation, with the true scope of the invention being indicated by the claims which follow.

### Example XII

This example further describes the preparation of another facultative fermentation product.

### Preparation of Base Fermentation Product

day 1
Rice (300 grams) (The rice can be white rice, wild rice or rice in the shell)
Corn (300 grams)
Yucca (300 grams)
1.5 liters of potable water treated with a metal from the elements in the period table where Cu is a member.
Cook at 90 degrees celsius and boil for 5 minutes. Then blend with additional water to a total of 19.5 liters of water. Place in a facultative reactor for five days, so that inherent bacteria, molds and yeasts transform their starches and sugars. Let stand for 3 more days and then filter through a porous fabric and add 10 liters of boiling water and gently mix to achieve uniformity and let cool.

The above mixture can also be fermented with Baker's yeast a00 gr of saccharomices cerviciae

### Example XIII

### Preparation of Specific Facultative Fermentation Products

### Day 1

Separate fermentation products are prepared to give specific end use character to each of the EPAC products.

The following materials are use for each specific use:

### Herbicide: Fern Foliage Marranero—Pteridium Aquilinum

Fungicida/Bactericide: Horsetail Fern—Esquisetum Arvensecanela Powder. Cinnamomum Zeylanicum

### Insecticide: Garlic Cloves—Allium Sativumfrutos, Pepper Tabasco—Capsicum Frutescens

Fertilizer: Grass Seed Kikuyo. Pennisetum Clandestinum
For The Preparation Of Specific fermented products use 500 Grams of the above Plant Input (If Two Inputs then 250 Grams Each)
Cook In 1.5 Liters Of Water at 90 Degrees Celsius and then Boil For 5 Minutes.
The product is blended with water and supplemented with additional water to a volume of 19.5 litres. Optionally leave in a facultative reactor for five days, so that bacteria, molds and yeasts transform their starches and sugars. process presents strictly no alcoholic fermentation.

### Day 8

The fermented blend is filtered through fabric. and then add 10 litres of boiling water and gently mixing to achieve uniformity and let cool. At the end of the process blend Example XII product with the different products of Example XIII

The EPAC product is recirculated through tubing exposed to a magnetic field generated byneodymium magnets and while recirculated ionized air is also injected and also recirculated while exposed to blue and green light for 8 hours.

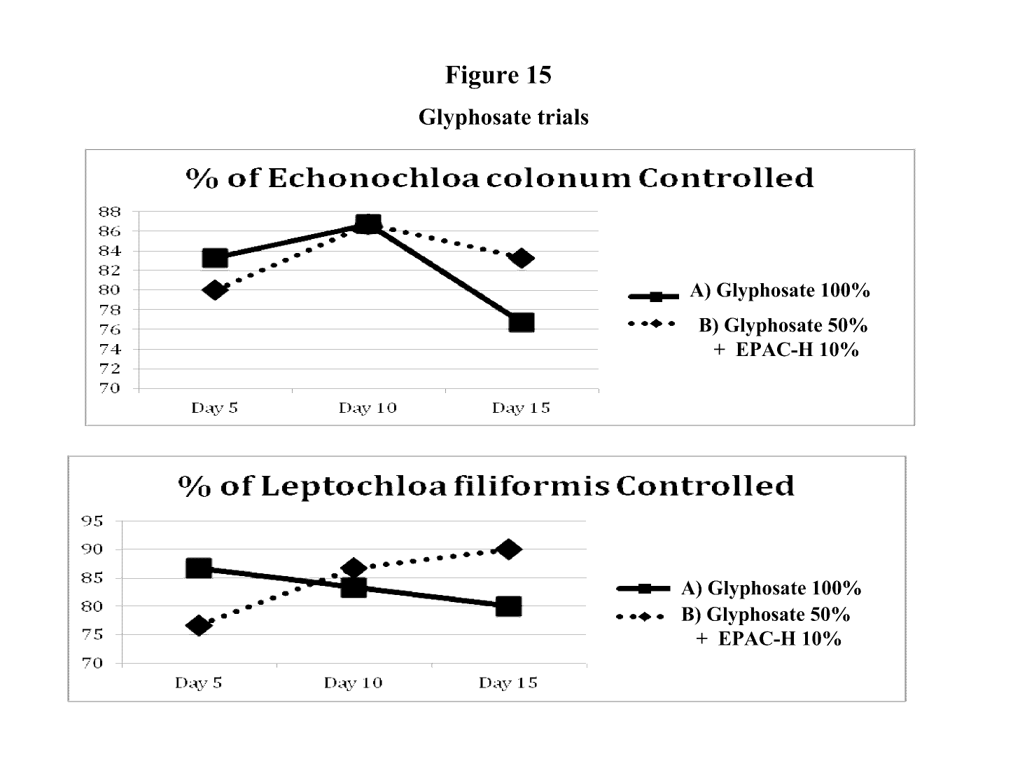

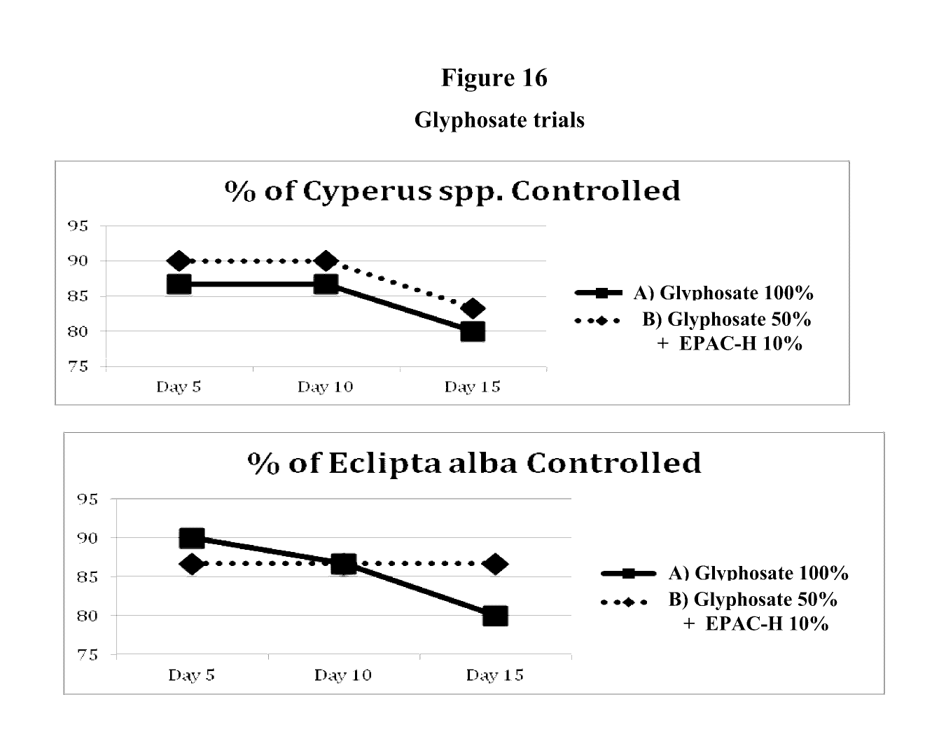

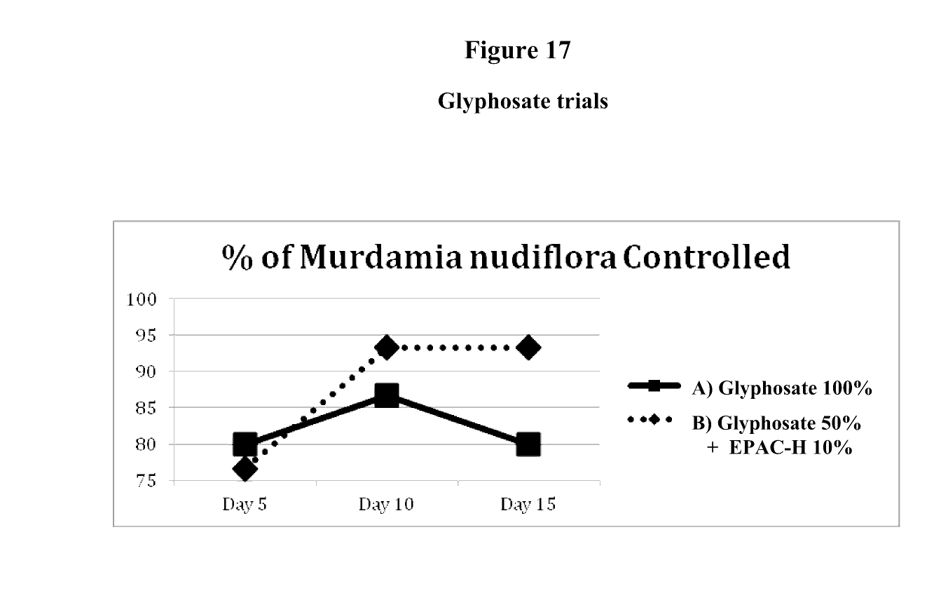

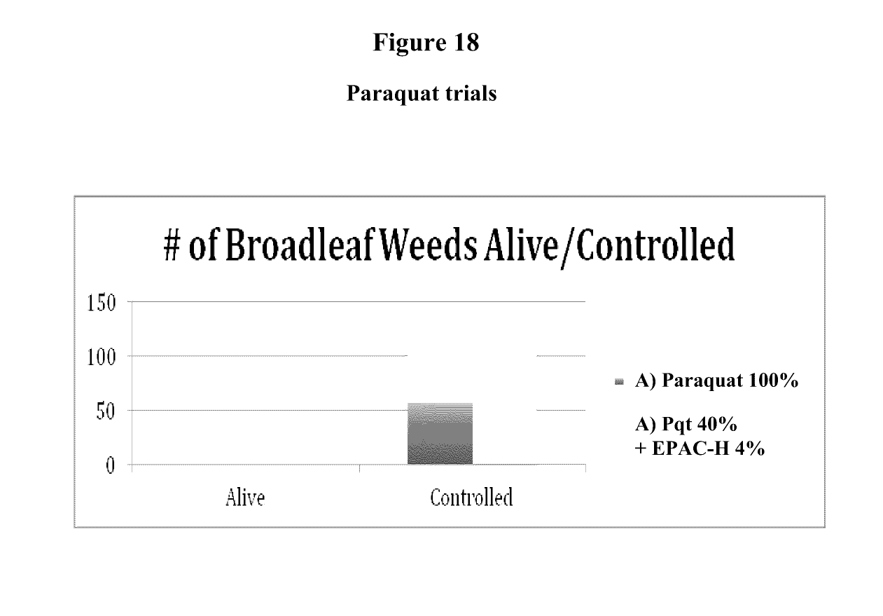

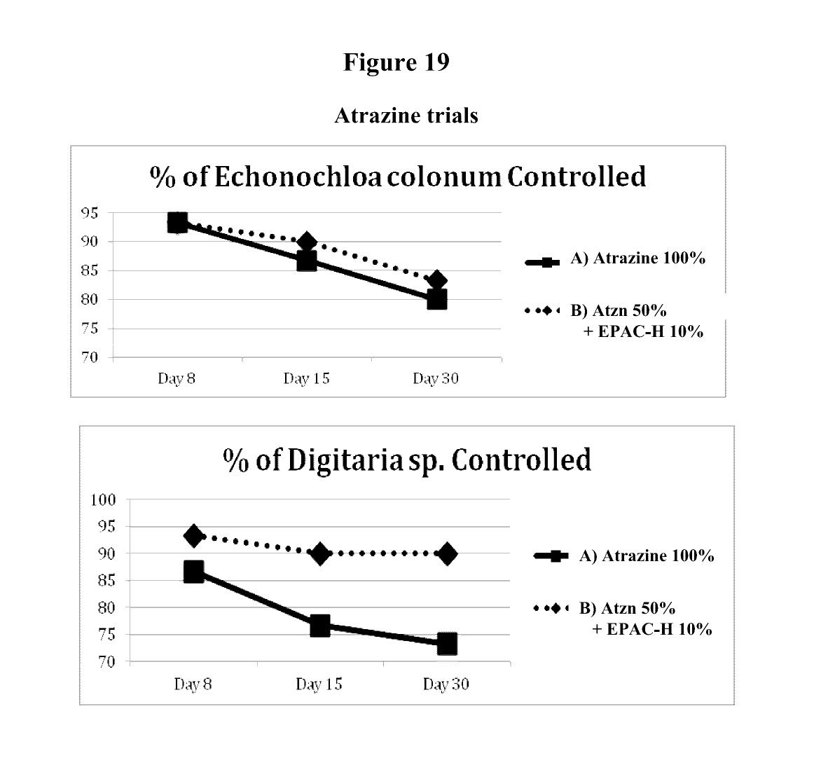

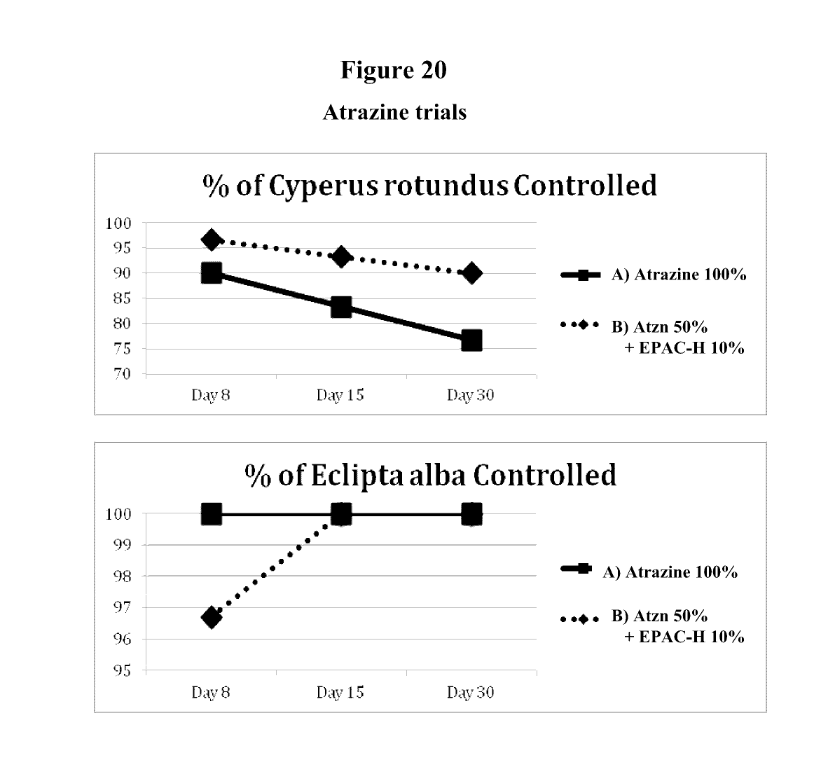

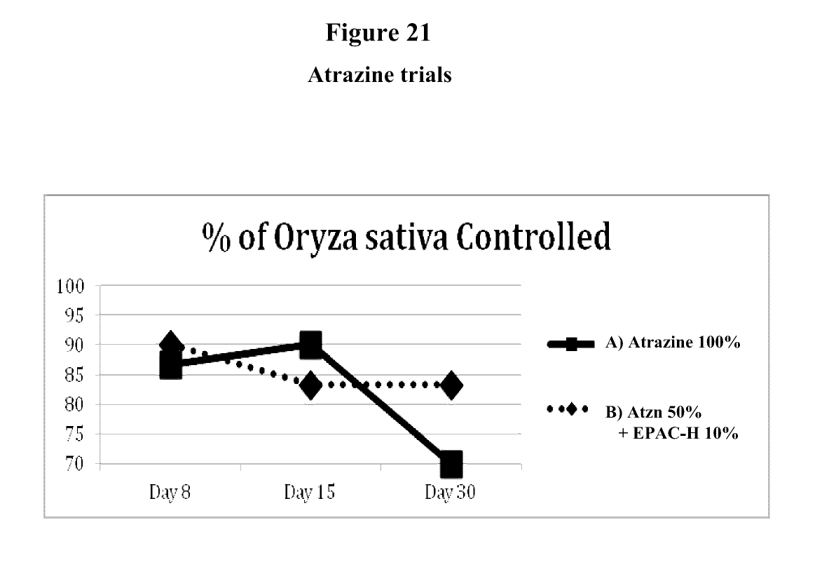

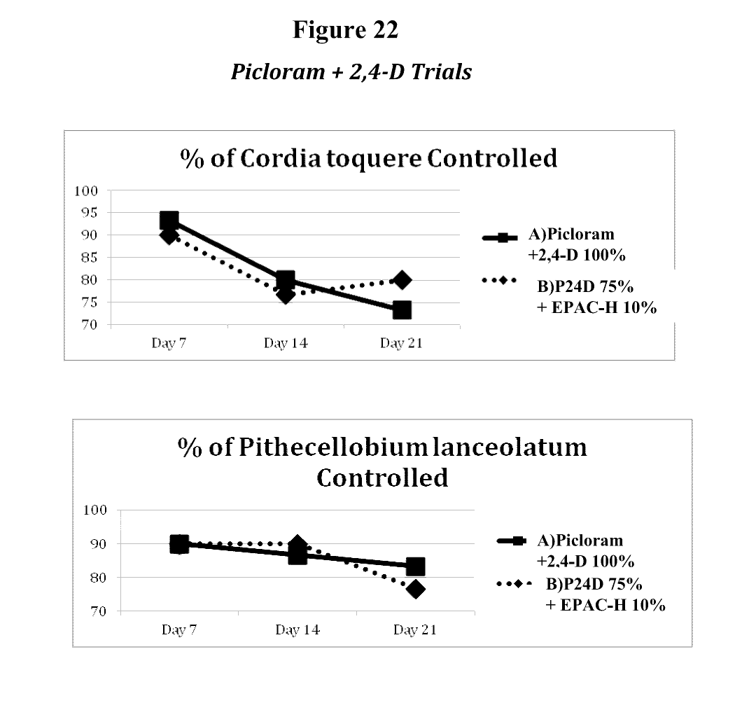

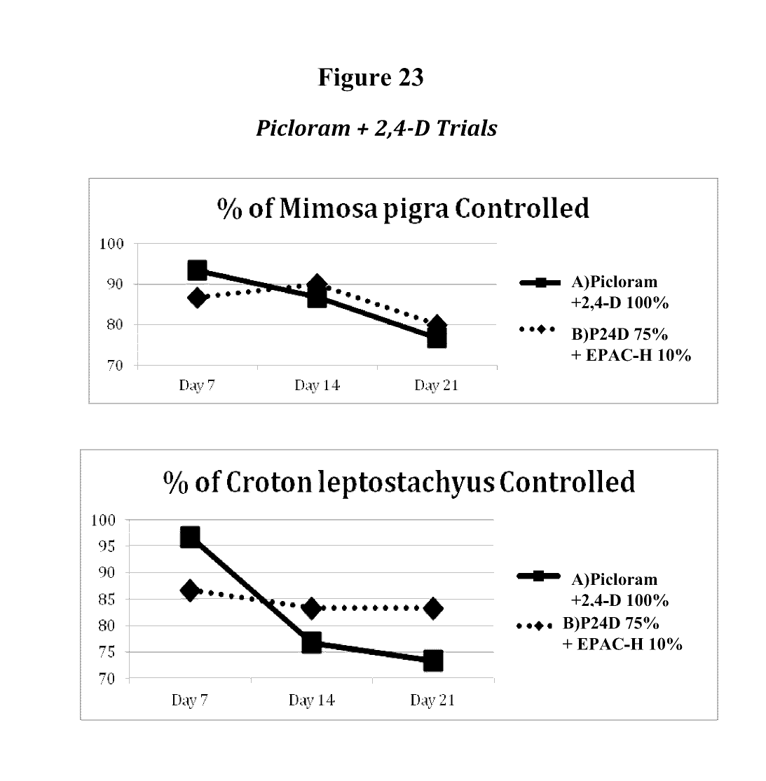

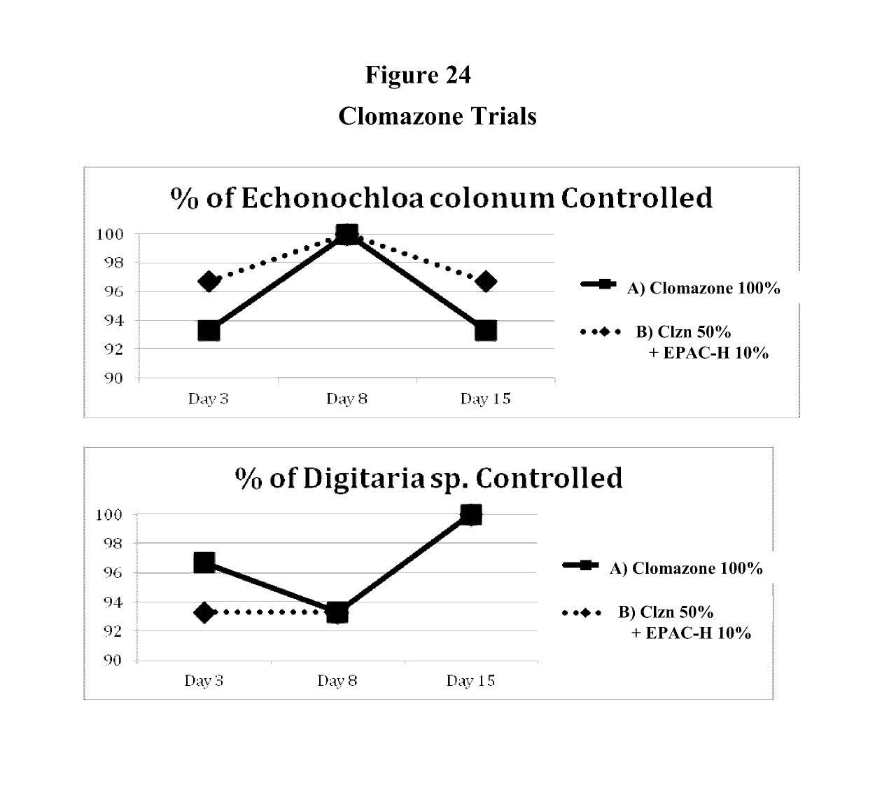

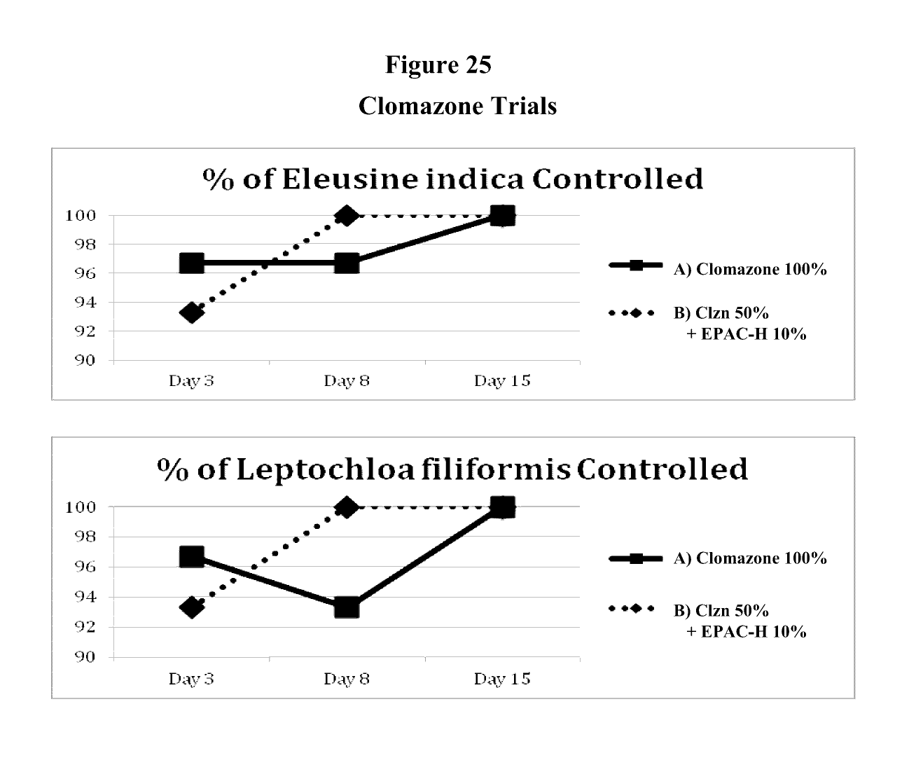

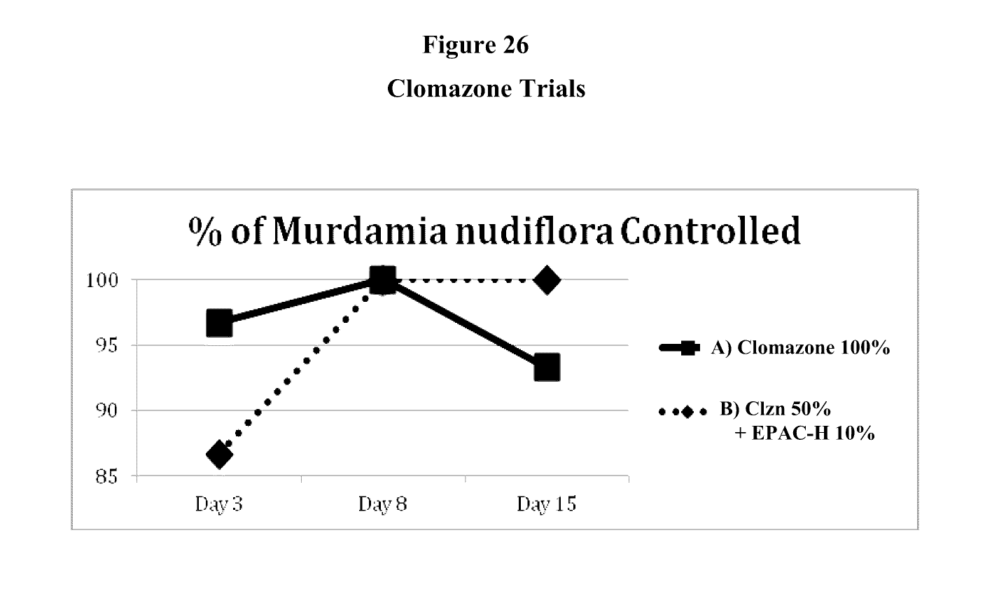

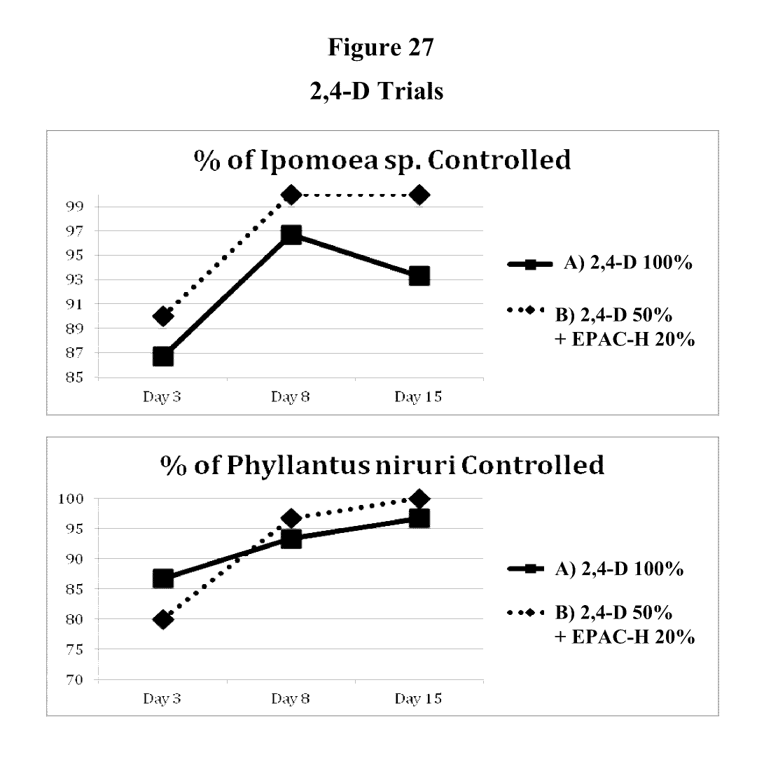

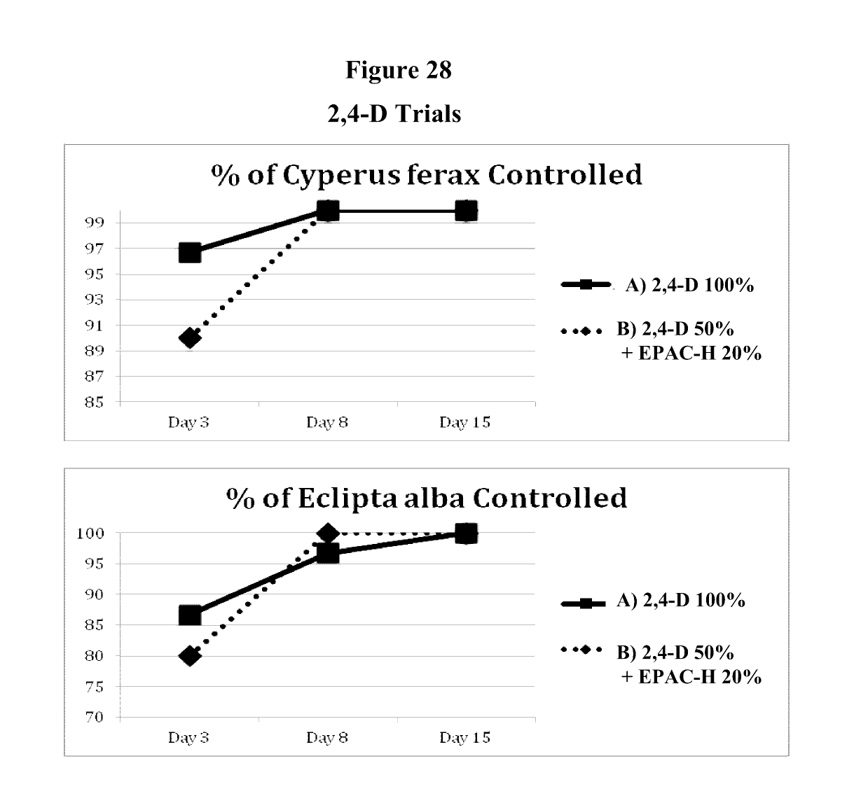

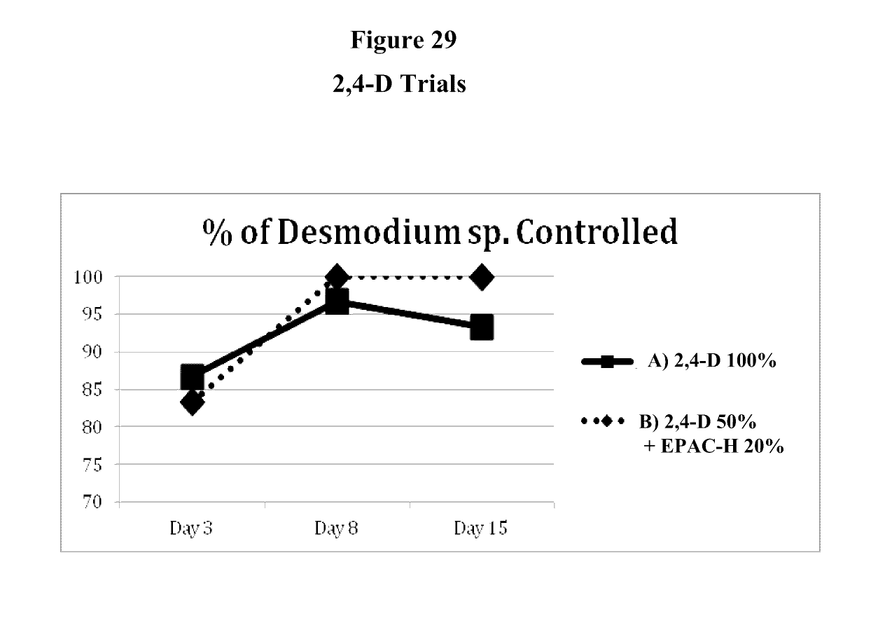

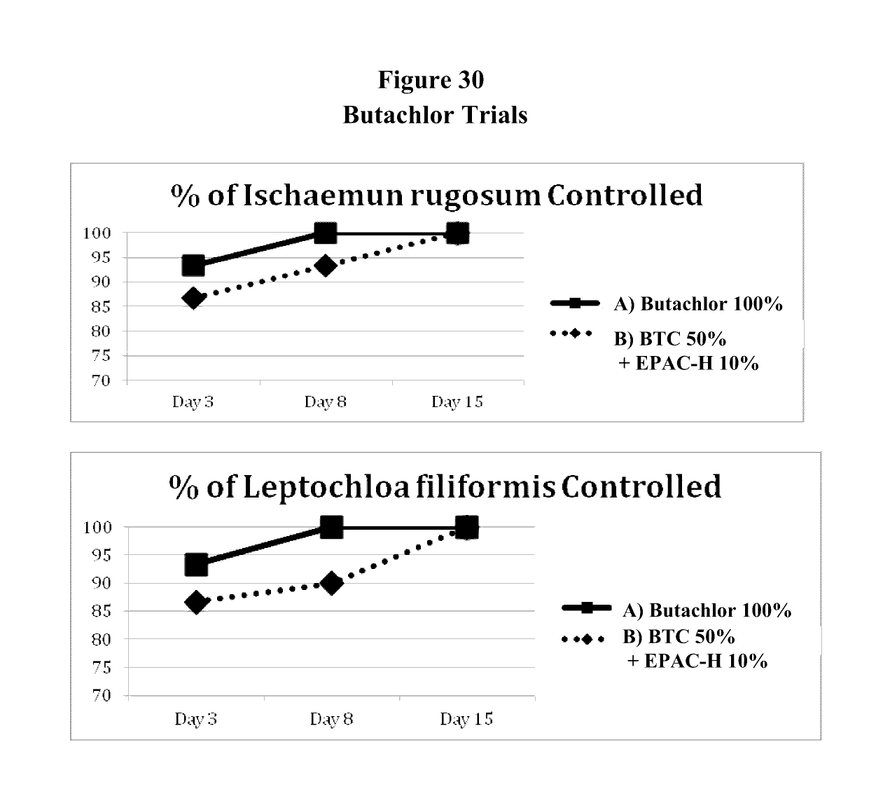

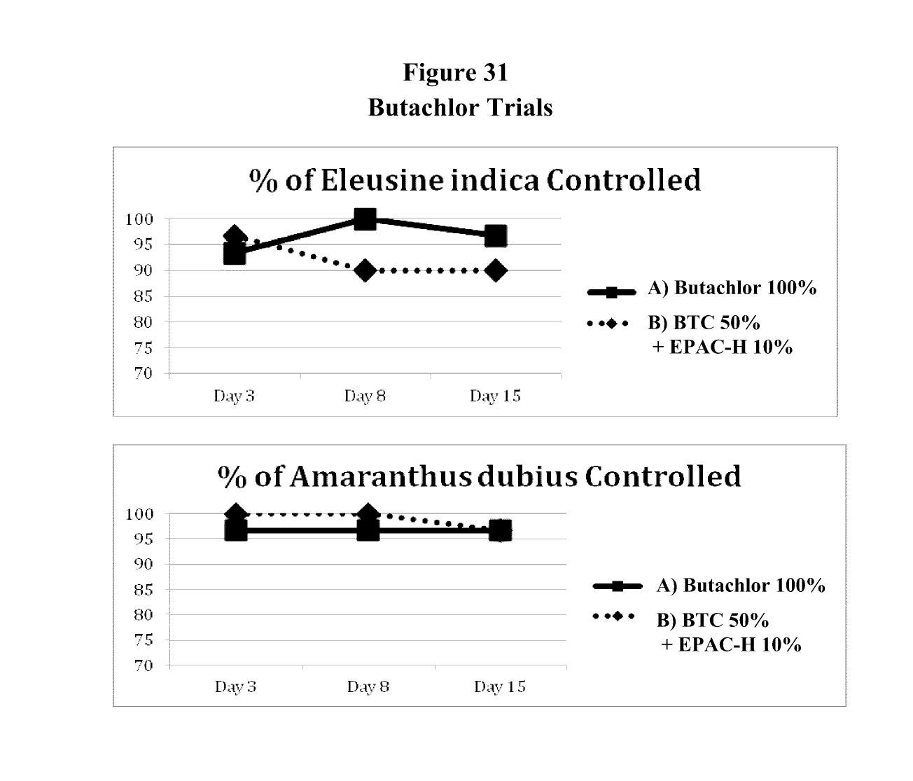

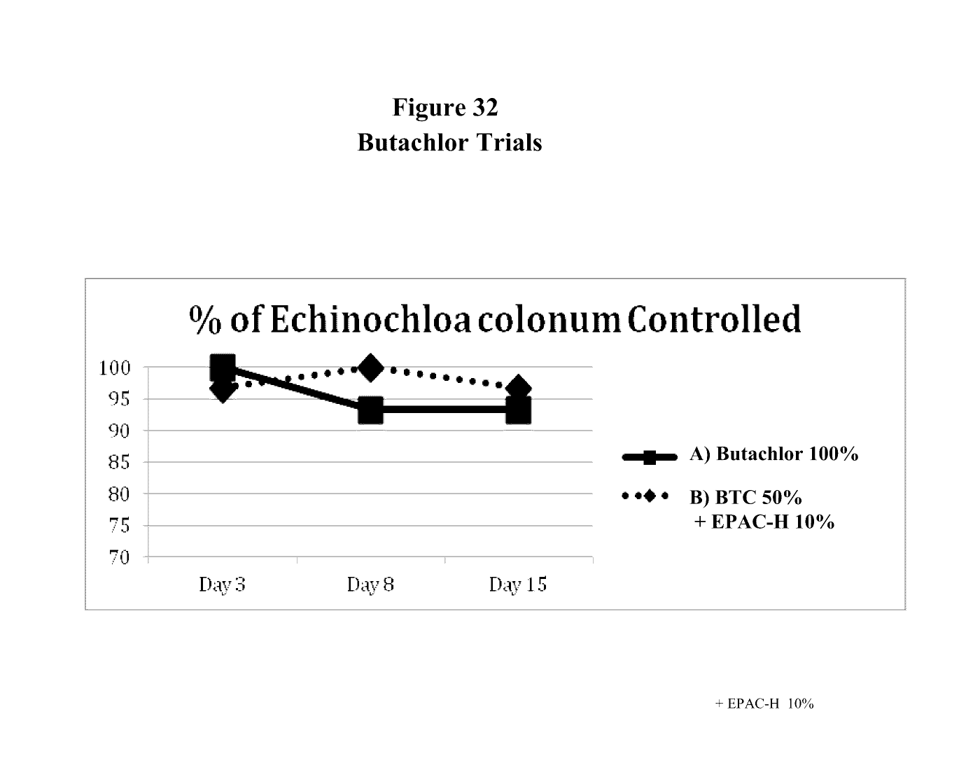

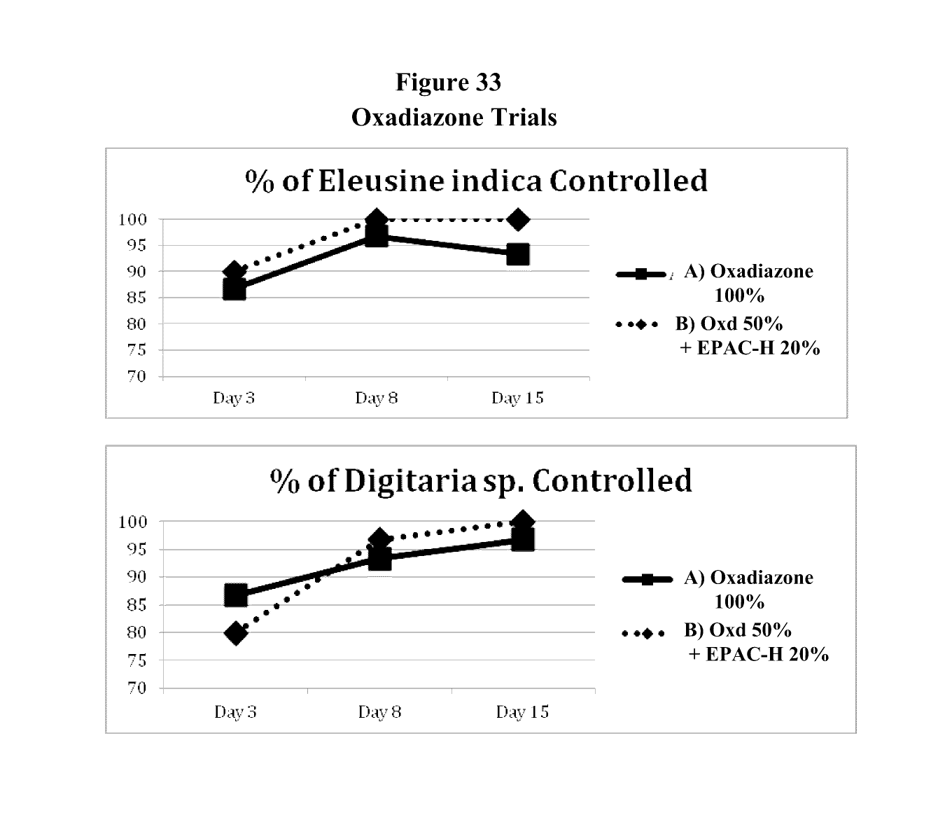

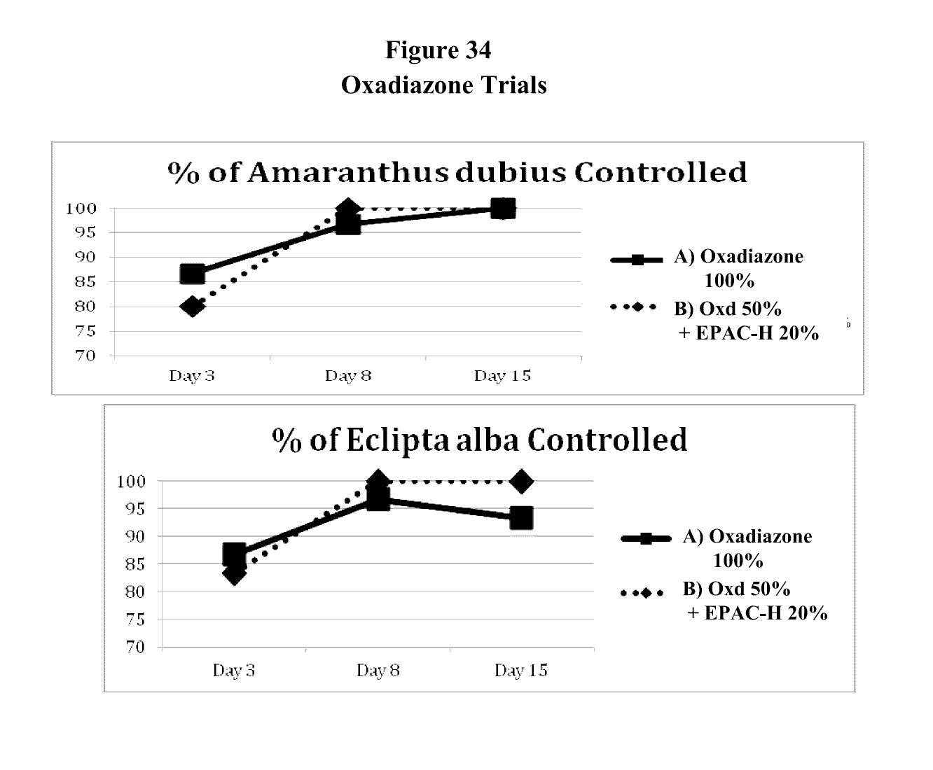

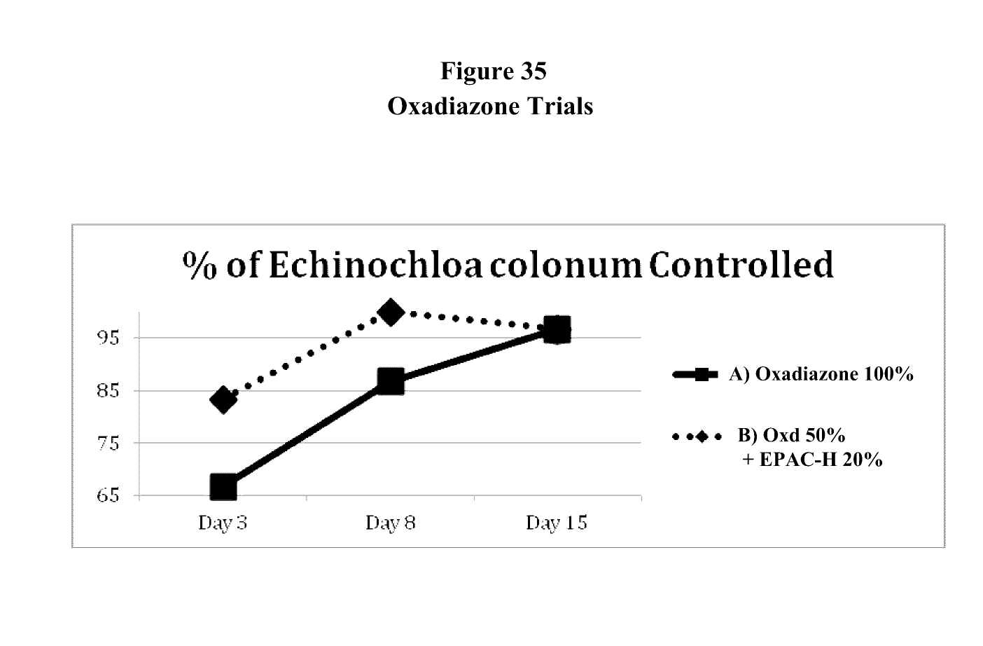

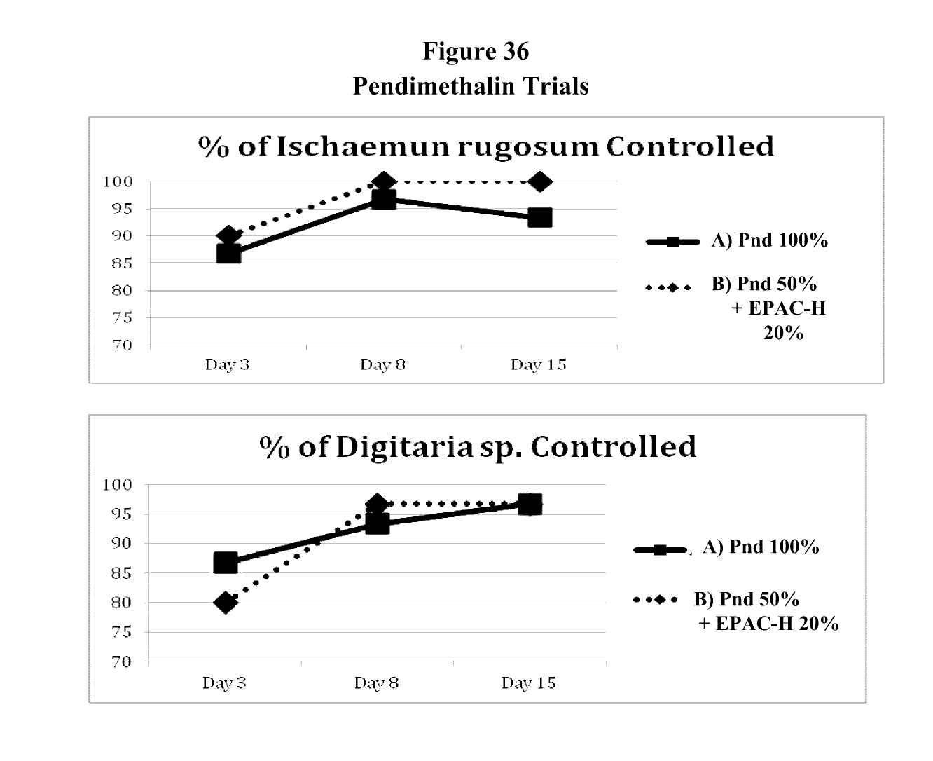

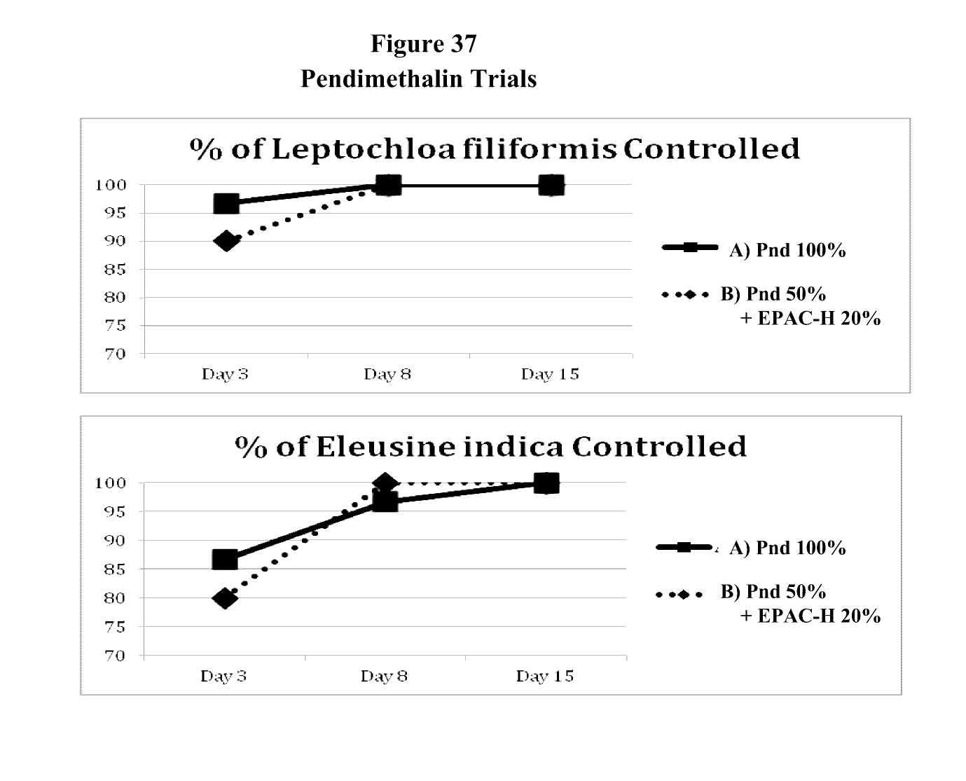

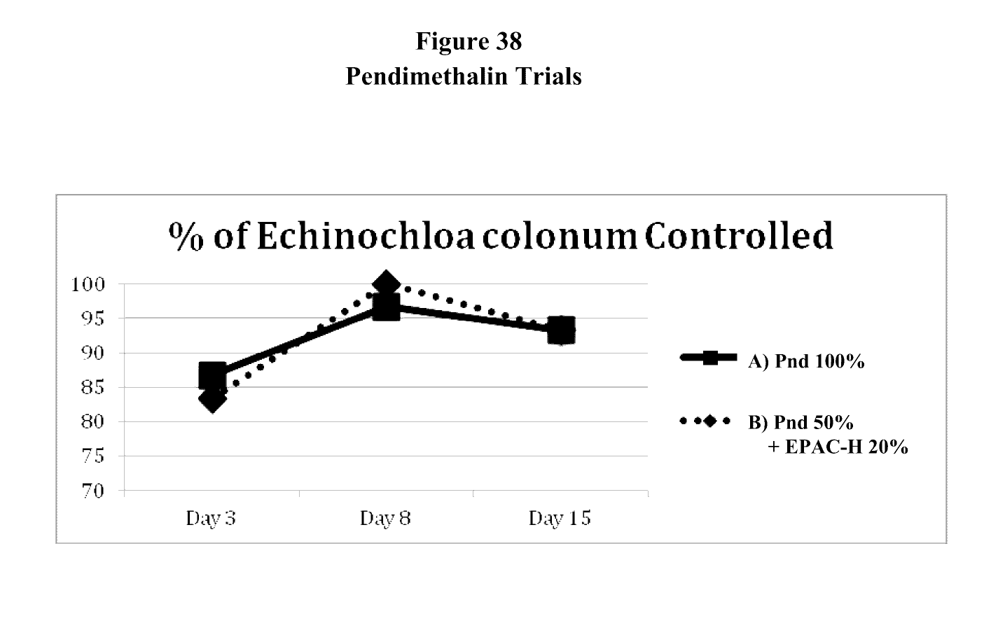

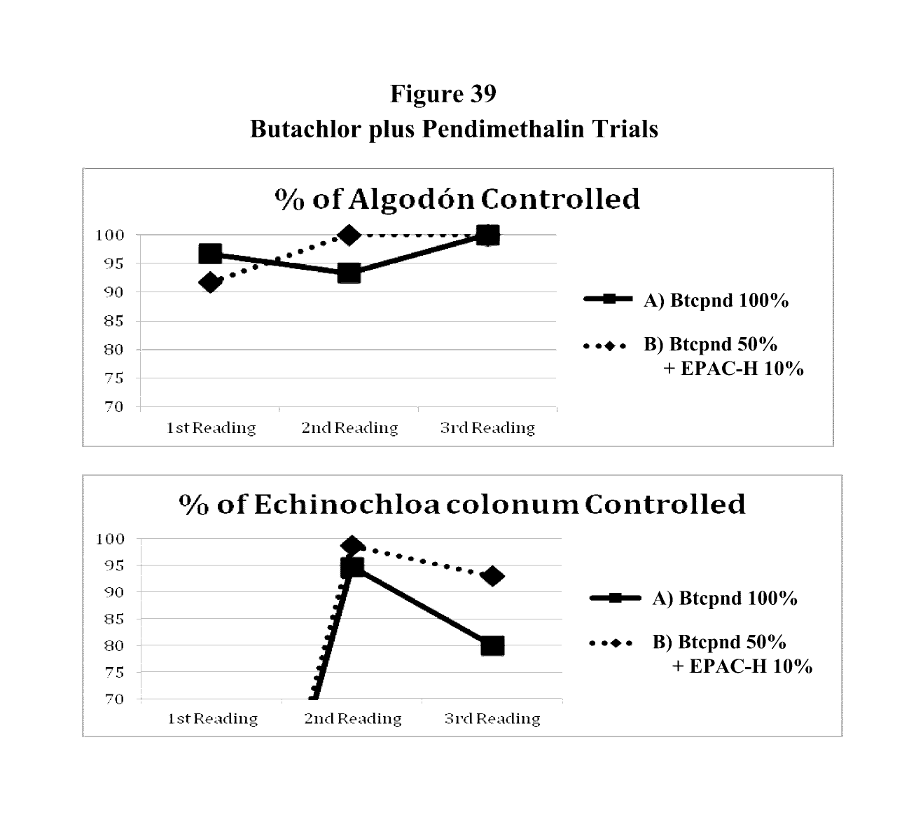

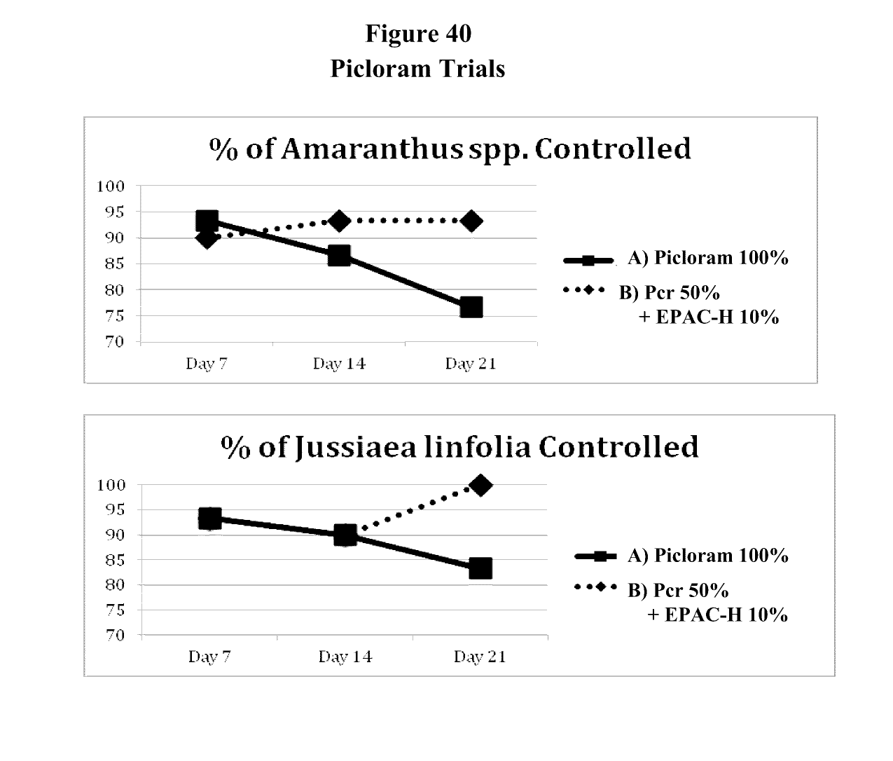

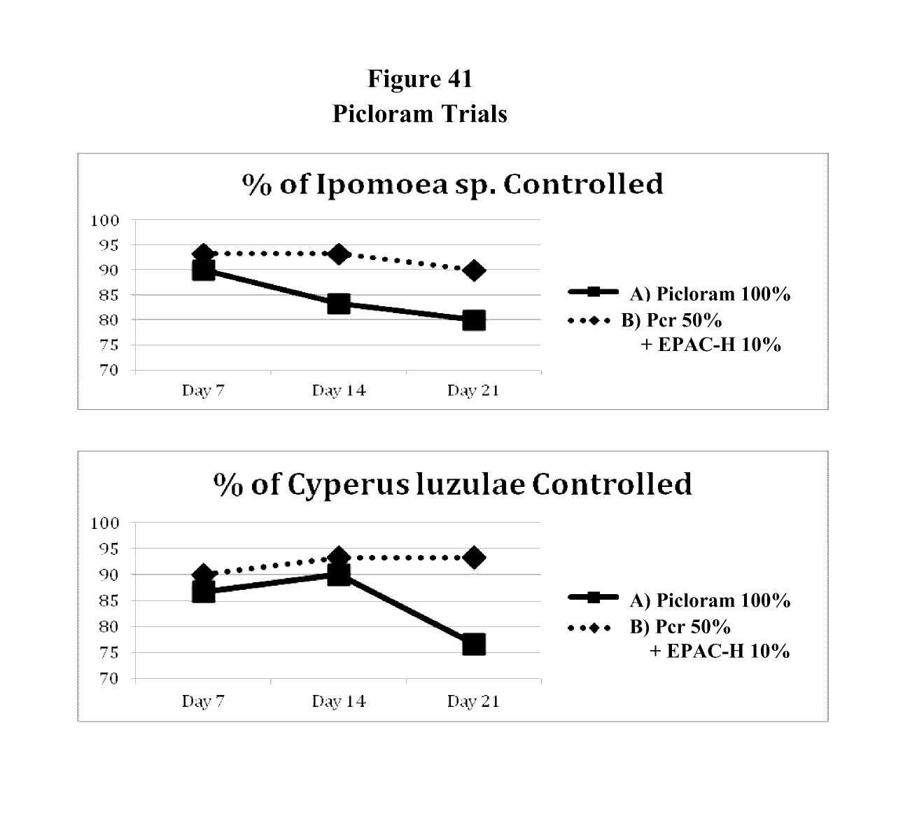

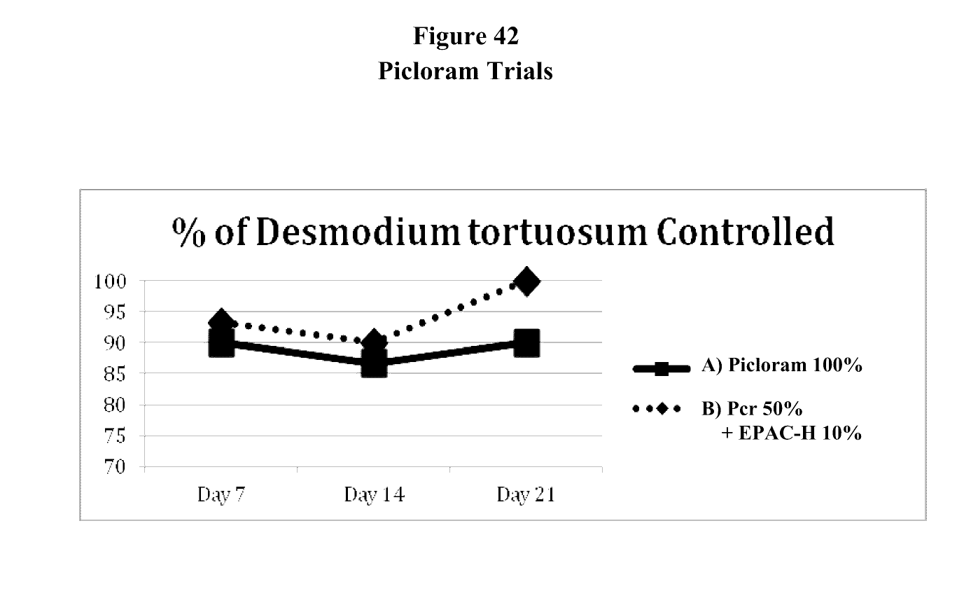

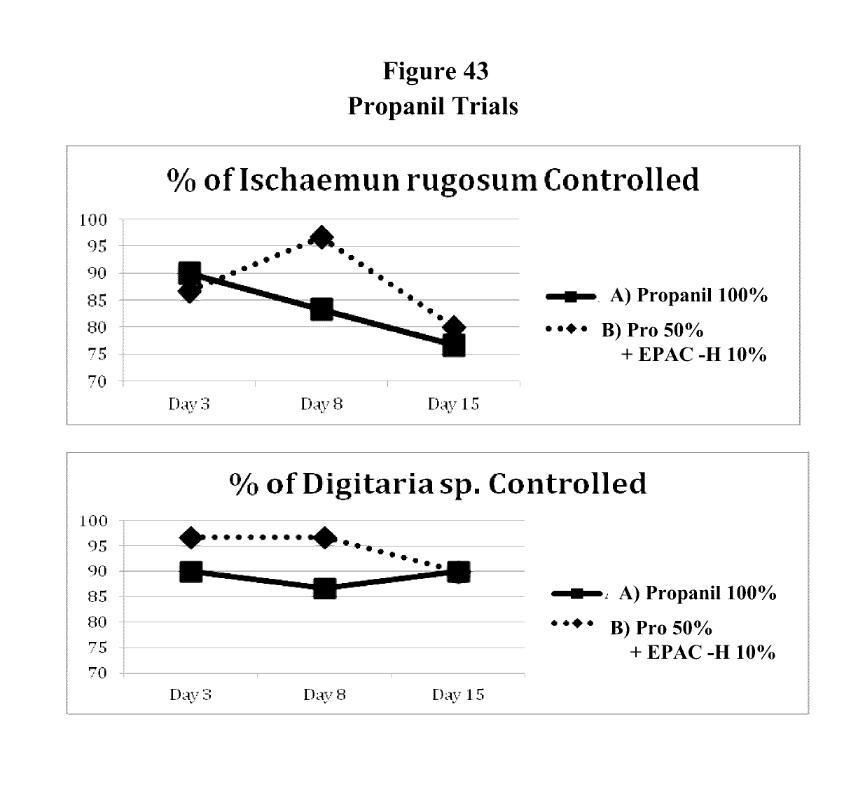

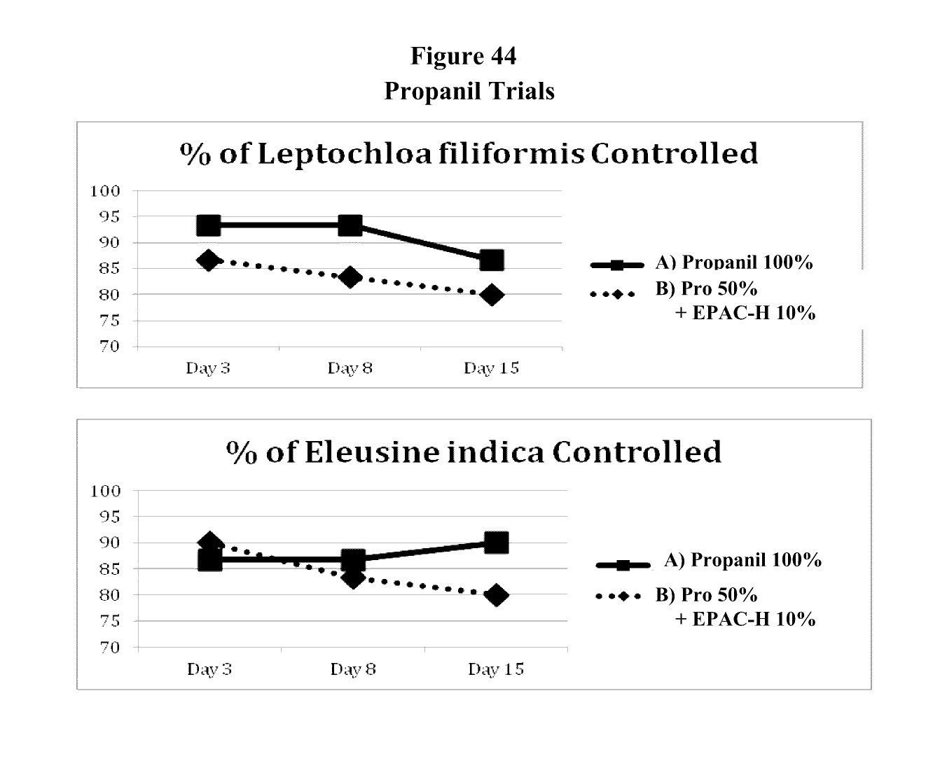

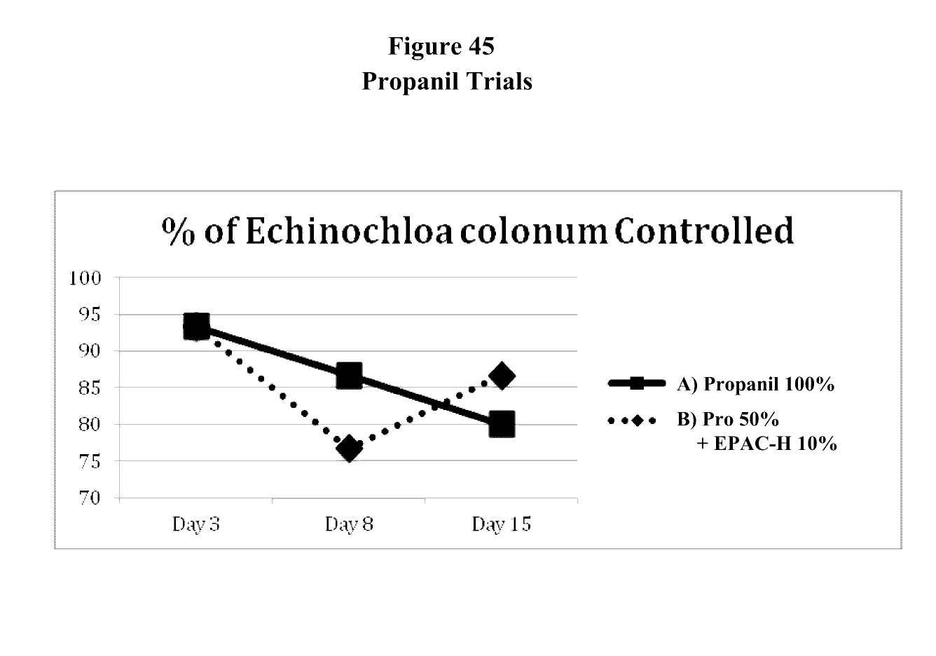

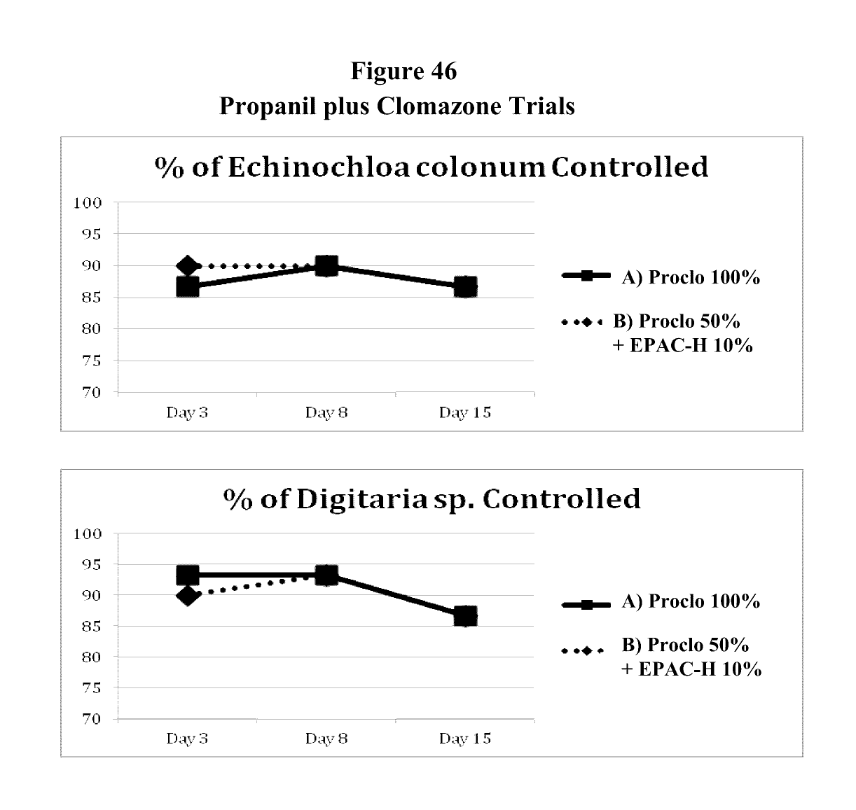

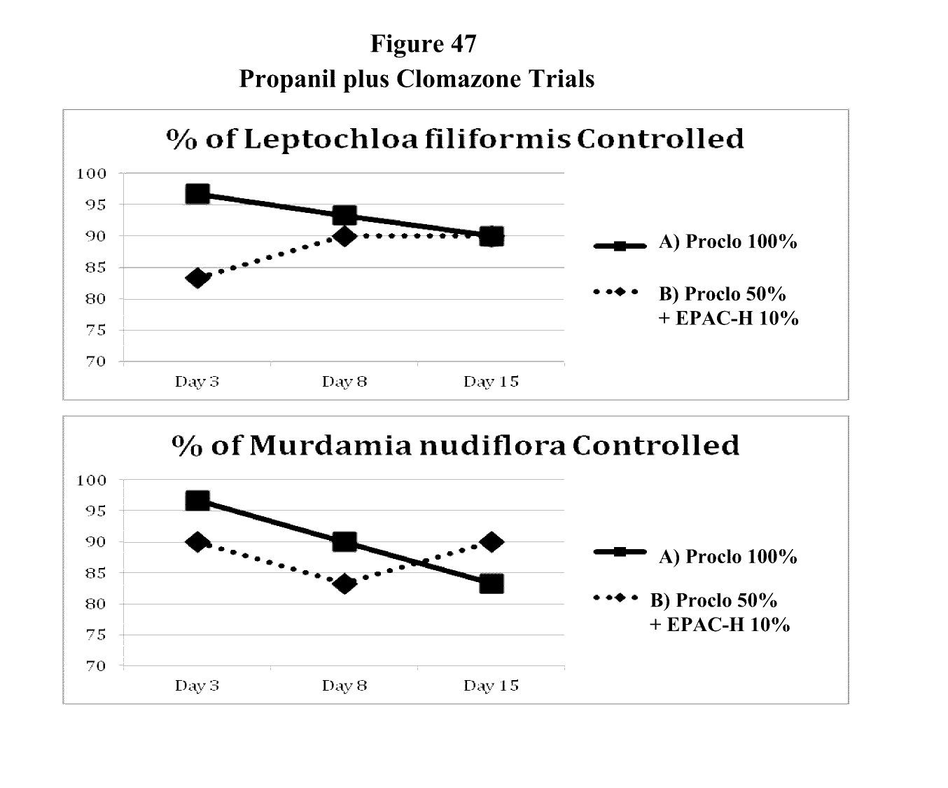

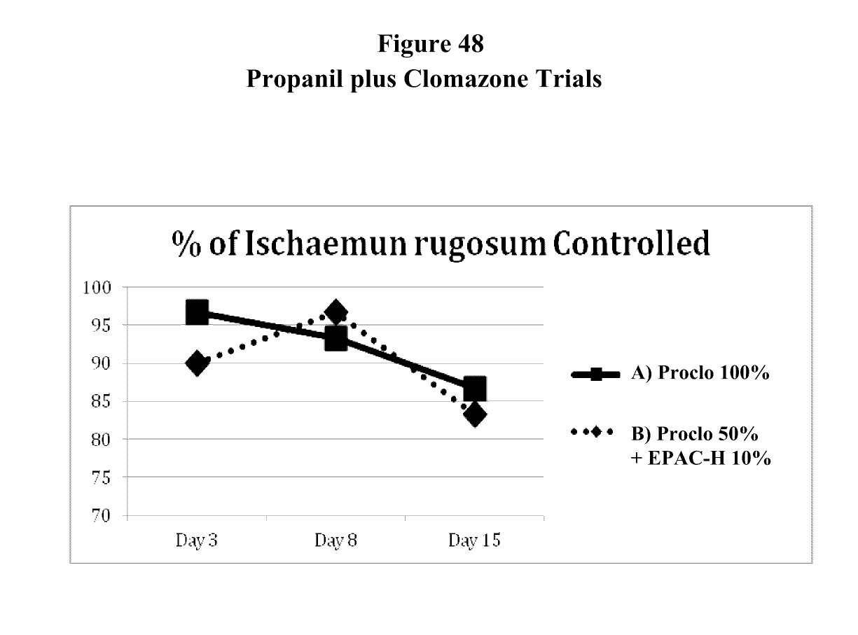

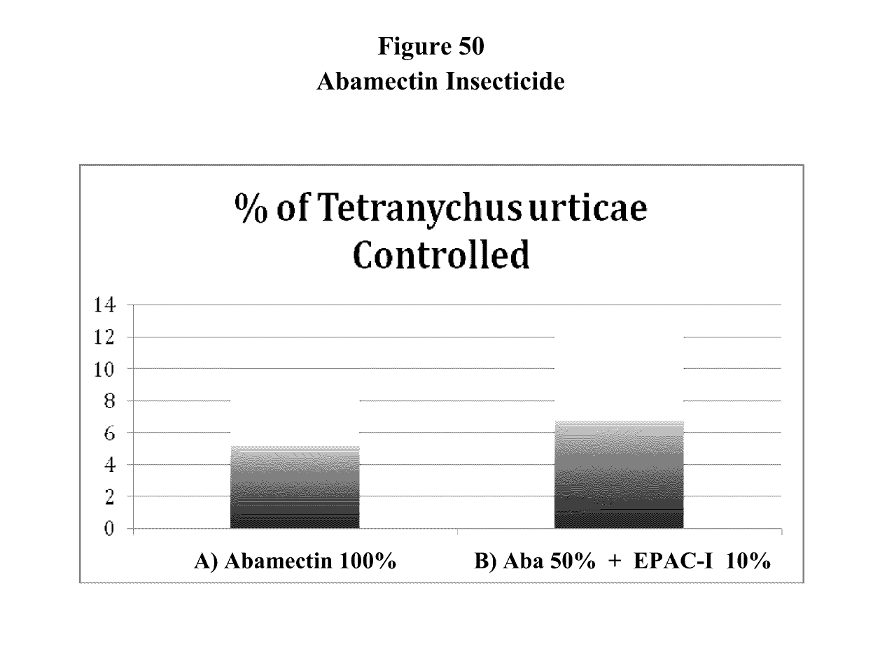

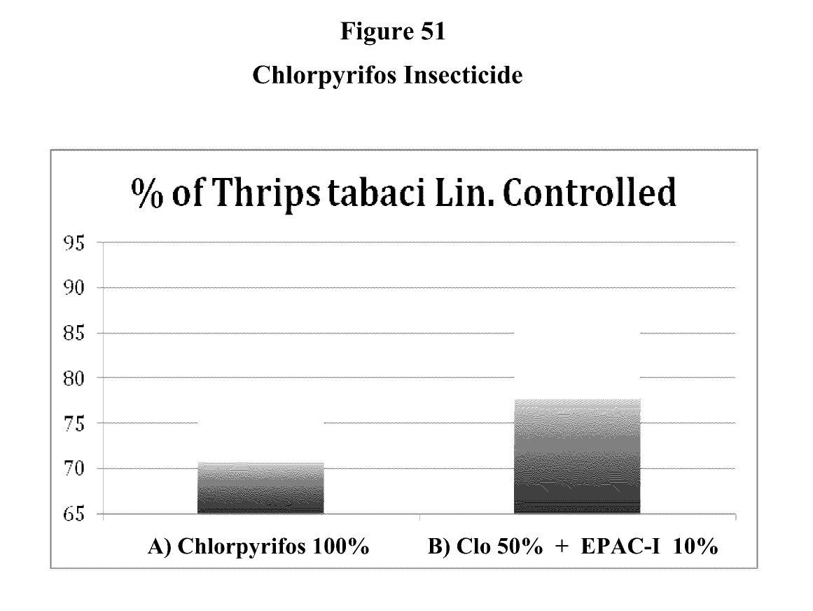

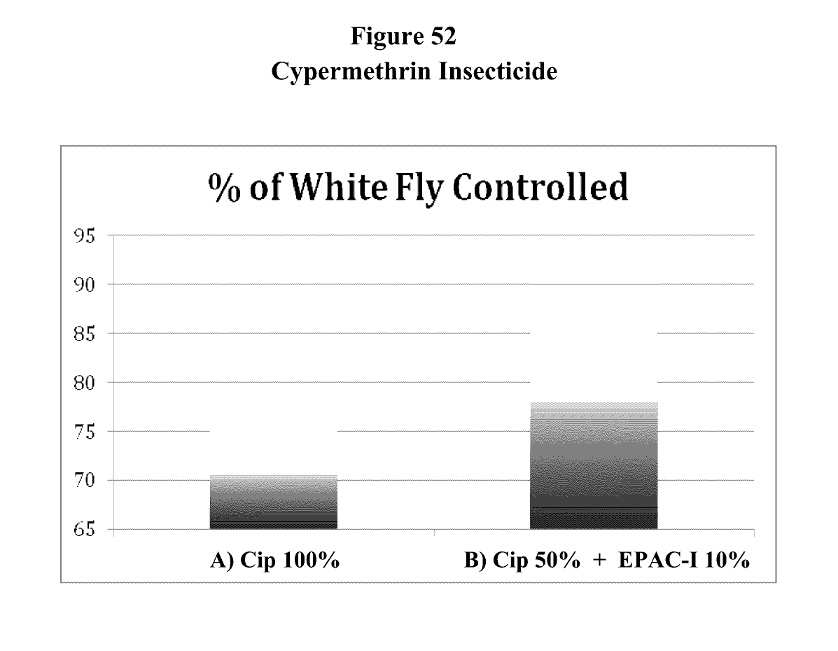

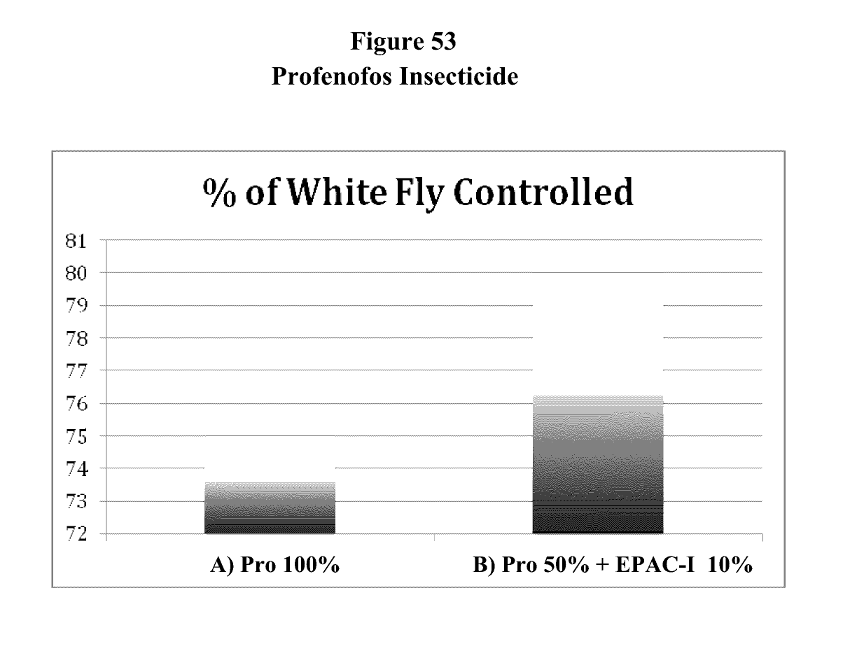

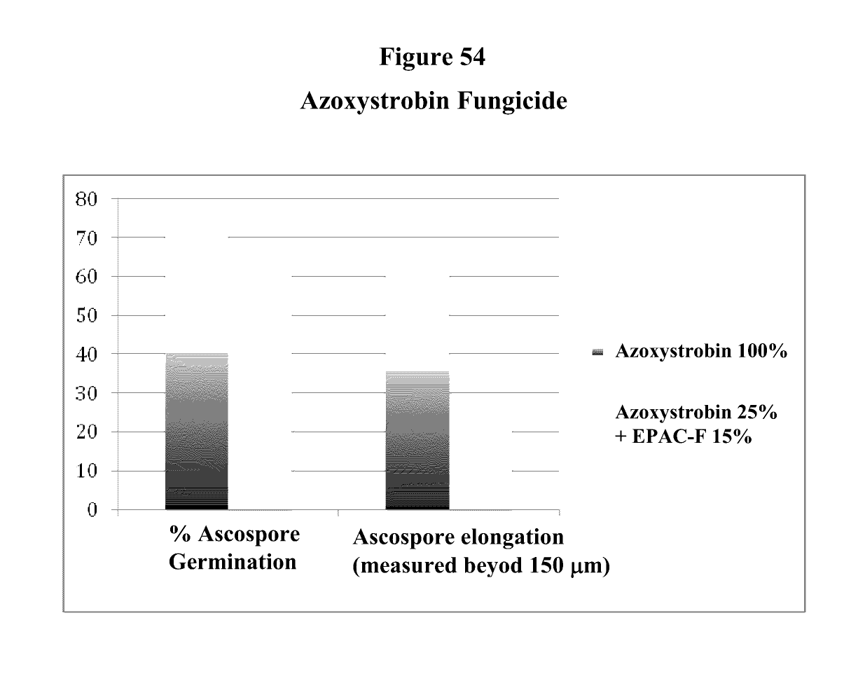

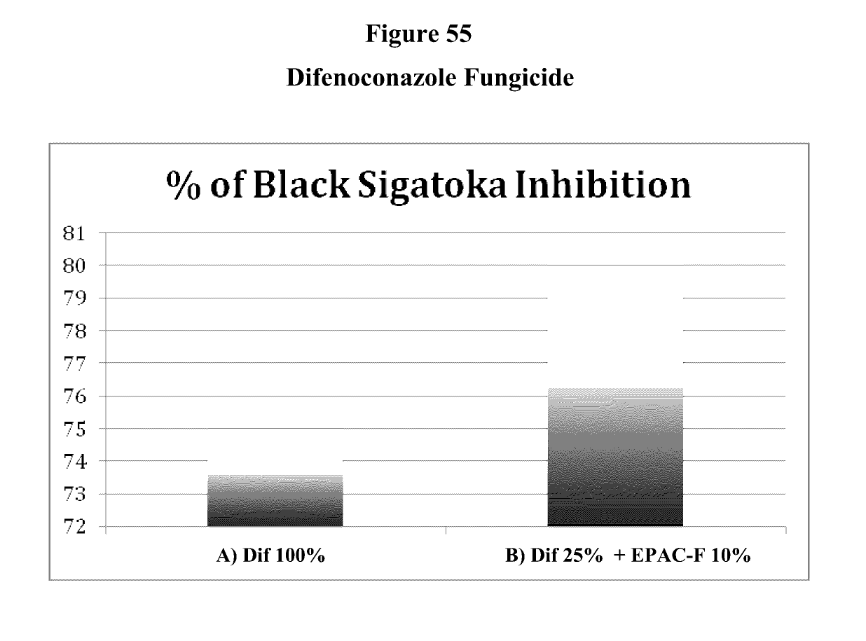

Numerous field trials were done with the enhancers and the following agricultural chemicals: Glyphosate, Paraquat, Atrazine, Picloram, 2,4-D, Picloram+2,4-D, Clomazone, Oxadiazone, Pendimenthaline, Methamidophos, Chlorpyrifos, Cypermethrin, Profenophos, Axozystrobin, Difenoconazole, Abamectin, Propanil, Propanil plus Clomazone, Butachlor, and Butachlor plus Pendimethalin. The results of all the trials are summarized in Table 9 and in FIGS. 15-55.

TABLE 9

| | | Date | | | | | | |
|---|---|---|---|---|---|---|---|---|
| Product | Crop | Started | Date Ended | Purpose | Weeds | Results Obtained | | |
| | | | | | | A) Glyphostate | B) Gly 50% + | |
| | | | | | % of Weeds Controlled | 100% | EPAC 10% | B − A |
| Glyphosate | Rice | Jun. 27, | Jul. 12, 2104 | Weed Control | Piñita | 83 | 95 | 12 |
| | | 2014 | | | (Murdania Nudiflora) | | | |
| | | | | | Leptocloa | 100 | 100 | 0 |
| | | | | | Guardarocio | 82 | 100 | 18 |
| | | | | | (Digitaria Sanguinalis) | | | |
| | | | | | Cortadera | 90 | 100 | 10 |
| | | | | | (Cortaderia Selloana) | | | |
| | | | | | Liendrepuerco | 93 | 93 | 0 |
| | | | | | (Echinochia Colonum) | | | |
| | | | | | | A) Paraquat | B) Paraq. 40% + | |
| | | | | | Crop Dissecation | 100% | EPAC 4% | B − A |
| Paraquat | Corn | 2/3/205 | Feb. 7, 2015 | Crop Dissecation | % of Crop Dissecated | 100 | 100 | 0 |
| | | | | | | | B) Atraz. 50% + | |
| | | | | | | A) Atrazine | EPAC | |
| | | | | | % of Weeds Controlled | 100% | 10%% | B − A |
| Atrazine | Corn | Feb. 20, | Mar. 13, 2015 | Weed Control - | 7 Days | 93% | 90% | −3% |
| | | 2015 | | Coquito (Cyperus | 14 Days | 90% | 90% | 0% |
| | | | | rotundus) | 21 Days | 90% | 93% | 3% |
| | | | | | | A) Picloram + | | |
| | | | | | | 2,4- | B) Piclor. 50% + | |
| | | | | | % of Weeds Controlled | D 100% | EPAC 10% | B − A |
| Picloram + | Pasture | Feb. 26, | Mar. 19, 2015 | Weed Control - | 7 Days | 87% | 93% | 6.6% |
| 2,4-D | Fields | 2015 | | Dormidera | 14 Days | 87% | 93% | 6.6% |
| | | | | (Mimosa Pudica) | 21 Days | 83% | 87% | 3.4% |
| | | | | | | | B) Clomaz. | |
| | | | | | | A) Clomazone | 50% + EPAC | |
| | | | | | % of Weeds Controlled | 100% | 10% | B − A |
| Clomazone | Rice | 20-Nov | Dec. 5, 2014 | Weed Control - | 3 Days | 97% | 93% | −3.7% |
| | Fields | | | Paja de Zorro | 8 Days | 93% | 100% | 6.7% |
| | | | | (Leptochloa | 15 Days | 100% | 100% | 0.0% |
| | | | | filiformis) | | | | |
| | | | | | | | B) Butach. | |
| | | | | | | | 50% + EPAC | |
| | | | | | | | 10% | B − A |
| | | | | | 3 Days | 93% | 87% | −6.3% |
| | | | | | 8 Days | 100% | 90% | −10.0% |
| | | | | | 15 Days | 100% | 100% | 0.0% |
| | | | | | | A) Oxadiazone | B) Oxad. 50% + | |
| | | | | | % of Weeds Controlled | 100% | EPAC 10% | B − A |
| Oxadiazone | Rice | Oct. 29, | Dec. 3, 2014 | Weed Control - | 3 Days | 87% | 90% | 3.3% |
| | Fields | 2014 | | Bledo | 8 Days | 97% | 100% | 3.3% |
| | | | | (Amaranthus | 15 Days | 100% | 100% | 0.0% |
| | | | | Albus) | | | | |
| | | | | | | A) | B) Pendam. | |
| | | | | | | Pendimethaline | 50% + EPAC | |
| | | | | | % of Weeds Controlled | 100% | 10% | B − A |
| Pendimenthaline | Rice | Nov. 15, | Dec. 1, 2014 | Weed Control - | 3 Days | 86.7 | 83.3 | −3.4 |
| | Fields | 2014 | | Falsa Caminadora | 8 Days | 96.7 | 96.7 | 0 |
| | | | | (Ischaemum | 15 Days | 93 | 100 | 7 |
| | | | | rugosum) | | | | |
| | | | | | | A) | B) Metam. | |
| | | | | | | Metamidophos | 50% + EPAC | |
| | | | | | % of Pest Controlled | 100% | 10% | B − A |
| Metamidhophos | Tomato | May 26, | Jun. 5, 2014 | Pest Control - | 1 Day | 10% | 28% | 18.0% |
| | Crops | 2014 | | White Fly | 4 Days | 30% | 47% | 17.0% |
| | | | | (Aleyrodidae) | 6 Days | 42% | 71% | 29.0% |
| | | | | | 8 Days | 46% | 78% | 32.0% |
| | | | | | 10 Days | 50% | 83% | 33.0% |
| | | | | | | A) | B) Chlorp. | |
| | | | | | | Chlorpyrifos | 50% + EPAC | |
| | | | | | % of Pest Controlled | 100% | 10% | B − A |
| Chlorpyrifos | Coffe | Feb. 23, | Mar. 16, 2015 | Pest Control - | 7 Days | 88% | 88% | 0.0% |
| | Fields | 2015 | | Coffe Borer | 14 Days | 83% | 85% | 1.7% |
| | | | | Beetle | 21 Days | 73% | 80% | 6.7% |
| | | | | | | A) | B) Cyperm. | |
| | | | | | | Cypermethrin | 50% + EPAC | |
| | | | | | % of Pest Controlled | 100% | 10% | B − A |
| Cypermethrin | Tomato | Nov. 26, | Dec. 11, 2014 | Pest Control - | 3 Days | 90% | 94% | 4% |
| | Crops | 2014 | | White Fly | 8 Days | 87% | 96% | 9% |
| | | | | (Aleyrodidae) | 15 Days | 76% | 92% | 16% |
| | | | | | | A) | B) Profen. | |
| | | | | | | Profenophos | 50% + EPAC | |
| | | | | | % of Pest Controlled | 100% | 20% | B − A |
| Profenophos | Tomato | Feb. 26, | Mar. 19, 2015 | Pest Control - | 7 Days | 92% | 90% | −2% |
| | Crops | 2015 | | White Fly | 12 Days | 82% | 83% | 2% |
| | | | | (Aleyrodidae) | 15 Days | 75% | 80% | 5% |
| | | | | | | A) | B) Azoxyst. | |
| | | | | | Fungus | Axozystrobin | 25% + EPAC | |
| | | | | | Inhibition | 100% | 15% | B − A |
| Axozystrobin | Banana | Nov. 24, | Dec. 5, 2014 | Fungus Control - | % Ascospore | 24% | 37% | 13% |
| | Crops | 2012 | | Black Sigatoka | Germination Inhibited | | | |
| | | | | (Mycosphaerella | % Ascospore elongation | 37% | 70% | 33% |
| | | | | fijiensis) | Inhibition (>150 microm) | | | |

The content of all references cited in the instant specification and all cited references in each of those references are incorporated in their entirety by reference herein as if those references were denoted in the text

While the many embodiments of the invention have been disclosed (Angres) above and include presently preferred embodiments, many other embodiments and variations are possible within the scope of the present disclosure and in the appended claims that follow. Accordingly, the details of the preferred embodiments and examples provided are not to be construed as limiting. It is to be understood that the terms used herein are merely descriptive rather than limiting and that various changes, numerous equivalents may be made without departing from the spirit or scope of the claimed invention.

What is claimed is:

1. An agricultural chemical enhancer composition comprising a mixture of:
(a) a fermentation product of one or more of red beans, peas, yellow corn, white corn, white rice, yucca, potatoes, manioc root, starch from vegetables sources, inorganic minerals, non-iodized sea salt, urea or another equivalent nitrogen source, biodynamic water and an inoculum selected from the group consisting of bacillus microorgasnisms or spores and yeast; and
(b) an essential oil selected from the group consisting of banana oil, cinnamon oil, coconut oil, vanilla oil and mixtures thereof; and urea or another equivalent nitrogen source.

2. The agricultural chemical enhancer of claim 1, further including an extract of a plant material selected from the group consisting of marranero fern foliage (Pteridium aquilinum), cola de caballo (horsetail fern) leaves (esquisetum arvense), powdered cinnamon (cinnamomum zeylanicum), garlic cloves (allium sativum), tabasco pepper fruits (capsicum frutescens), pasto kikuyo seeds (pennisetum clandestinum) and mixtures thereof.

3. A herbicide composition comprising:
(a) 1-99% by weight the enhancer of claim 2; and
(b) 1-99% by weight of a herbicide selected from one or more of: Alachlor, Atrazine, Bentazon, Bialaphos, Butachlor, Butylate, Chlorimuron ethyl, Chlorsul furon, Cinmethylin, Clomazone, Cyanazine, Cycloate, Dicamba 2,4-D (2,4-dichlorophenoxyacetic acid), EPTC, Ethephon, Fenoxaprop, Fluazifop-butyl, Fomesafen, Glufosinate, Glyphosate, Haloxyfop, Hoelon, Imazapyr Imazaquin, Imazethapyr, Linuron, Mefluidide, Metolachlor, Metribuzin, Metsulfuron, Molinate, Norflurazon, Oryzalin, Oxyfluorfen, Paraquat, Pendimethalin, Picloram, Propachlor, Propanil, Pyridate, Sethoxydim, Simazine, S,S,S-tributyl phosphorothioate, Sulfometuron, Sulfosate and Trifluralin and mixtures thereof.

4. A insecticidal composition comprising:
(a) 1 to 99% by weight the enhancer of claim 2; and
(b) 1 to 99% by weight of an insecticide selected from one or more of: abamectin, acephate, acetamiprid, acrinathrin, alanycarb, aldicarb, allethrin, alpha-cypermethrin, aluminium phosphide, amitraz, azadirachtin, azamethiphos, azinphos-ethyl, azinphos-methyl, bendiocarb, benfuracarb, bensultap, beta-cyfluthrin, beta-cypermethrin, bifenthrin, bioallethrin, bioallethrin S-cyclopentenyl isomer, bioresmethrin, bistrifluron, borax, buprofezin, butocarboxim, butoxycarboxim, cadusafos, calcium cyanide, calcium polysulfide, carbaryl, chlorantraniliprole, carbofuran, carbosulfan, cartap, chlorethoxyfos, chlorfenapyr, chlorfenvinphos, chlorfluazuron, chlormephos, chloropicrin, chlorpyrifos, chlorpyrifos-methyl, chromafenozide, clothianidin, cyantraniliprole, coumaphos, cryolite, cyanophos, cycloprothrin, cyfluthrin, cyhalothrin, cypermethrin, cyphenothrin, cyromazine, dazomet, deltamethrin, demeton-S-methyl, diafenthiuron, diazinon, dichlorvos, dicrotophos, dicyclanil, diflubenzuron, dimethoate, dimethylvinphos, dinotefuran, disulfoton, emamectin, emamectin benzoate, empenthrin, endosulfan, esfenvalerate, ethiofencarb, ethion, ethiprole, ethoprophos, ethylene dibromide, etofenprox, etoxazole, famphur, fenitrothion, fenobucarb, fenoxycarb, fenpropathrin, fenthion, fenvalerate, fipronil, flonicamid, flucycloxuron, flucythrinate, flufenoxuron, flumethrin, formetanate, formetanate hydrochloride, fosthiazate, furathiocarb, gamma-cyhalothrin, halofenozide, heptachlor, heptenophos, hexaflumuron, hydramethylnon, hydroprene, imidacloprid, imiprothrin, indoxacarb, isofenphos, isoprocarb, isopropyl O-(methoxyaminothiophosphoryl)salicylate, isoxathion, lambda-cyhalothrin, lithium perfluoro-octane sulfonate, lufenuron, magnesium phosphide, malathion, mecarbam, mercurous chloride, metaflumizone, metam, metam-sodium, methamidophos, methidathion, methiocarb, methomyl, methoprene, methothrin, methoxychlor, methoxyfenozide, metofluthrin, methyl isothiocyanate, metolcarb, mevinphos, milbemectin, monocrotophos, naled, naphthalenic compounds, nicotine, nitenpyram, nithiazine, novaluron, noviflumuron, omethoate, oxamyl, oxydemeton-methyl, parathion, parathion-methyl, pentachlorophenol, pentachlorophenyl laurate, permethrin, petroleum oils, phenothrin, phorate, phosalone, phosmet, phosphamidon, phosphine, pirimicarb, pirimiphos-methyl, prallethrin, profenofos, propaphos, propetamphos, propoxur, prothiofos, pymetrozine, pyraclofos, pyrethrins, pyridalyl, pyridaben, pyridaphenthion, pyrimidifen, pyriproxyfen, quinalphos, resmethrin, rotenone, sabadilla, silafluofen, sodium cyanide, sodium pentachloro-phenoxide, spinetoram, spinosad, sulcofuron, sulcofuron-sodium, sulfluramid, sulfotep, sulfuryl fluoride, sulprofos, tau-fluvalinate, tebufenozide, tebupirimfos, teflubenzuron, tefluthrin, temephos, terbufos, tetrachlorvinphos, tetramethrin, theta-cypermethrin, thiacloprid, thiamethoxam, thiodicarb, thiofanox, thiometon, thiosultap-sodium, tolfenpyrad, tralomethrin, transfluthrin, triazamate, triazophos, trichlorfon, triblumuron, trimethacarb, vamidothion, xylylcarb, zeta-cypermethrin, zinc phosphide, beet juice, D-limonene, cedarwood oil, castor oil, cedar oil, cinnamon oil, citric acid, citronella oil, clove oil, corn oil, cottonseed oil, eugenol, garlic oil, geraniol, geranium oil, lauryl sulfate, lemon grass oil, linseed oil, malic acid, mint oil, peppermint oil, 2-phenethyl propionate (2-phenylethyl propionate), potassium sorbate, rosemary oil, sesame oil, sodium chloride, sodium lauryl sulfate, soybean oil, and thyme oil and mixtures thereof.

5. A germicidal composition comprising:
(a) 1-99% by weight the enhancer of claim 2; and
(b) 1-99% by weight of a germicide selected from the group consisting of Azoxystrobin, Mancozeb, Tricyclazole, Carbendazim, Hexaconazole, Metalaxyl, Benomyl, Difenoconazole, Propiconazole, Kitazin, Tebuconazole, Copper oxychloride, Copper hydroxide, Tridemorph, Propineb, Hexachlorophene, Dichlorophen, Bronopol, Copper Hydroxide, Cresol, Dipyrithione, Dodicin, Fenaminosulf, Formaldehyde, 8-Hydroxyquinoline Sulfate, Kasugamycin, Nitrapyrin, Octhilinone, Oxytetracycline, Probenazole, Streptomycin, Tecloftalam and Thiomersal and mixtures thereof.

6. A method for controlling weeds which comprises applying to said weeds an amount effective to inhibit weed growth or to kill weeds of a chemical agent and a fermentation product produced by facultative fermentation, said chemical agent, in the presence of said facultative fermentation product, being effective to inhibit the growth or to kill at least one weed species, and said facultative fermentation product being effective to enhance the activity of said chemical agent, said chemical agent and said facultative fermentation product being applied in amounts wherein killing of said weeds or the inhibition of the growth of said weeds is greater than would be caused by the same amounts of said chemical agent or said facultative fermentation product applied alone.

7. The method of claim 6 wherein said chemical agent is a herbicide.

8. The method of claim 6 wherein said facultative fermentation product is further processed to make a processed facultative fermentation product.

9. The method of claim 6 wherein said chemical agent and said facultative fermentation product are applied to said weeds simultaneously.

10. The method of claim 6, wherein said facultative fermentation product is a mixture of
(a) a fermentation product of one or more of red beans, peas, yellow corn, white corn, white rice, yucca, potatoes, manioc root, starch from vegetables sources, inorganic minerals, non-iodized sea salt, urea or another equivalent nitrogen source, biodynamic water and an inoculum selected from the group consisting of bacillus microorgasnisms or spores and yeast;
(b) an essential oil selected from the group consisting of banana oil, cinnamon oil, coconut oil, vanilla oil and mixtures thereof; and urea or another equivalent nitrogen source; and
(c) an extract of a plant material selected from the group consisting of marranero fern foliage (Pteridium aquilinum), cola de caballo (horsetail fern) leaves (esquisetum arvense), powdered cinnamon (cinnamomum zeylanicum), garlic cloves (allium sativum), tabasco pepper fruits (capsicum frutescens), pasto kikuyo seeds (pennisetum clandestinum) and mixtures thereof.

11. A herbicidal composition comprising a chemical herbicide in combination with a facultative fermentation product which enhances the activity of said chemical herbicide, said facultative fermentation product being present in said composition in amount sufficient to enhance the herbicidal activity of said chemical herbicide against at least one weed species.

12. A composition as claimed in claim 11 wherein said composition contains said herbicide.

13. A composition as claimed in claim 11 wherein said facultative fermentation product is product is a mixture of: (a) a fermentation product of one or more of red beans, peas, yellow corn, white corn, white rice, yucca, potatoes, manioc root, starch from vegetables sources, inorganic minerals, non-iodized sea salt, urea or another equivalent nitrogen source, biodynamic water and an inoculum selected from the group consisting of bacillus microorgasnisms or spores and yeast;
(b) an essential oil selected from the group consisting of banana oil, cinnamon oil, coconut oil, vanilla oil and mixtures thereof; and urea or another equivalent nitrogen source; and
(c) an extract of a plant material selected from the group consisting of marranero fern foliage (Pteridium aquilinum).

14. A composition as claimed in claim 11 wherein said herbicide is sulfosate.

15. A composition as claimed in claim 11 wherein said herbicide is glyphosate.

16. A composition as claimed in claim 11 wherein said herbicide is glufosinate.

17. A composition as claimed in claim 11 wherein said herbicide is selected from the group consisting of fluazifop, sethoxydim, imazapyr, chlorimuron, dicamba, bentazon, fomesafen, and imazethapyr.

18. A method for controlling weeds which comprises applying to the seeds of said weeds an amount effective to prevent or inhibit weed growth of a chemical agent and a facultative fermentation product, said chemical agent, in the presence of said facultative fermentation product, being effective to kill or inhibit the growth of weeds from said seeds of at least one weeds species, and said facultative fermentation product being effective to enhance the activity of said chemical agent, such chemical agent and facultative fermentation product being applied in amounts wherein killing of said seeds or the inhibition of the growth of said weeds from said seeds is greater than would be caused by the same amounts of said chemical agent or said facultative fermentation product applied alone.

19. An agricultural composition comprising:
(a) 1-99% by weight the enhancer of claim 2; and
(b) 1-99% by weight of an agricultural chemical.

20. The agricultural composition of claim 19, wherein said agricultural chemical is selected from the group consisting of: insecticide, fungicide, acaricide, nematocide, miticide, rodenticide, bactericide, molluscicide and bird repellant and mixtures thereof.

21. A chemical composition comprising an chemical in combination with a facultative fermentation product which enhances the activity of said agricultural chemical, said facultative fermentation product being present in said composition in amounts sufficient to enhance the activity of said agricultural chemical.

22. The chemical composition of claim 21, wherein said chemical is an agricultural chemical.

23. The chemical composition of claim 21, wherein said chemical is an industrial chemical.

24. The chemical composition of claim 21, wherein said chemical is a medicinal chemical.

25. The chemical composition of claim 21, wherein said chemical is a household chemical.
